(19) United States
(12) Patent Application Publication
(10) Pub. No.: US 2022/0027408 A1
(43) Pub. Date: Jan. 27, 2022

(54) MEMORY OF SEQUENCES, METHOD FOR CREATION AND FUNCTIONING OF SEQUENCE MEMORY, HIERARCHICAL SEQUENCE MEMORY

(71) Applicant: Oleg Aleksandrovich SEREBRENNIKOV, Moscow (RU)

(72) Inventor: Oleg Aleksandrovich SEREBRENNIKOV, Moscow (RU)

(21) Appl. No.: 17/493,496

(22) Filed: Oct. 4, 2021

Related U.S. Application Data
(63) Continuation of application No. PCT/RU2019/000211, filed on Apr. 4, 2019.

(51) Int. Cl. G06F 16/906; G06F 16/901; G06N 3/04; G06N 3/063

(52) U.S. Cl. CPC G06F 16/906; G06N 3/063; G06N 3/04; G06F 16/9024

(57) ABSTRACT

Sequence Memory is intended for entering sequences and creating a statistical map of the weights of the joint occurrence of sequence objects and analyzing the map for solving problems: 1) predicting the appearance of the next sequence objects in the past or future; 2) determining the context and the point of changing the context of the sequence with the assignment of individual sections of the sequence unique identifiers of the context; 3) input of sequences of context identifiers in the Sequence Memory of the next level of the hierarchy in order to create a Hierarchical Sequence Memory; 4) Representation of cause-and-effect relationships as relationships of mutual occurrence of objects of different levels of the hierarchy for analysis 5) identification of cause-and-effect relationships of the corresponding level of the hierarchy for making conclusions and judgments.

The Sequence Memory Device and the Hierarchical Sequence Memory device are designed to reduce the complexity of solving the problems of the Sequence Memory and the Hierarchical Sequence Memory.

The Sequence Memory device is a fully connected crossbar of two intersecting sets of transverse buses, each of which encodes one of the unique sequence objects, and the connection weight of each two objects is encoded by the Artificial Neurons of Occurrence (INV) set at the intersection of the corresponding buses.

The Hierarchical Sequence Memory device connects two or more Sequence Memory devices of sequential hierarchy levels connected by a plurality of Artificial Neurons of the Hierarchy, as well as layers of measurement buses associated with the Hierarchical Sequence Memory through Artificial Neurons of the Label, providing 1) representation of a sequence of contexts of sequence objects through Sequence Memory buses, connection of sequence objects through INV, shorter sequences of contexts at different levels of the hierarchy, 2) assignment of measurement labels in order to compare and synchronize sequences with comparable measurement labels.

### CROSS-REFERENCE TO RELATED APPLICATION

This application is Continuation of International Application No. PCT/RU2019/000211, filed on Apr. 4, 2019, the disclosure of which is incorporated by reference herein in its entirety.

### BACKGROUND

The invention relates to the field of information and retrieval technologies, in the field of information analysis and processing and forecasting, to the field of storage and processing of data, to the field of artificial neural networks.

Internet search engines are known. However, search engines store data in an index, and the index is a sequence object numbering machine. Therefore, search engines are not equipped to store and search unnumbered sequences. Algorithms for indexing sequences (textual or other information) by search engines are designed in such a way that they do not store the weight of relationships of mutual occurrence of objects in sequences and therefore do not build a set of relationships “future” and “past” for each unique object of a set of sequences. The reasons for these shortcomings are that search engines are designed to index and search information, and not to create a memory of sequences. The search engine index is not intended to analyze the mutual occurrence of individual objects in the sequence and therefore, the implementation of such an analysis using the search engine index is very laborious.

Known patents “Recursive index (RI) for search engines” RU2459242 and U.S. Pat. No. 9,679,002 (hereinafter “Serebrennikov's patents”). RI is a prototype of the Memory of Sequences and allows storing many links of the “future” and “past” for each unique object of the set of sequences. RI significantly reduces the complexity of studying the mutual occurrence of sequence objects in comparison with the index of search engines. However, the RI is an index and is intended for the analysis of numbered sequences, which increases the storage size and does not allow making a Memory Device for Unnumbered Sequences based on it. The named patents also do not propose methods of analysis and forecasting based on the use of rank Clusters (sets of frequent objects of the future or past).

Sequence Memory (PP)

The prototypes of PP are fully connected artificial neural networks (NN) with a well-known architecture. Unlike neurons of the cerebral cortex, individual neurons of the neural network do not encode objects, and therefore the data stored in the neural network is not the memory of sequences of such objects. The predictive capabilities of neural networks are not deterministic—in the process of learning, neural networks generate a structure of connections that is not directly based on the statistics of the occurrence of objects in sequences and therefore the result of the neural network is not completely predictable. Another significant disadvantage of the NN is the absence in the NN of a device for measuring and synchronizing time, space and other measurable quantities, as well as a device for making decisions taking into account emotions and ethical norms.

Another PP prototype is a matrix of fully connected nods—a crossbar. However, the crossbar does not have artificial neurons of occurrence (INV) and, in addition, in contrast to the “kerchief” of the PP, this matrix has an excess number of connections “each with each”.

Hierarchical Sequence Memory (IPP).

Serebrennikov's patents are IPP prototypes. However, the disadvantage of Serebrennikov's patents is that RI does not offer methods for analyzing sequence patterns and does not provide for the creation of synthetic objects. Therefore, RI cannot be the basis for the creation of the Hierarchical Sequence Memory.

Another IPP prototype are Artificial Neural Networks (NN). The disadvantage of the neural network is that the artificial neurons of the fully connected layer do not encode individual objects, and therefore the neural network cannot encode sequences of objects at different levels of the hierarchy, thus making it impossible to create an IPP in principle. In addition, neural networks do not have a device for synchronizing sequences of objects of different nature and therefore do not meet the requirements of multithreading, which does not allow comparing sequences of objects of different nature and makes it impossible to create a strong artificial intelligence based on neural networks of a known architecture. The named disadvantages of the NN are a fundamental obstacle to the creation of a strong AI based on the NN.

Still another prototype of the IPP is the so-called Temporary Hierarchical Memory, described in the work “Hierarchical Temporal Memory”, Jeff Hawkins & Dileep George, Numenta Corp. and other works by the named author and his co-authors. However, in the work “Hierarchy of HTM corresponds to the spatial and temporal hierarchy of the real world” [“Hierarchical Temporal Memory”, Jeff Hawkins & Dileep George, Numenta Corp], the authors note that the model of Temporary Hierarchical Memory proposed by them (VIP is the Russian analogue of the English abbreviation HTM (Hierarchical Temporal Memory)) has some limitations: “How would we organize the vocabulary input in a sensory array, where each input line represents a different word, so that local spatial correlations can be found? We do not yet know the answer to this question, but we suspect that HTMs can work with such information.”. The HTM also does not offer mechanisms for creating synthetic objects and therefore does not offer a way to create IPP.

The task to be solved by the group of inventions is the creation of the technology of the so-called strong Artificial Intelligence also known as General AI, namely the creation of a device—an analogue of the cerebral cortex, as well as the creation of information processing methods that ensure the identification of cause-and-effect relationships and the production of conclusions and judgments. The difference between the present invention and prototypes and analogs is that the invention is based on the representation of consciousness as a statistical model of the world (the action of the laws of the world), built by entering and memorizing connections between objects of a set of sequences that reflect the action of the laws of the named world and therefore contain statistically admissible causal investigative connections that satisfy the named laws, whatever the laws themselves. This allows the PP and the IPP in the learning process to create and fill a statistical model of the external world that can predict statistically reliable consequences of known causes or, conversely, detect statistically reliable causes of known consequences.

The unified technical result, which can be obtained as a result of the implementation of the claimed invention (group of inventions), consists in the creation of a Hierarchical Multithreaded Synchronous Memory of Unnumbered Sequences.

### SUMMARY

A method of creation and functioning of the sequence memory wherein digital information is represented by a plurality of machine-readable data arrays, each of which is a sequence of unique objects, each represented by a unique machine-readable value of the object, and each unique object (hereinafter the “key object”) appears, at least in some sequences, the sequence memory is trained by feeding the sequences of objects to the memory input, and each time the key object appears, the memory extracts the objects preceding the key object in the sequence (hereinafter referred to as “frequent objects of the past”), increases by one the value of the counter of the co-occurrence of the key object with each unique frequent object of the past and updates the counter value with a new value, and combines the counter values for different unique frequent objects into a data array of weights of the “past”, as well the memory, at each appearance of the key object, extracts from the named sequence the objects following the named key object in the named sequence (hereinafter referred to as “frequent objects of the future”), increases by one the value of the counter of the mutual occurrence of the key object with each unique frequent object and updates the counter value with a new value, and combines the counter values for different unique frequent objects into a data array of weights of the “future”; each data array of “past” and “future” is being divided into subsets (hereinafter “rank sets”), each of which contains only frequent objects equidistant from the named key object either in the “past” or in the “future”, and each unique key object with at least one corresponding rank set is put in the sequence memory; and the sequence memory provides a search in the named data arrays for the named rank set of weights in response to the input of the named unique key object or the search for the named unique key object in response to the input of the rank set or its part.

### BRIEF DESCRIPTION OF THE DRAWINGS

To clarify the essence of the claimed invention, the following graphic materials are presented:

FIG. 1—Hierarchical Temporal Memory according to Jeff Hawkins.

FIG. 2—Cluster Diagram K_{N} of a key object.

FIG. 3—Attention Window of five sequence objects.

FIG. 4—Fragment of the sequence. The weights (w) of Clusters decrease from K1 to K4.

FIG. 5—Sequence represented by Clusters of the 1st rank.

FIG. 6—Learning feedback. Tells the previous hit (object) what the new sequence object was.

FIG. 7—Feedforward for building hypothesis.

FIG. 8—Training and forecasting in RINP.

FIG. 9—Forward links of known objects point to the same section of the sequence in the future that we want to predict.

FIG. 10—An increase in the number of hypotheses as the depth of prediction increases.

FIG. 11—Key Object (KO), as well as three frequent objects (−3, −2, and −1) and (1, 2 and 3), located, respectively, before and after the Key Object in a specific sequence.

FIG. 12—Formed rank Clusters—three for the past K⁻³, K⁻², K⁻¹ and three for the future K¹, K², K³.

FIG. 13—Introduced fragment of the sequence, consisting of three objects.

FIG. 14—Coherent clusters of objects C₂, C₃ and C₄.

FIG. 15—Example of three sequences

FIG. 16—Frequent objects of the Cluster of key object A

FIG. 17—A set of sequences with object B

FIG. 18—A set sequence with Object C

FIG. 19—A set sequence with Object D

FIG. 20—Clusters of Past of elements B, C and D.

FIG. 21—Backward projection of the Cluster.

FIG. 22—Ranked Backward Projection.

FIG. 23—The appearance of one object to indicate several equivalent meanings.

FIG. 24—Compression of Clusters of four objects to one Cluster Cont (4).

FIG. 25—Replacing a sequence of objects with a sequence of Pipes.

FIG. 26—Euler-Venn diagram for logical negation.

FIG. 27—The formation of hypotheses is shown with dotted arrows.

FIG. 28—Backward-forward connections between Pipes.

FIG. 29—Formation of back-forward connections between Pipes.

FIG. 30—Use of a hierarchy of links to draw conclusions.

FIG. 31—Input S of bus C.

FIG. 32—Functional diagram of the Sequence Memory.

FIG—Graduation of links between objects of sequences. Object 1 is the latest of entered sequence objects, and object N is the earliest.

FIG. 34—Connection “each to each” in the form of a matrix of N*N buses (crossbar).

FIG. 35—Half of the matrix—triangle (Half Cross bar), here A—bus inputs and B—bus outputs

FIG. 36—Writing and reading links in the combined node of the matrix triangle.

FIG. 37—Example of switching a connection “to itself”

FIG. 38—Recurrent feedback is shown with an arrow.

FIG. 39—Regular single-rank matrix of two sections.

FIG. 40—Series connection of two sections of single-rank triangles.

FIG. 41—Dual-rank matrix switching as an example of multi-rank matrix switching

FIG. 42—Matrix generator.

FIG. 43—Topology of a matrix of six single-rank sections with links of 1st, 2nd, 3rd, 4th, 5th, 6th rank. Shown a dual-rank matrix generator with connections of the 1st and 2nd ranks.

FIG. 44—Directions Input-Output: 1)→—recording (feedback is recorded); 2)→—reading the past 3)←—reading the future.

FIG. 45—Object buses and Pipe buses.

FIG. 46—Two counters of occurrence (INV) for the forward and reverse order of objects Cₙ→Cₖ and Cₖ→Cₙ.

FIG. 47—Reading the value and direction of inversion.

FIG. 48—Neuron of Occurrence (INV).

FIG. 49—Neuron—1; buses of objects C₁ and C₂—2 and 3; bus valves of objects C₁ and C₂ in the “open” position—4 and 5; communication between buses of objects—6; bus communication valve between objects in the “closed” position—7.

FIG. 50—Neuron—1; buses of objects C₁ and C₂—2 and 3; bus vents of objects C₁ and C₂ in the “closed” position—4 and 5; communication between buses of objects—6; bus communication vent between objects in the “open” position—7.

FIG. 51—Counters—1 for directions Cₖ→Cₙ and Cₙ→Cₖ, writing to counter memory at the intersection of the bus objects C₁ and Cₖ in triangle of rank k is in progress only while supplying the both signals S₁=1 and Sₖ=(1−ΔS_{1,k}) on the buses of objects C₁ and Cₖ of triangle of rank k in the direction of feedback; the link of mutual occurrence—2; the coupling vent is moved to the “open” position—3.

FIG. 52—The strength of signals Sᵢ on the buses of objects Cᵢ.

FIG. 53—Counter—1, vent in the “open” position—2.

FIG. 54—Reading feedback.

FIG. 55—Reading the rank Cluster of the multi-rank matrix.

FIG. 56—Reading rank relationships of a multi-rank matrix.

FIG. 57—Reading the weights of three consecutive rank relationships of the matrix.

FIG. 58—Reading a complete Cluster of a multi-rank matrix.

FIG. 59—Reading the weights of three consecutive rank relationships of the matrix.

FIG. 60 Artificial neuron scheme of sequence memory hierarchy (INI). INI provides a connection between adjacent layers of the hierarchy of the Sequence Memory M1 and M2: A—sensors with the activation function (φ) of the sensor to obtain the Cluster and Caliber of the Pipe with the weights of frequent objects at the output of the matrix M1 of the objects of the lower hierarchy level, B—the adder (Σ) of the weights of the frequent objects of the Cluster of Pipe with the activation function (φ) of a neuron, C—connections of the neuron bus with the buses of objects of the matrix M2 of the Memory of Sequences of the upper level of the hierarchy, D—sensors for memorizing the Window of Attention—the objects of the Pipe Generator at the input of the matrix M1 of objects of the lower level of the hierarchy, E—feedback of the output of the neuron with Generator Pipes objects at the input of matrix M1 of the lower hierarchy level.

FIG. 61—Scheme of an artificial neuron of a traditional neural network (perceptron)

FIG. 62—Scheme of switching a neuron of an artificial neuron of the sequence memory hierarchy (INI) with matrices of the lower level M1 (Object layer) and matrix M2 (layer of pipes of the 1st level) using INI. A—Cluster of weights of frequent objects, B—neuron adder with activation function, C—intersection of the neuron output bus with the buses of the upper-level matrix M2 (Level 1 Pipes)

FIG. 63—Architecture of matrices of different levels of the hierarchy.

FIG. 64—Arrangement of groups of sensors and adders of INI in triangles. 1—sensors of group D, 6—sensors of group A, totalizer group B is located at the outputs.

FIG. 65—The attention window is shown by arrows in the group D of sensors

FIG. 66—Training Neuron of Combinations

FIG. 67—Operation of the Neuron of Combinations

FIG. 68—Scheme of switching an artificial neuron of sequences memory combinations (INS) with matrices of the lower level M1 (layer of Objects) and matrix M2 (layer of combinations) using INS. A—Cluster of weights of frequent objects, B—adder of a neuron with an activation function, C—intersections of the output bus of the neuron with the buses of the upper-level matrix M2 (Layer of combinations), D—objects of the combination, as well as a neuron.

FIG. 69—Stable combination layer

FIG. 70—Functional diagram of recurrent Sequence Memory.

FIG. 71—Pipe' Remembrance by Unnormalized Cluster

FIG. 72—Active frequency buses and passive buses.

FIG. 73—Pipe Caliber of the measurement layer.

FIG. 74—The layer of frequency buses without intersections, and the layer of labels with intersections “each with each” both in the layer of frequency buses and in the layer of labels.

FIG. 75—Layer of frequency buses for synchronization of measurements. In this case, a ternary number system is shown with three buses in each digit.

FIG. 76—Layers of synchronization of measurements in the triangle architecture.

FIG. 77—Matrix Architecture with Dimension Layers

FIG. 78—Architecture of a matrix with a measurement layer and sensor groups A and A1, D and D1, a measurement generator G, Adders B and B1, and a sensor C

FIG. 79—The structure of a large pyramidal cell of the cerebral cortex of the V layer (according to GI Polyakov)

FIG. 80—Model of a pyramidal neuron.

### DETAILED DESCRIPTION

### 1. Introduction

Although the first neural networks (neural networks) were fully connected networks, consisting of perceptrons, the most widespread at present are the architectures of the Convolutional Neural Network (CNN). CNNs use a cascade of convolution and linearization units (ReLU—rectified linear unit) of feature maps, and only as the last processing unit is the still fully connected network of perceptrons.

The number of neural network researchers is quite large, and investments in this area are growing rapidly, but this has not yet led to the emergence of universal AI (artificial intelligence), and the consistency of the approach to creating a universal AI based on neural networks is being questioned.

In 2003, Jeff Hawkins published On Intelligence [“On Intelligence”, Jeff Hawkins & Sandra Blakeslee, ISBN 0-8050-7456-2], in which he noted as a lack of the approach of connectivists (neural network enthusiasts) their lack of knowledge about the work of the brain and the key qualities of human intelligence. Hawkins calls his approach “Biological and Machine Intelligence (BAMI)”—Biological and Machine Intelligence (BIMI). Within the framework of the approach proposed by BIMI, Hawkins was the first to reformulate the content of the famous “behavioral” Turing Test for the presence of intelligence: prediction, not behavior, is evidence of intelligence. In his works, Hawkins comes to the conclusion that the physical carrier of human intelligence is the neocortex, the key functions of which are: The
neocortex stores sequences of patterns.
The neocortex recalls patterns in an auto-associative manner.
The neocortex stores patterns in an invariant form.
The neocortex stores patterns hierarchically.

Later in their 2006 work entitled “Hierarchical Temporal Memory” by Jeff Hawkins & Dileep George, Numenta Corp, the authors propose a technical concept of memory (FIG. 1) that implements the storage of spatial patterns and temporal sequences of patterns.

However, in chapter 3.2. “The HTM hierarchy corresponds to the spatial and temporal hierarchy of the real world” [“Hierarchical Temporal Memory”, Jeff Hawkins & Dileep George, Numenta Corp], the authors note that the proposed model of Temporary Hierarchical Memory (VIP is the Russian analogue of the English abbreviation HTM (Hierarchical Temporal Memory)) has some limitations: “How would we organize vocabulary input in a sensory array, where each input line represents a different word, so that local spatial correlations can be found? We do not yet know the answer to this question, but we suspect that HTMs can work with such information.”

[symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] . The present invention proceeds from the idea of the brain as a memory of sequences, where the picture of the world is represented by connections, the weight of which depends on the repetition of connections in sequences in nature.

### 2. Sequence Memory (SM)

### 2.1. General Approach

### 2.1.1. Concept of Mutual Occurrence of Objects

Recursive index (RI) for search engines (RU2459242, U.S. Pat. No. 9,679,002) is a sequence memory. The development of the Recursive Index allows storing both the sequences themselves and the sequences of patterns (called “sphere”, “future” and “past” in patents) of each of the sequence objects. RI significantly reduces the complexity of studying the mutual occurrence of sequence objects, which is of key importance for the development of AI.

RI implements the following algorithms:

1. indexing sequences of objects (Key objects),
2. searching in sequences of a Key Object,
3. retrieving from the index sequences of R objects (R-sequence) located before and/or after the Key Object,
4. constructing the (+R)-hemisphere of the future, consisting of all the R-sequences found in the index beginning with the Key Object and the (−R)-hemisphere of the past, consisting of all R-sequences found in the index ending with the Key Object,
5. Constructing the R-sphere of objects (Frequent objects), combining the Key objects of the sequences (+R)-hemisphere of the future and (−R)-hemisphere of the past.

All Frequent objects falling into the (+R)-hemisphere of the future and (−R)-hemisphere of the past of a particular Key Object form, respectively, the Cluster of the future and the Cluster of the past of this Key Object. For any Key Object, two types of Clusters can be built—the Cluster of the Past and the Cluster of the Future. In order to take into account that the Cluster contains frequent objects from the “past” and “future”, objects from the future will be assigned a plus sign, and objects from the past—a minus sign.

SM allows detecting and investigating spatial and temporal correlations within and between sequences and is based on the concept of analyzing the mutual occurrence of sequence objects.

### 2.1.2. From Text Documents to Sequences of Objects of any Nature

Let's agree to consider that sequences consist of a finite set of unique objects and these objects can be combined in sequences according to rules unknown to us.

Search in modern search engines is understood as the input of a unique object (keyword or phrase), the occurrence of which must be found in stored sequences. Internet search engines were created to work with documents, therefore search engines operate with the concept of “document number”, and the order of words in a document is determined by the ordinal numbers of words in the document (“position of a word in a document”). In a more general case, from the concept of “document” one should go to the concept of “chain of events/objects” or “sequence of events/objects”, and from the concept of “document number” to the concept of “chain number” or “sequence number”. Since events occur and objects appear in space and time, in general, the time/place stamp of the data chain object should be used as the “chain number”. And if we cannot establish the absolute time of occurrence of an event, we can determine the time of occurrence of events as a time shift relative to the time of the beginning of the sequence. So, if we cannot know exactly when an event captured on video occurred, then we can definitely say at what minute/second, or even in what order in the video frame, such an event occurred. However, for the sake of simplicity, we will often use examples of sequences of textual information.

### 2.1.3. Stable Combinations, Concepts

Let's take human speech or a sequence of words in texts as an example of sequences and investigate the joint occurrence of words in speech or texts. For example, it is known that NLP is an abbreviation of the phrase “neuro linguistic programming”. Therefore, the combination of two words “neuro linguistic” is often found in speech and texts, and the phrase with the reverse order of the words “linguistic neuro” almost never.

If we wanted to create a machine that uses the difference in the frequency of joint forward and reverse co-occurrence of objects as a criterion for the stability of a phrase or a criterion for a new meaning generated by a combination, then we could take many examples of stable phrases and phrases that generate new meaning (new concepts, often denoted abbreviations), to measure statistically the ratio M of the weights of the forward and reverse occurrence of words of such combinations and use this ratio to automatically determine the stability of such phrases and the generation of new concepts by them.

The simplest solution for finding the value M of the mutual occurrence of any two words of the language would be to create a table N*N, where the names of columns and rows would be N words of the language, for example, listed in alphabetical order. If in the cell at the intersection of row i and column j we enter the number of cases Q when words i and j met in the order i=>j, and in the cell at the intersection of row j and column i we enter the number of cases W when words i and j met in reverse order j=>i, then the cells that are symmetric with respect to the diagonal contain the numbers Q and W for each pair of words i and j. Actually M=Q/W. When proceeding to the study of the mutual occurrence of three objects, we would have to consider not a table, but a cube of size N*N*N, and to study the mutual occurrence of R objects, the volume of the cube would increase to the size of N^{R}.

The logic of the study of mutual occurrence can be used to identify stable word combinations that do not form a concept, such as, for example, “tiger”, “striped” and “ice”, because it is obvious that the pair of words “tiger” and “striped” occurs together more often than a couple of words “tiger” and “ice”.

Following the described logic, it is possible to study the mutual occurrence of objects that do not form a combination, but are separated by a number of other objects.

Remark 1 (Reducing the Complexity of Determining the Weight of the Mutual Occurrence):

The mechanism for identifying stable phrases and concepts by building a cube of size N^{R} is simple, but the computational complexity of the method is quite high. The use of the Recursive Index makes it possible to significantly reduce the complexity of the problem of studying the mutual occurrence by constructing a sphere around object i containing K fragments of sequences with a radius of R objects before and after object i, and studying the mutual occurrence of object i with other objects in the sphere, which allows solving the problem on a set of objects 2*R*K, and not on a set of objects N^{R}, due to which the labor intensity is reduced and this allows solving the problem of mutual occurrence using weak processors and on the fly.

### 2.1.4. Directional Links Between Sequence Objects

Let us now turn to a more general example—events. If we studied the events captured on camera, we could find that in the chain of events of fire occurrence, the appearance of smoke most often precedes the appearance of fire. By examining texts or videos containing descriptions or footage of the occurrence of a fire, we might find the same thing—first there is smoke and then fire, or vice versa. However, the words “smoke” and “fire” do not necessarily form a phrase, but can be separated by many other words. The same can be said for the words “striped” and “tiger”, they may not form phrases, but are often found in the same description of a tiger or events involving a tiger. In a more general case, it seems reasonable to expect that in a sequence of events, a cause event always precedes an effect event, thus a pair of these events forms a stable directional sequence of events “cause”=>“effect” separated by other intermediate events, and apparently the frequency of occurrence of the direct sequence “cause”=>“effect” will be higher than the frequency of occurrence of the sequence “effect”=>“cause”. At the same time, the identification of cause-and-effect is a conclusion, which means that a machine that allows you to draw conclusions about the joint occurrence of objects in a sequence is a machine that allows you to draw conclusions or a “thinking” machine.

Thus, if we want to build a machine that draws conclusions, then we should build a machine that analyzes the mutual occurrence of each object with each in a set of sequences of events. Such a machine will be a machine for identifying cause-and-effect relationships between objects separated by a large amount of intermediate information.

Now our machine can draw conclusions. However, if we use the technique for constructing tables that was given above, then the computational complexity of the algorithm of such a machine will be proportional to N to the power of N. Therefore, we should build an apparatus for representing, recording and analyzing sequences that allows us to analyze them and draw conclusions on the fly.

### 2.1.5. Simultaneous and Parallel Sequences

In Jeff Hawkins' “On Intelligence”, Jeff Hawkins & Sandra Blakeslee, ISBN 0-8050-7456-2], [“Hierarchical Temporal Memory”, Jeff Hawkins & Dileep George, Numenta Corp], “hierarchical temporary memory” contains the word “temporal”, which should be understood as a sequence of spatial patterns following one after another in time. However, in order to identify temporal correlations between temporal sequences of patterns entering memory and already stored in it, it is necessary to define the concept of “simultaneity”. In everyday life, we call simultaneous events that occur at the same time, however, going to the saved sequences, we often do not know when they were recorded, and therefore, to understand whether the sequences are simultaneous in the time of their manifestation, it is possible only by comparing and analyzing the similarity events and objects of such sequences. In the general case, we will call simultaneous sequences, the common beginning or end of which is the same unique object or time or place. Manifestations of such an object in different channels of information receipt (vision, hearing . . . ) can be attributed to different manifestations of the same object precisely due to the simultaneous receipt of information about the object through different information channels.

However, not all simultaneous sequences can be correlated with each other. So a video recording of a cat and an audio recording of her meowing may correlate if the named recordings are recordings of the same event, and a meteorite falling in one part of the Earth and the birth of a child in another may not have correlations. Parallel we will call simultaneous sequences correlated with each other. Different word forms of a word are an example of a degenerate form of parallel sequences, each of which consists of the object itself in different word forms. Another form of parallel sequences can be synonym objects and synonym combinations. Another example of parallel sequences of patterns is many texts in different languages, each of which is a translation of the same source text, or two texts describing the same event, but written by different people. The use of parallel texts formed the basis for training the Google machine translation system, within which the neural network created its own abstract language, the map of which is presented in Google's Multilingual Neural Machine Translation System: Enabling Zero-Shot Translation [Google's Multilingual Neural Machine Translation System: Enabling Zero-Shot Translation (https://arxiv.org/abs/1611.04558 and Russian version https://m.geektimes.ru/post/282976/)]. The work of Google in learning mode uses texts that obviously satisfy the condition of a semantic correlation between them, and this resembles the process of cognizing the reality of the physical world by the brain—it learns from examples of obviously parallel sequences presented through different senses: we see a cat and hear its meow. The brain, thanks to the mechanisms for detecting temporal correlations between the obviously parallel sensory temporal sequences of audio and video patterns, makes a conclusion about the belonging of the “meowing” sound to the observed object—a cat. Thus, presentation of parallel temporal sequences is key for training, and the apparatus for detecting correlations is the basic mechanism for producing predictions (inferences), and “multithreading” (multithreaded sequence memory) of sequence memory is perhaps absolutely necessary for AI.

We are able to think about something lying down, without moving, in silence and with closed eyes, at this moment the process of “thinking” works with objects of memory, and not with objects of reality, and therefore, for abstract thinking, it is critically important to be able to identify correlations between memory sequences, some of which are not simultaneous, and some of the simultaneous are not parallel. Revealing the fact of parallelism of two or more sequences located in memory, in essence, is one of the basic mechanisms of AI abstract inference. Predicting the development of real events is also associated with the ability to detect correlations: if a correlation is found between the input sequence and the sequence located in memory, then the sequence from memory can be used as a forecast of the appearance of objects in the input sequence. Therefore, we need an apparatus for “temporary memory of sequences”, the architecture of which allows:
extract “concurrent” sequences
identify temporal correlations between simultaneous sequences and determine which of the sequences are parallel.

Modern man has learned to fix and measure much more than his own senses allow him. Analysis of parallel sequences of the world (changes in the geomagnetic, gravitational field, the strength of the solar wind, and so on, the sequence of natural phenomena) and their comparison with events in the life and behavior of people can lead to unobvious and therefore unexpected results and discoveries.

### 2.1.6. Multithreaded Sequence Memory

Speaking about sequences and memory of sequences, we abstract from the nature of the sequences under consideration: these can be sequences of images of visual (sight) or sound (hearing) or tactile or other human feelings and sensations. Sequences can also be data from instruments measuring changes in fields, velocities, locations and other measured parameters. Moreover, all these sequences can be simultaneous in time and/or space and parallel in semantic significance, which means that such sequences can reflect the same manifestation of reality, be parts of one process or phenomenon, and therefore a correlation should be observed between the sequences. This correlation provides intelligence with the information it needs to draw conclusions that would not be obvious without it. This means that the memory of sequences must be able to simultaneously process many sequences of different nature, the objects of which are fed into the memory of sequences through different channels of communication between memory and reality, and be able to establish a connection between such sequences. In what follows, the processing of the memory of several sequences will be called multithreaded or multichannel sequence memory.

### 2.1.7. Sequence Memory and Logic

Logic is described as “the science of the laws of thought and its forms”, as well as “the course of reasoning, inferences,” and logical elements are the basis of modern computers. When moving from a computational model to a neural network model, the question arises: is it necessary to implement the apparatus of logic separately from the memory of sequences or memory of sequences itself is the apparatus of logic, the apparatus of “reasoning and inferences”?

If people could not present the description of logic in text form—in the form of a sequence, then knowledge about such logic would not be possible to transfer through manuscripts to descendants. Therefore, humanity operates with logic described by sequences: any known logic (classical and others) has a textual and formalized description, and each text or formula is a sequence. Therefore, it can be argued: any logical apparatus that can be represented by a sequence can also be memorized and reproduced using the sequence memory. And vice versa: only a logical apparatus, which cannot be described by a sequence, is also impossible to remember or reproduce using the memory of sequences. From this point of view, the apparatus of logic is a formal description of how sequence memory works, and not vice versa.

### 2.2. Some Neuroanalogies of Sequence Memory Processes

Moving on to the Memory of Sequences, we are actually moving on to imitating the work of brain neurons, and therefore it would be appropriate to agree on some analogies.

2.2.1. Primary, Secondary, Etc. Neurons

It is known that external images are able to excite specific neurons of the cortex, this was demonstrated by the example of “Bill Clinton neuron” or “Jennifer Aniston neuron”]. In other words, there are neurons assigned to objects in the real world and for convenience, we will call them Primary neurons. The cerebral cortex is essentially a model of the external world, and the sequences of objects in the external world must correspond to the sequence of excitations of individual primary neurons of the cortex. Primary neurons of the brain, being excited, transmit their excitation to a multitude of neurons (secondary, tertiary, and so on neurons), with which they are connected by forward or backward connection.

### 2.2.2. Neuron Connectivity

Neurons can have forward and backward connections as well as lateral connections. Lateral connections will be considered connections that allow comparison between neurons connected by a lateral connection.

### 2.2.3. Arousal: Spawning the Cluster

In our analogy, the primary neurons correspond to the key objects of the sequence, and the secondary neurons correspond to the frequent objects of the Key object′ Cluster. The strength of the synapse between the primary and secondary neurons in our model corresponds to the co-occurrence′ weight of the frequent object in the Cluster of the Key object.

### 2.2.4. Feedback Excitation: Reverse Projection of the Cluster

Since neurons have not only forward, but also backward connections, then secondary neurons, excited by backward connection, will be in the conditional “past” of the primary neuron. Below we will show that reverse projection of arousal is important for the detection of parallel meanings (synonymy in the broad sense). In the model of the Recursive Index (or Memory of Sequences), the reverse excitation of neurons will be represented by the reverse projection of the original Cluster, namely, by constructing the Clusters of the past for each of the frequent objects of the original Cluster and determining superposition of the Clusters.

### 2.2.5. Sequence of Excitations: Superposition of Clusters

If we excite primary neurons in the brain in a certain sequence, then some of the secondary neurons will be fired repeatedly more often than other secondary neurons. As a result, some of the secondary neurons will remain excited, and some of the neurons will fade out. Due to the interference of excitations in the cerebral cortex, waves of excitation and decay can occur [“Compression and Reflection of Visually Evoked Cortical Waves” (https://www.researchgate.net/publication/6226590_Compression_and_Reflection_of_Visually_Evoked_Cortical_Waves)]. Models of oscillating neurons are traditionally used to model such wave excitation of neurons. However, primary neurons are not connected with all neurons of the cortex, but only with some—“secondary neurons”, therefore, the excitation wave can be transmitted not to all surrounding neurons, but only to those with which the excited neuron has a directional connection formed in the process of learning by entering sequences. In the Recursive Index (or Sequence Memory) model, the sequence of excitations will be represented by a superposition of Clusters.

### 2.2.6. Attenuation: Reducing the Weight of the Object

Since the excitation of neurons weakens with time, the excitation of primary neurons (analogs of objects of the input sequence) will decrease in proportion to the “distance” to the last excited neuron in the sequence. The further the previously excited primary neuron is from the last excited primary neuron of the sequence, the less excited it is—its excitation weakens more than in neurons that were excited later.

### 2.2.7. Attention Window

By the Attention Window, we mean a queue of objects in a sequence of a certain size. During communication, we are able to accurately reproduce only the last few words that we heard, and the rest we remember “in meaning.” Those words that we remember can be called the Window of Attention. Within the framework of neuroanalogy, the Attention Window can be represented as a queue of sequentially excited neurons, the level of excitation of which decreases from the end to the beginning of the queue. Thus, the Attention Window is a queue of N primary neurons, in which the “last entered” will be the most excited, and the excitation of the “first exited” will be the most attenuated. That is, the excitation of all primary neurons starting from the (N+1) th primary neuron in the past is considered completely damped. Strictly speaking, due to the presence of forward and backward, as well as lateral connections, primary neurons from the beginning of the queue can be fired by primary neurons from the end of the queue, therefore the Attention Window does not have a strict neuroanalogy and is rather the last known fragment of the sequence, the order of objects in which defined.

### 2.2.8. Pauses: Interrupts Input

Sequence interruptions are more important because interrupting a sequence can mean a context change. An example of interruptions in texts is punctuation marks. The meaning of interruptions is clearly shown in the well-known Russian example: “ [symbol] [symbol] [symbol] ” in which the placement of a comma after the first or second word changes the meaning from “mercy, not execution” to “execution, not mercy.”. Reading the phrases aloud with and without comma it is easy to notice that the comma in the speech corresponds to a pause. Since the brain learns speech first and later learns reading and writing, originally the comprehension of language is not associated with comprehension of punctuation marks in texts, but rather with comprehension of pauses in speech: “execution <______> not mercy” or “Mercy <______> not execution.”

Not only speech, but also vision uses pauses—interruptions in input. Interruption of vision can be a pause between the saccades of the eyes when shifting the gaze from one place to another, because each saccade, in fact, generates a separate context—a saccade with a focus on the nose, a saccade with a focus on the eyes, a saccade with a focus on the lips . . . saccades image recognition is also related to the recognition of a sequence of images. It is known that when recognizing faces, a person's eyes examine several different elements of the face (eyes, nose, etc.) and thanks to saccades, the recognition process turns into the process of recognizing a sequence of images of different facial elements. Modern facial recognition neural networks work with static images instead of working with sequences, they use convolution, pulling, and other neural network techniques to work with feature maps. Therefore, when processing images using a neural network, feeding a sequence of face elements (nose, eyes, etc.) to the input of the neural network may be more optimal in terms of the speed and quality of recognition of a face or other image. The order in which the elements of the face are fed to the input of the neural network for recognition can also be important, therefore, the sequence of elements may probably be fed in the same order. This would correspond to the habit of a particular person to consider a face in a certain sequence of saccades.

Thus, pauses are one of the signs that the context of the sequence has changed and should be used.

Interruptions can also be a certain level of emotion or violation of ethical norms.

### 2.3. Clusters

### 2.3.1. Spatial Patterns of Objects and Sequences

The visual image of any object is a spatial pattern of pixels that convolutional neural networks have learned to successfully recognize.

In the case of sequences, the spatial pattern of each unique object in the sequence is the set of its connections with other unique objects, taking into account the frequency of their co-occurrence in the sequences. Therefore, we will call such connections “frequent connections”, which we will designate by the identifiers of the unique objects themselves, with which such a connection is established. Therefore, sometimes instead of the phrase “frequent connections” we will use the phrase “frequent objects”. The weight of the connection will be determined by the frequency of co-occurrence.

In what follows, any pattern of co-occurrence of objects will be referred to as a Cluster. We will form the clusters by analyzing the mutual co-occurrence of each unique object (a key object) with other unique objects forming a Cluster of such the Key object. The measure of the similarity of objects and sequences among themselves will be considered the measure of similarity of their Clusters (spatial patterns). The biological analogue of the unique object is the neuron of the cerebral cortex, and the Cluster in this analogy plays the role of a set of synapses connecting this neuron with other neurons in the brain.

Each Cluster is a set of objects and therefore operations on Clusters can be performed as on sets. At the same time, each frequent object of the Cluster is assigned a weighting coefficient, and therefore the Cluster is also an array or matrix or tensor. A cluster can also be represented as a vector.

### 2.3.2. Pattern Invariance

Since Clusters are a reflection of the mutual co-occurrence of objects in sequences, the Cluster is the context of the appearance of an object in sequences and therefore is an invariant representation of an object. In particular, in language the Cluster of a word can be invariant with respect to word forms of the word and to its synonyms. Word forms and synonyms are semantic copies of each other and therefore their Clusters should be similar. In the case of text sequences, it is not important in which form the keyword itself appears in the text, but it is important which frequent words will fall into the Keyword Cluster. Cluster invariance allows the Recursive Index to search for parallel chunks and synonyms.

### 2.3.3. What is the Size of the Cluster?

How distinguishable are word frequencies in the Cluster? The answer to this question is given by the well-known empirical laws, called Heeps' law and Zipf's law. Zipf's law says: “If all words of a language (or just a long enough text) are ordered in descending order of frequency of their use, then the frequency of the nth word in such a list will be approximately inversely proportional to its ordinal number n (the so-called rank of this word). For example, the second most commonly used word occurs about half as often as the first, the third—three times less often than the first, and so on.” Thus, we may anticipate that the frequencies of words in the Cluster differ in inverse proportion to their ranks in the Cluster.

According to Hips's Law, the number of unique words in a text is proportional to the square root of all words in the text. Thus, a Cluster built on a corpus of sequences of 10 thousand words will contain only 100 unique words, the frequency of which will decrease in inverse proportion to the rank of words in the Cluster list, according to Zipf's law. The last—the hundredth frequent word will occur in the source text 100 times less often than the first frequent word in the list of Cluster invariants.

If the frequency of using the first frequent word is taken to be equal to one, then the frequency of using k words in accordance with Zipf's law can be represented by a “harmonic series”. The sum of the first n members of the harmonic series will be (Calculations 1. The sum of a harmonic series):

$${S}_{k} = {\sum }_{k = 1}^{∞} \frac{1}{k} = 1 + \frac{1}{2} + \frac{1}{3} + \frac{1}{4} + … + \frac{1}{k} + …$$

### Thus:

S₁=1;S₂=1,5;S₃=1,833;S₄=2,083;S₅=2,283; . . . ;S₁₀_{^{3=7,484}};S₁₀_{⁶}=14,393;

As noted above, it follows from Heaps' law that a text of 10 thousand words will contain only 100 unique words (they are also frequent words of the Cluster), and, accordingly, for a text with a length of 1 million words, the Cluster will contain only 1 thousand unique frequent words. Moreover, for a Cluster of one thousand words, the total frequency of co-occurrence in frequent units of the first word will be 7,484 units (see Calculations 1), of which the frequency of occurrence of the first frequent word is 1 unit or 13.36%, the frequency of the second word is about 7%. the third—3.6% . . . of the total frequency of words in the Cluster in units of the frequency of the first word. As you can see, the first hundred of the frequent words of the Cluster in % will be decisive for texts of 1 thousand (4 pages of text) or even 1 million words (4 thousand pages of text).

Statement 1

Thus, a text from 10 to 250 thousand words can be described by a Cluster, the size of which is no more than, say, 100-500 frequent words.

### 2.3.4. Generation and Vector Representation of Object Clusters in RI

Vector representation of words has been proposed for quite some time, but, as can be seen from the publication by Christopher Olah [2014, (http://colah.github.io/posts/2014-07-NLP-RNNs-Representations/], a study of the mutual occurrence words was carried out using neural networks, and not the Recursive Index. “The use of vector representations of words has recently become the main” secret of the company “in many natural language processing systems, including solving the problems of identifying named entities (named entity recognition), part-of-speech markup (part-of-speech tagging), parsing and semantic role labeling.”—noted in another publication [Luong et al. (2013) https://nlp.stanford.edu/˜lmthang/data/papers/conll13_morpho.pdf].

The methods for studying the mutual occurrence of words with the construction of vectors of mutual occurrence, presented in the named publications, seem laborious and not obvious, while the Recursive Index offers a significantly less laborious and intuitive way than the one chosen by the authors of the named publications.

When using digital processing methods, Clusters and objects can be conveniently represented as vectors. Let us consider the process of creating Clusters for words of a language according to the corpus of documents stored in the RI. Search problem formulation:
1) at the input of the RI at each cycle, a keyword is supplied—a pattern by which the machine must find documents (sequences) containing such a pattern—a keyword. It uses an analogy with search queries to search engines, where a pattern is called a “keyword” or “set of keywords”. In each document, the word has a serial number N, assigned by the RI when indexing the corresponding document.
2) For the entered keyword, it is necessary to build a sphere of radius R words from the previously indexed sequences passing through the keyword each time it appears. To do this, it is necessary to extract from the memory of the RI an array of frequent words (connections)—words characterized by mutual occurrence with a keyword within the sphere of radius R of words.
   Let's start building an array of key word relationships in all previously indexed documents. To do this, we will:
1) find in documents all fragments containing such a keyword;
2) change the numbering of words in fragments so that the keyword in each of the fragments has the number N, the words of the fragment to the left of the keyword (past) respectively have numbers (N−1), (N−2), (N−3) and so on (N−R), and the words to the right (future) of the keyword would have numbers (N+1), (N+2), (N+3), and so on (N+R), respectively.

Thus, the word chains of each of the fragments will contain a keyword in the center, and therefore the documents will, as it were, “pass” through the keyword, forming a ball of radius R centered on the keyword.

Having counted the number of occurrences of each unique frequent word that fell into a ball with a plus sign (hemisphere of the future), and also fell into a ball with a minus sign (hemisphere of the past), we get two sets of unique frequent objects multiplied by the weight of the joint occurrence of unique frequent words of the ball with the search term keyword (Formula 1):

K_{P}=−Σⱼ₌₁^{R}(wⱼ*Cⱼ)—Cluster of the past of the N-object in sequences.

K_{F}=Σᵢ₌₁^{R}(wᵢ*Cᵢ)—Cluster of the future of the N-object in sequences.

K_{N}=Σᵢ₌₁^{R}(wᵢ*Cᵢ)−Σⱼ₌₁^{R}(wⱼ*Cⱼ—full sphere (Cluster of the future and Cluster of the past) of the N-object in sequences.

where Cᵢ—are frequent words in the Cluster of the Future (+) and Cⱼ—in the Cluster of the Past (−), respectively, and wi and wj are the weight coefficients of the co-occurrence of the C_{N} key object that generated the K_{N} Cluster with the corresponding frequent object Cⱼ or Cᵢ of the Cluster. The coefficients wᵢ can, for example, be equal to the total frequency of occurrence of the object Cᵢ with the object C_{N} in the corpus of RI sequences.

Cluster K_{N} is an array of frequent objects Cᵢ, each of which is multiplied by the number wi of occurrences of object Cᵢ in Cluster K_{N}. If we assume that the frequent objects Cᵢ are unit vectors forming the axes of the Cartesian coordinate system, then the weight coefficients wi are the value of the projection of the vector K_{P} or K_{P} on the coordinate axis. For example, if in Cluster K_{P} of object C_{N}=“tiger” the object C₁=“jungle” and once object C₂=“redhead” were encountered twice, then the unit vectors of words C₁ and C₂ will serve as the axes in it, and the projections of the object vector C_{N} onto the axis C₁ will be w₁=2 and on the C₁ axis will be w₁=1.

Definition 1

Cluster K_{N} of the key object C_{N} is the decomposition of the vector of the key object along the coordinate axes of the set of frequent objects Cᵢ of the Cluster K_{N}, and the weight coefficients wᵢ are the projections of the vector C_{N} on the axis Cᵢ.

### 2.3.5. Comparison of Clusters

### 2.3.5.1. Collinearity

Statement 2

The collinearity of the vectors of words C_{N} and C_{K}, represented by the coordinates K_{N} and K_{K}, indicates that the words have the same meaning—they are parallel objects: either word forms of one word, or synonyms, or translations of text into different languages or descriptions of the same phenomenon in different words [http://colah.github.io/posts/2014-07-NLP-RNNs-Representations/].

The length of each of the collinear vectors can be expressed in terms of the length of the smaller of the vectors multiplied by the value “λ”.

[symbol]

=λ*

[symbol]

Or in terms of Clusters (Formula 2—Collinear vectors of objects of the same meaning):

[symbol]

=λ*

[symbol]

### 2.3.5.2. Comparison of the Length of Normalized Vectors

A cluster is a vector in the space of frequent objects. Lets normalize the weights of the frequent objects of the Cluster so that their sum is equal to one (transition to probabilities). If the weight of each object is denoted as wᵢ, then the sum of all weights of the frequent objects of the Cluster will be (Formula 3—: Total weight of the Cluster objects)

$${W}_{\sum } = {\sum }_{i = 1}^{n} {w}_{i}$$

And then for the normalized weights of frequent objects ωᵢ we get (Formula 4—Normalization of the weight of frequent objects of the Cluster):

$${ω}_{i} = \frac{{w}_{i}}{{W}_{\sum }} = \frac{{w}_{i}}{{\sum }_{i = 1}^{n} {w}_{i}}$$

and it is obvious that

$${ω}_{\sum } = {\sum }_{i = 1}^{n} {ω}_{i} = 1$$

Considering that the number of frequent objects in the compared Clusters may differ, it is necessary to agree on the measure of semantic identity of such Clusters of different dimensions. For this
1. The projection ω₁ᵢ and ω₂ᵢ of the collinear vectors of Clusters K₁ and K₂ onto the axis of the frequent object C₁ should not differ by more than ωᵢ.

The sum of the difference in the weights of the normalized collinear vectors Σᵢ₌₁^{N}|ω_{Σ1}−ω_{Σ2}| over the entire set N of Sequence Memory objects should not exceed some collinearity error Δω_{Σ}. (Formula 5—Comparison error for normalized vectors):

$$2. \vert {ω}_{1 i} - {ω}_{2 i} \vert \leq Δω$$

$${\sum }_{i = 1}^{N} \vert {ω}_{i 1} - {ω}_{i 2} \vert \leq {Δω}_{\sum }$$

It can also be said that the difference between the normalized profiles of two Clusters that are identical in meaning should not exceed a certain error (Formula 6—Maximum error of coincidence of the normalized profiles of the Clusters weights):

ΔK̅ₘ̅ₐ̅ₓ̅≥K̅_{J}−K̅ₗ.

### 2.3.5.3. Fourier Series Representation

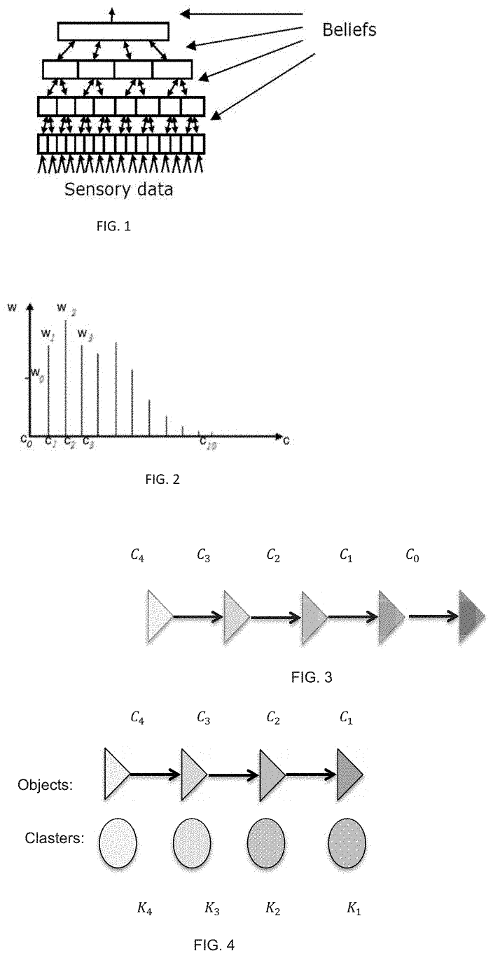

Any digital object of the set of objects of the sequence corpus corresponds to a unique digital identifier Cᵢ, and in the K_{N} Cluster of the C_{N} key object, each frequent object Cᵢ corresponds to the weight wi of the joint occurrence with the C_{N} key object that generated the K_{N} Cluster. Let us arrange identifiers of objects Cᵢ in ascending sequence C₀, C₁, C₂, . . . along the ordinate, and along the abscissa we will plot the weight of the object w₀, w₁, w₂, . . . . Then the Cluster K_{N} of the key object can be represented by a diagram (FIG. 2). If we agree that the values C₀, C₁, C₂, . . . are harmonics of the K_{N} Cluster with amplitudes w₀, w₁, w₂, . . . , then mathematically, such a Cluster K_{N} of frequent words can be represented by a Fourier series.

This representation of the K_{N} Clusters allows you to apply well-known numerical methods to analyze the meaning of sequences, the objects of which are represented by their Clusters:
1. construct a vector of meaning and search for a vector collinear to it in the vectors of the meaning of various words, thus determining the closest word or concept available to the memory of sequences;
2. apply the inverse Fourier transform for quantization into its constituent harmonics—codes of frequent words;
3. identify synonyms;
4. identify new concepts.

All the above reasoning is applicable both for a Cluster of objects and for the sum of a Cluster of several objects, which makes it possible to represent a vector and a sum of Clusters.

### 2.3.6. The Unity of the Processes of Remembering and Learning in RI

Cluster K_{N} of C_{N} is the “Cluster of C_{N} for all Sequences” of the Recursive Index. To reduce the formation time of the K_{N} Cluster, it is reasonable to store its value in the RI and update at each cycle of the C_{N} object entering the RI. Replenishing the K_{N} Cluster with objects of new sequences (the RI learning) and making changes to the weight coefficients wᵢ of the frequent objects Cᵢ of the K_{N} Cluster is the process of the Recursive Index learning on the C_{N} object. Since for training the K_{N} Cluster it has to be extracted from the Recursive Index, we can say that each input of the C_{N} object of a new sequence leads first to the “retrieving” of the K_{N} Cluster, and then to the training of the K_{N} Cluster using the example of using the C_{N} object in the input sequence. More specifically, the input of the C_{N} object is accompanied by the reproduction of the Cluster K_{P} and the Cluster K_{F} of the C_{N} object, which corresponds to the mode of “retrieving” the pattern of using the C_{N} object in the past K_{P} and “predicting” the possible behavior of the sequence in the “future” K_{F}.

### 2.3.7. The Function of Weakening the Weights of Objects in the Attention Window

INI contains an Adder (i.e. Totalizer) with a Adder activation function, a plurality of Group A Sensors, each of which is equipped with an activation function and a memory cell for placing the Corresponding weight value A and is located at the output of one of the buses of the PP Device of the hierarchy level N, as well as a plurality of Sensors D, each of which equipped with a memory cell and a device for measuring and changing at least one of the signal characteristics and is located at the inputs of one of the buses of the PP of the hierarchy level N; moreover, each of the Group D Sensors is connected to the output of the Adder, and each of the Sensors of the A group is connected to the input of the Adder, in addition, the output of the Adder is equipped with a connection with the input of one of the buses of the PP device of the upper hierarchy level (N+1); The INI learning mode is carried out in cycles, and on each cycle an ordered set of one or more learning signals (hereinafter “Attention Window”) are fed to the inputs of one or more PP buses of hierarchy level N, and the signals in the Attention Window are ordered using the attenuation function. Each of the signals passes through one or more INVs located in the hierarchy level N of PP and the named one or more INV changes one of the signal characteristics encoding the co-occurrence weight and at the output of each of the plurality of PP buses of the hierarchy level N a signal is obtained encoding the co-occurrence weight from which the value of the weight of the co-occurrence of the corresponding bus is retrieved and the weight is transferred to the Adder, where the weights obtained from the outputs of different buses are summed up and the value of the cycle sum is stored, after which the Attention Window changes and the learning cycle repeats, and at each next learning cycle the value of the sum of the next cycle is compared with the sum value of the previous cycle, and if the value of the sum of the next learning cycle is equal to or less than the value of the sum of the previous learning cycle, training of the INI stops and the Corresponding value of weight A (hereinafter “activation weight”) obtained for the learning cycle with the maximum sum of weights by each sensor of group A is assigned as the activation value of the activation function of sensor A, the Adder assigns the activation function of the Adder the value of the maximum sum of the weights or assigns the value of the number of sensors of group A with non-zero values of the Corresponding weights A or assigns both of these values, and each sensor of INI of group D at the input of each of the PP buses of the hierarchy level N, to which signals were applied during the learning cycle with the maximum sum of weights, measures and places in the Sensor D memory cell The Corresponding value D of at least one of the characteristics of the learning signal encoding the named value of the attenuation function D of the bus signal in the Window Attention; in the INI playback mode, the playback signal is fed to one or a plurality of PP buses of the hierarchy level N and the co-occurrence weight is obtained at the output of the plurality of PP buses of the hierarchy level N and, if the co-occurrence weight obtained at the bus output is equal to or greater than the value of the sensor activation function A of such a bus, sensor A sends to the Adder either the value of the activation weight or a value “one” or both values, and the Adder sums the obtained values of the activation functions of sensors A and compares the resulting sum with the value of the activation sum of the Adder and, if the total value is equal to or exceeds the value of the activation function of the Adder, then the activation signal INI is fed to the output of the Adder, which is then simultaneously fed to the input of one of the buses of the hierarchy level (N+1) of PP and to the inputs of the sensors of the group D of the hierarchy level N of PP, the memory cell of each of which contains the named Corresponding value of the attenuation function D, and each of the named sensors of group D changes the Adder signal in accordance with the Corresponding value of the attenuation function D and feeds the modified signal to the input of the corresponding PP bus of the hierarchy level N or does not change the signal and feeds the unchanged signal to the input of the corresponding PP bus of the hierarchy level N.

One of the signals simultaneously applied to each of the buses is changed so that the difference in the signals indicates the direction from the bus with a higher number to the bus with a lower number, or vice versa from the bus with a lower number to the bus with a higher number, and each INV is equipped with not one, but with two Counters, one for changing the last co-occurrence value in the direction from the bus with a higher number to the bus with a lower number and the second for changing the last occurrence value in the direction from the bus with a lower number to the bus with a higher number.

As mentioned above, the weighting coefficient wᵢ is the weight of the co-occurrence of the key C_{N} object with the frequent object Cᵢ on the entire sequence corpus. However, in each specific sequence, these two objects can be separated by a different number of other K objects, and it is obvious that each case of mutual occurrence must correspond to a different bond weight, which will be the less, the larger the number r of objects separating the C_{N} and C_{Nr} objects in a particular sequence is. If the weakening of the connection is depicted as a decrease in the color saturation of the object, then the sequential input of the sequence of objects, the last of which was the object C₀, will look as shown in FIG. 3.

The decrease in the weight of the connection (synapse) is calculated for each case of co-occurrence separately. It is advisable to weaken the weight of the specific case of mutual occurrence with increasing distance r between objects C₁ and Cᵢ: the greater the distance between objects, the weaker the connection between them, which we will express as the value of the weight of the connection w^{r}, where r is the rank of the connection. In general, the object weight reduction function Cr in the sequence shown in FIG. 3, may differ for different cases (Formula 7—Attention window attenuation function):

w^{r}=ƒ(r),

or

w=ƒ(r)

And for the appearance of an arbitrary frequent object Cᵢ in all sequences of the hemisphere (Cluster) of the key C_{N} object, the function should be written as (Formula 8—Total weight of the object in the Cluster):

$${w}_{i} = {\sum }_{s = 1}^{S} {f}_{i}^{s} ( r )$$

where S—is the number of sequences included in the hemisphere (Cluster) of the key object Cᵢ.

Cluster of key object C_{N}, built on S sequences (Formula 9):

$${K}_{N} = {{\sum }_{i = 1}}^{I} {w}_{i} * {C}_{i} = {{\sum }_{i = 1}}^{I} {C}_{i} * ( {\sum }_{s = 1}^{S} {f}_{i}^{s} ( r ) )$$

### 2.3.8. Attention Window Object Numbering Function

As shown above, the weight loss function ƒ(r) allows to assign weight coefficients w to the objects of each sequence within sphere R and sum coefficients for each unique object to determine the total weight of such a unique frequent object in the cluster of future or past. Since different loss functions can be used in different solutions and by different researchers, we will simply talk about the weight loss function ƒ(r) or the weight w of the object (Formula 10—weight loss function).

w=ƒ(r)

The weight loss function can be applied to the attenuation of any measurable physical characteristic—frequency, strength, tension or tension, and so on. For example, if the ƒ(r) function is applied to the frequency of the oscillation of the signal, then we will receive frequency separation and will be able to determine the rank of the frequent object relative to the key object by the frequency of signal of the frequent object.

Obviously, the value of r can be determined by the numbering function (Formula 11—Numbering function of Attention Window objects)

r=g(w)

Note 2 (Numbering function and weighting function of the Attention Window):

The placement function or numbering of frequent objects in the Attention Window r=g(w) is the function inverse of the weighting function w=ƒ(r).

The weight loss function can be linear, or use the Paretto distribution or Zipf's law, or the quadratic function or exponential function and so on. From a practical point of view, it makes sense to choose a function for which, for each 0<r≤R, the condition (Formula 12) is satisfied:

$$f ( r ) > {\sum }_{j = r + 1}^{R} f ( i )$$

This allows you to select objects of different rank by their weight.

Each frequent object Ci can occur at a distance r from the key object C_{N} not in all sequences S that fall within the sphere of the key object C_{N} (see Formula 8), so the inequality (Formula 12) can be rewritten as (Formula 13):

$${f}_{i} ( r ) > {\sum }_{j = r + 1}^{R} {\sum }_{s = 1}^{S} {f}_{i}^{s} ( r )$$

Formula 13 allows you to rank frequent objects in the Cluster, considering the total weight of each frequent object as the probability of its appearance at a distance

r=g(ƒᵢ(r))

### 2.3.9. Sequence Clustering

An object cluster is an invariant representation of an object. Generally speaking, the converse statement is not correct—different objects with the same meaning may correspond to the same Cluster, in particular for a language, due to the presence of word forms and synonymy. Thus instead of a sequence of objects, it is convenient to operate with the sequence of the Clusters generated by them, therefore the function of weakening the weight ƒ(r) can be applied not only to objects, but also to their Clusters. Therefore, we will also talk about the weight weakening function ƒ(r) or the weight wi of the Cluster Kᵢ for the object Cᵢ.

FIG. 4 shows an example of a sequence of objects and Clusters generated by these objects. The bond strength of frequent objects of one Cluster with frequent objects of other Clusters changes with increasing distance between them in accordance with the weight loss function ƒ(r).

The Total Weight of the Pipe is counted by extracting and adding the weights of the occurrence of all frequent Objects forming the set of the Pipe.

Summing up the Clusters (Formula 9), taking into account their weakening in the sequence, we obtain (Formula 14—Sum of Clusters of Attention Window objects)

$${K}^{\sum } = {\sum }_{r = 1}^{R} f ( r ) * {K}_{r} = {\sum }_{r = 1}^{R} f ( r ) * \{ {\sum }_{i = 1}^{I} {w}_{i} * {C}_{i} \} = {\sum }_{r = 1}^{R} f ( r ) * \{ {\sum }_{i = 1}^{I} {C}_{i} * ( {\sum }_{s = 1}^{S} {f}_{i}^{s} ( r ) ) \}$$

It's obvious that:

K^{Σ}∝(ƒ(r))²

### Statement 3

Taking into account the condition (Formula 13), it can be argued that the weights of frequent objects, whose rank is greater than one r>1, turn out to be of such an order of smallness that they can be neglected, and therefore, when calculating K^{Σ}, instead of full Clusters Kᵣ, one can add only clusters of the first rank. Kᵣ¹ (Formula 15—Sum of Sequence Clusters):

$${K}^{\sum } = {\sum }_{r = 1}^{R} f ( r ) * {K}_{r}^{1}$$

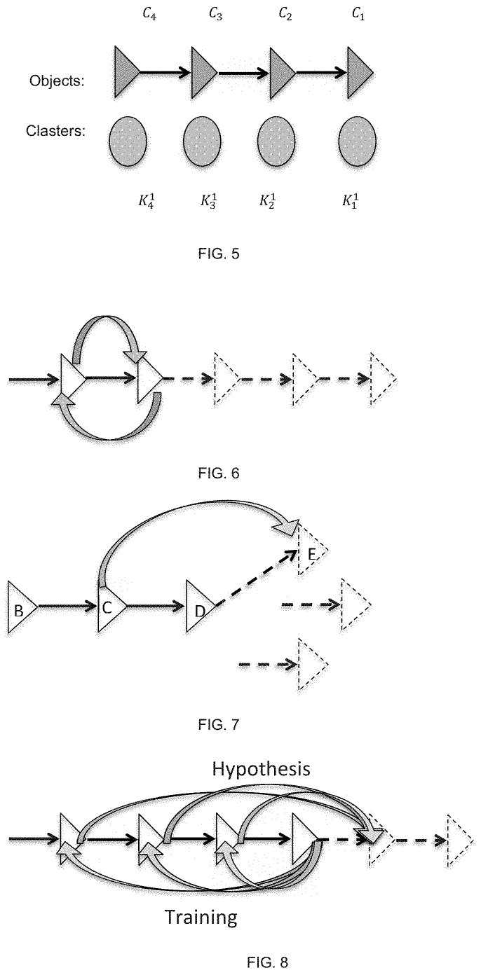

When constructing a Full Cluster of Key Object for a sphere of radius R, we count all (+R) future' and (−R) past' objects from all sequences containing the key object. Nevertheless, any sequence of objects can be represented by a sequence of links of the 1st rank between neighboring objects, which corresponds to the Clusters of the 1st rank (FIG. 5).

An array of “future” or an array of “past”, or a set of a rank other than the base rank are represented by a set derived from the MSP set.

The named set is a set of the first rank and contains the weights of the frequent Objects immediately adjacent to the named Key Object in the named sequences.

Statement 4

Any Full Cluster for a sphere of radius R is a linear composition of Clusters of the 1st rank of the set of all unique objects and (Formula 15) is correct.

Statement 5

However, a Cluster of an arbitrary rank N is also a derivative of a Cluster of the first rank, and therefore any complete Cluster for a sphere of radius R can also be represented as a linear composition of Clusters of rank N of the set of all unique objects.

Another important property of the unnumbered memory of sequences is the symmetry of the weights, namely, that the weight of the connection to future w_{N→i} is equal to the weight of the connection to past w_{i→N}. Therefore, for each unique C_{N} object, the sequence memory can store only one rank Cluster of the future (or past), and the Past (or future) Cluster can be synthesized as a linear composition of all links of the C_{N} object in the Future Kᵢ (or past) Clusters of all other unique memory objects Cᵢ sequences. We will demonstrate how to do this and for this we assume that all memory objects of the sequence are numbered from 1 to Max and for each object the memory stores the Cluster of the future. Task: to build a Cluster of the past K_{N} for some object C_{N} of sequence memory:
Step 1) We assume that i=1
Step 2) We extract from Cluster Kᵢ the weight w_{i→N} of the connection Cᵢ→C_{N} of the key object Cᵢ with the frequent object C_{N} of the Cluster
Step 3) We assume that the extracted weight w_{i→N} of the future for Cᵢ→C_{N} corresponds to the weight w_{N→i} of the past for C_{N}→Cᵢ, between the object C_{N} and the object Cᵢ.
Step 4) We Include the weight w_{N→i} of the connection between objects C_{N}→Cᵢ into the K_{N} cluster of pasts for C_{N} object
Step 5) We assume that i=i+1 and if i≤Max, then go to Step 1, and if i>Max, consider the cluster of past K_{N} of the C_{N} object is formed.

### Statement 6

In the memory of unnumbered sequences, for each unique C_{N} object, it is sufficient to store one cluster of future (or past) K_{N}, and the appropriate cluster of past (or future) K_{-N} can be reproduced as a linear composition of all future (or past) clusters) Kᵢ of the sequence memory.

### 2.3.10. Generation of Questions

A certain set of all rank sets of the base rank is stored in memory as a “Reference Memory State” (hereinafter referred to as “ESP”), and any “Instant memory state” (hereinafter “MSP”) or part of it, is compared with the ESP or its part to identify deviations of the MSP from the ESP.

The Sequence Memory operates with a finite number of unique objects and the full set of weights of the co-occurrence of each unique C_{N} object with each other unique frequent object C_{K} at each moment of time characterizes the state of the Sequence Memory (hereinafter “Memory State” or “Consciousness State”). If each of the objects is represented by the Cluster of the 1st rank of the “future”, then the linear composition of the 1st rank Clusters of the future of all unique objects of the Memory of Sequences will characterize the instantaneous statistical state of the Memory of Sequences Kₛₜₐₜₑ (Formula 16—“State of consciousness” of the Memory of Sequences):

$${K}_{state} = {\sum }_{i = 1}^{N} {K}_{i}^{1}$$

Obviously, the weight w_{K→N} of the connection of future of C_{K}→C_{N} in the K_{K}¹ Cluster corresponds to the weight w_{N→K} of the connection of past of C_{N}→C_{K}, between the objects C_{N} and the C_{K}, in the Cluster K_{N}⁻¹ and the weights are equal W_{N→K}=w_{K→N}. Therefore, to build the Kₛₜₐₜₑ array, it is sufficient to use either only the weights of the connections of “future” or only the weights of the connections of “past”.

The memory state can also be represented by a two-dimensional diagonal matrix, in which nonzero values are located only in one part, for example, under the diagonal, and the weights of the occurrence of objects with themselves are placed on the diagonal can be equal to zero.

$${K}_{State} = ( \begin{matrix}{w}_{11} = 0 \\ {w}_{21} , {w}_{22} = 0 \\ {w}_{31} , {w}_{32} , {w}_{33} = 0 \\ {w}_{41} , {w}_{42} , {w}_{43} , {w}_{44} = 0 \\ … \\ {w}_{N 1} , {w}_{N 2} , {w}_{N 3} , {w}_{N 4} , … , {w}_{N ( N - 1 )} , {w}_{NN} = 0\end{matrix} )$$

Nevertheless, for the language, the co-occurrence of word with “itself” is widespread, for example, “well, well, well” or “we are driving, driving, driving,” and so on, so in the general case, the values of the diagonal weights of the state matrix may be non-zero (Formula 17—Diagonal memory state matrix):

$${K}_{State} = ( \begin{matrix}{w}_{11} \\ {w}_{21} , {w}_{22} \\ {w}_{31} , {w}_{32} , {w}_{33} \\ {w}_{41} , {w}_{42} , {w}_{43} , {w}_{44} \\ … \\ {w}_{N 1} , {w}_{N 2} , {w}_{N 3} , {w}_{N 4} , … , {w}_{N ( N - 1 )} , {w}_{NN}\end{matrix} )$$

A noticeable advantage of the proposed model from neural networks and from convolutional neural networks is that, unlike neural networks, the proposed model allows you to control the “memory state” of robots. Namely, if you set some Reference Memory State K̅ₛₜₐₜₑ (ESP), then any instantaneous deviation of the memory state from the state K̅ₛₜₐₜₑ can be interpreted as an instant (for example, input error) or long-term (learning error) deviation of the memory state from ESP K̅_{State}. This deviation from the ESP can be used as a trigger to start in the Sequence Memory the process of searching for the cause of such deviation in order to detect instantaneous or long-term deviations.

In the particular case of the PP design, it additionally contains a memory in which at least one reference value of a counter is located for at least one specific INV, and the last counter value of the named INV is retrieved and compared with the said reference value.

In the particular case of the PP design, it additionally contains a calculator for calculating the said reference value, and the calculation of the reference value is performed using the last values of the counters of at least two different INV of the triangle plate.

In the particular case of the INV design, it is equipped with means of replacing the last value of the counter with the named reference value, and the replacement of the last value with the reference value is performed when the corresponding instruction arrives at the device.

The reference state K̅_{State} can be the state of the system in which, for example, a robot is unable to violate the robotics laws described by Isaac Asimov or another set of rules. It is also possible also monitor the Memory State of the robot in order to detect Reference Pathological States in it. To do this, the robots memory should be trained on “bad” sequences, for example, teach a fascist or other ideology of hatred, store the Pathological State of Memory (PSP) of the robot after training, and use this PSP to prevent the appearance of PSP in robots in the future.

The deviation of the “local context” of the input sequence from the larger “current context” should generate what people call a “question”, and the search for the reason for the deviation of the context is the search for the “answer” to such a question. For example, entering a word with an error should generate a discrepancy with the general context and, as a consequence, should generate a process of error correction or memory correction to reflect a new reality. The problem of finding the cause of the deviation can be formulated as the problem of finding the connection between the “local context” and larger-scale “current contexts” in the past or in the future.

Another illustration of deviation of local context from a larger-scale current context is a situation in which I ask you for a pen, and instead of a pen, you give me a carrot and I need to remember that yesterday I asked you to bring me a carrot for my pet rabbit. However, if I do not remember my request to bring a carrot, then I may consider your behavior inadequate—not corresponding to the normal stable statistical state of consciousness. Drawing a parallel with consciousness, a stable statistical state can be called a “normal state of consciousness”, and deviation from such a stable statistical state can be characterized as a “state of altered consciousness.”

### Statement 7

From the formula “States of consciousness” (Formula 16) it follows that each Cluster of the 1st rank is a subset of the “state of consciousness” matrix Kₛₜₐₜₑ, and therefore any state of the Sequences Memory can be a subset of the elements of the Kₛₜₐₜₑ matrix.

Therefore, any array of “future” or array of “past”, or a rank set of a rank other than the set of the base rank, can be represented with a set derived from the set of MSP.

### 2.3.11. Analysis of “Memory State”

Analysis of the State of Memory can use methods of the present work, but neural networks, in particular convolutional neural networks, can also be used for analysis. To do this, the neural network should be trained on various “Memory States” by introducing the weights of object co-occurrences stored in the Memory State matrix (Formula 17) as initial data or “feature maps” during learning and use of neural network.

### 3. Memory of Unnumbered Sequences

Earlier we looked at sequence memory in the form of a Recursive Index, where all sequences and all objects in sequences are numbered. Numbering allows restoring of any sequence and order of objects in it while retrieving. However, a human′ memory stores sequences without numbering and, nevertheless, knows how to store and retrieve them. How does she do it?

### 3.1. Features of Unnumbered Sequences

Let us explain how the memory of unnumbered sequences works on the example of a network of roads with traffic lights. Imagine that cars move on roads with intersections equipped with traffic lights, and the routes of cars are set by a sequence of traffic lights that the car must pass, however, no one knows the full routes, and traffic lights for certain roads at the intersection light up green only at a direction, if the intersection that the car is drove last confirmed that the car drove them in a certain order. In most cases, only one traffic light of each intersection can turn green for a car, depending on which three intersections the car has passed before. Thus, the traffic light system, not knowing the routes, knows how to control traffic along these routes, so that each traffic light knows three consecutive previous intersections that the car must pass in order to have the right to exit the intersection under this traffic light.

### 3.1.1. Connectivity of Recursive Index' Hits

Considering the hits of the RI, we can say that these are partially overlapping fragments of the sequence, and the central unique object of the hit is the key object, and the objects of intersection of the hit with the previous and next hits are the “previous” and “next” objects stored in the hit of the key object, which represent, respectively backward and forward link of the key object to the previous and subsequent hits in the sequence. It is this property of the Recursive Index—the partial intersection of hits, which we will use to omit the numbering, replacing the numbering with a mechanism for comparing a set of hits for their partial coincidence, which should indicate the relationship between them. Thus, from the deterministic search mechanism in the RI, we will pass to the probabilistic search in the Unnumbered Sequence Memory.

At the time of creation of any hit, writing the “next” sequence object to it is impossible until such a next object is added to the sequence. Thus, the recording of the “next” object in a hit is possible only at the step of entering such a “next” object and recording the next hit in the RI. That is, the Recursive Index current hit needs a feedback to the previous hit, according to which, at the current step of indexing, the previous hit will be informed what the current sequence object turned out to be (FIG. 6).

As seen in FIG. 6, the backword link, observed in the process of memorizing the sequence (storing to the index), is used as a forward link during recollection (retrieving from the index), which allows recalling the “next” object of the sequence.

### 3.1.2. Refusal to Number Sequence Objects

According to the specified method, digital information is represented by a plurality of machine-readable data arrays, each of which is a sequence of many unique Objects, and each of the named Objects is represented by a unique machine-readable value of the Object, and each unique Object (hereinafter the “key Object”) appears, at least in some sequences, the Memory of Sequences is trained by feeding the sequences of Objects to the memory input, and the memory, each time the key Object appears, extracts the objects that precede the named key Object in of the named sequence (hereinafter referred to as “frequent Objects of the past”), increases by one the value of the counter of the co-occurrence of the key Object with each unique frequent Object and updates the counter value with a new value, and the set of counter values for different x unique frequent Objects it combines into an array of weight coefficients of the mutual occurrence of the key Object with unique frequent Objects of the data array of the “Past”, as well as memory, at each appearance of the key Object, extracts from the named sequence the objects following the named key Object in the named sequence (hereinafter referred to as “frequent Objects of the future”), increases by one the value of the counter of the mutual occurrence of the key Object with each unique frequent Object and updates the counter value with a new value, and combines the set of counter values for different unique frequent Objects into an array of weight coefficients of the mutual occurrence of the key Object with unique frequent objects of the data array of the “Future”. Each data array for the set of objects of “Past” and for set of objects of “Future” is being divided into subsets (hereinafter “rank sets”), each of which contains only frequent Objects equidistant from the named key Object either in the “Past” or in the “Future”, and each unique key Object is put in mutual correspondence and stored in the PP the named key Object itself and at least one of the named rank sets of the named unique key Object, containing at least the value of the counter of the mutual occurrence of the named unique key Object with each unique frequent object; and the search for the named rank set of weights by the entered named unique key Object or the search for the named unique key Object by the entered named rank set or part thereof is provided in the named data arrays for sets of objects.

Using backward and forward links, one can abandon the numbering of sequence objects and create a sequence memory in the database, in which a hit will contain a fragment—a queue of H consecutive sequence objects. Earlier, using neuroanalogy, we called such a queue the Attention Window [2.2.7.], However, for the unnumbered memory of sequences, the Attention Window is a numbered segment in which the order of the objects in the queue is specified using relationships between objects backward and forward. By shifting the queue by at least one object Δ=1 forward, we get a new hit' queue—the Attention Window, in which the earliest object of the previous hit is missing and a new latest object is added (FIFO). Thus, each next hit (k+1) will contain a fragment of the previous hit k, and hits k and (k+2) separated by the hit (k+1) will differ by four objects—a pair of the earliest objects and a pair of the latest ones. In general, two hits k and (k+n), separated by other hits, will contain a common fragment of length h:

h=H−2*(n+Δ)

If we want n consecutive hits to contain a common fragment of a given length h, then the length of the fragment stored in the hit (Attention Window) must be equal to:

H=h+2*(n+Δ)

For Δ=1, n=3 and h=3, we get H=3+2*(3+1)=11. The result obtained demonstrates the minimum fragment length that should be stored in a hit so that three consecutive hits contain a common fragment of 3 objects long. By increasing the number of matching objects (provided that N>(2*n)), we reduce the probability of error when searching for related hits is inversely proportional to the number of combinations from N to n:

$$\frac{1}{{C}_{N}^{n}} = \frac{n ! * ( N - n ) !}{N !} ,$$

where N is the number of all unique objects on the set of which the sequence memory is built.

Neurons form physical backward-forward connections with each other. In the index of unnumbered sequences, the function of physical connection of neurons is performed by the processes of searching and comparing hits, which creates a backward-forward connection between hits that store the same fragment of the sequence. It is clear that the same fragment may turn out to be part of a hit that does not belong to the desired sequence, and therefore, as noted above, the process of recalling unnumbered sequences in memory will not be deterministic, but probabilistic.

The Hit of Unnumbered Sequence Memory, in addition to the named fragments of “previous” and “next” objects, can also contain other data:

Hit={objects of the past, object of a hit, objects of the future, other data}

Let us illustrate this by an example of a sequence of letters of the Latin alphabet (A, B, C, D, E, F, G, . . . ) hits of objects B and C will contain the same fragments {B, C, D} (Formula 18—Formula of a hit of an unnumbered sequence):

hit_B={_,A,B,C,D}

and

hit_C={A,B,C,D,E}

where the space character “_” denotes the empty feedback of the beginning of the sequence.

As you can see in the above hits, a fragment of the sequence {B, C, D} matches, which allows the Recursive Index to decide whether both hits belong to the same sequence (see FIG. 7) and allows predicting the appearance of the next object in the sequence—the letter E, based on her appearance in “hit_C”. It is also obvious that the construction of a hypothesis is reduced to the search for consecutive fragments of the sequence represented by hits, the intersection of which is a non-empty set (Formula 19):

hit_B∩hit_C={B,C,D}

and the subsequent search for hypothesis E as an addition Δ(hit_B) of the set of objects “hit_B” to the set of objects “hit_C” (Formula 20):

E=Δ(hit_B)=(hit_C)\(hit_B)

As you can see (see FIG. 7), the memory operation of unnumbered sequences gives not an exact, but a probabilistic result when extracting sequences, in fact, the Recursive Index of Unnumbered Sequences (RINP) is an associative memory.

It is easy to see that if we extract all objects of the past or objects of the future from all hits of a specific unique object in all sequences and combine the extracted objects of the past or future into one set, then we get the Cluster of the past or the Cluster of the future of this unique object, which we talked about above. The cluster of an object is built from all the sequences containing the object for which the Cluster is being built, and therefore, when building the Cluster, it is not necessary to know the sequence number.

Different sequences can have the same fragments, therefore, in our example with traffic lights, at the intersection, not one, but several traffic lights can light up green at the same time, but they can burn with different brightness: all green traffic lights lead to the roads corresponding to our route, but the brighter the green traffic light, the more often this road was used for the route you follow. You also see red traffic lights, which indicate roads that have never been used before for the route you are following now, and if you choose a road with a red traffic light, you or may not reach your destination, or instead the road indicated by a red traffic light may be shorter than roads even with the brightest green traffic lights—it's just that this road with a red traffic light has never been used before for the route you now follow.

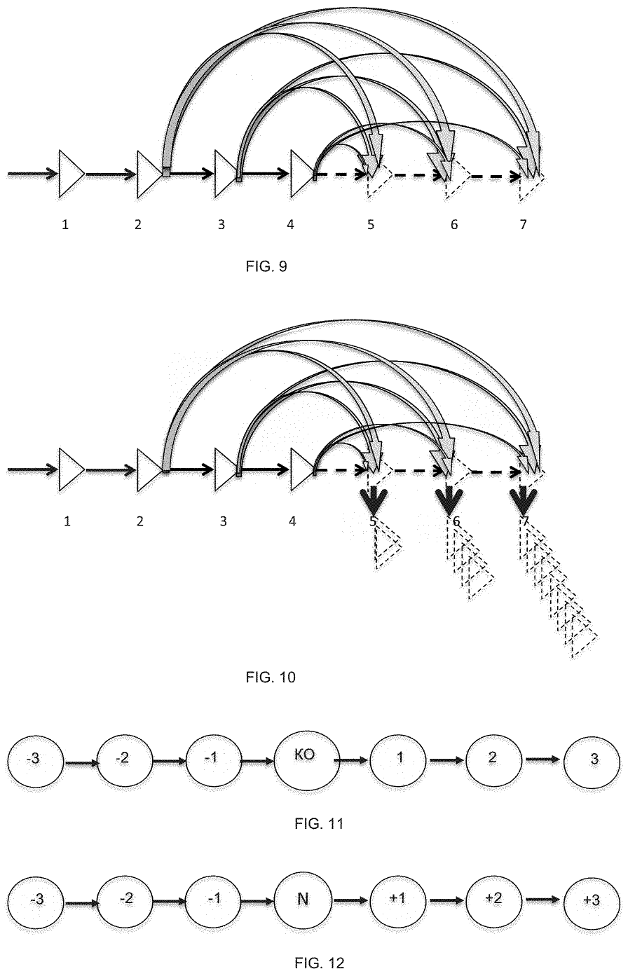

Despite the difference in names, both forward and feedback links are one and the same relationship of two objects—forward for previous and feedback for following object. The memory of sequences (see FIG. 8) in the process of indexing (memorization or learning) creates feedbacks, which are used as feedforward links in the process of retrieving sequences (recollecting or predicting).

As one can see, for unnumbered sequences, the hypothesis mechanism is the only process that retrieves sequences from memory.

### 3.2. Forecasting

Next, we will begin to distinguish between two types of predictions and predictions: prediction/forecasting of the future, hereinafter referred to as the “scientist's task”, and restoration/reconstruction of the past, hereinafter referred to as the “pathfinding task”, as well as correction of input errors.

### 3.2.1. General Approach to Forecasting

From the previous reasoning, it follows that each sequence object recorded in the memory of unnumbered sequences has backward and forward connections with all objects recorded in the sequence memory in the past and future of these sequences to a depth R of objects, where R represents the radius of the past/future sphere. This allows one to “see” the hypotheses of unknown objects 5, 6 and 7 in the Clusters of the future, built for the known objects of the sequence 2, 3 and 4 (see FIG. 9).

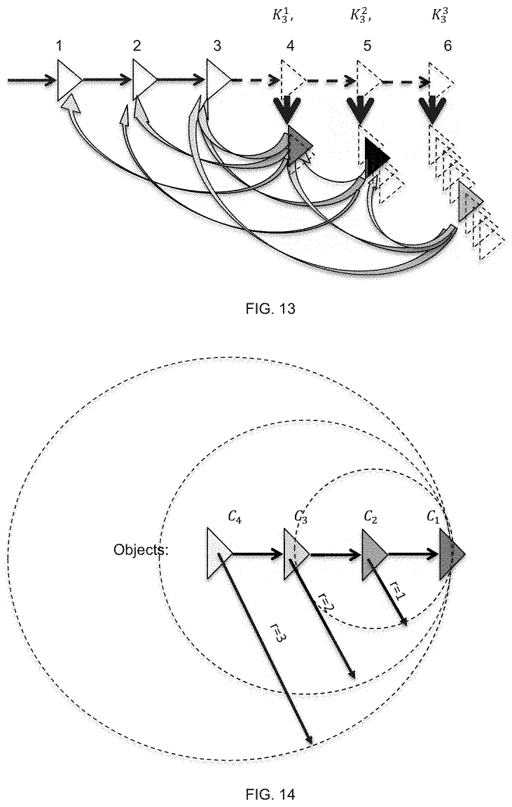

At the same time, the number of hypotheses grows exponentially with increasing prediction depth (see FIG. 10), thereby reducing the likelihood of realizing deeper hypotheses.

Despite the fact that forecasting for the “scientist's task” is considered, it is clear that when solving the “pathfinders task” the number of hypotheses will also grow with increasing depth of forecasting in the past.

### 3.2.2. Frequent Object Ranks and Cluster Ranks

In the chapters devoted to numbered sequences, we described the Key Object Cluster, in which we recorded all frequent objects included in a ball of radius R. This was explained by the fact that inside the ball there were objects whose sequence numbers were known. However, for the analysis of unnumbered sequences, it is more convenient to consider a set of Clusters, each of which will include only frequent objects with the same rank lying on the surface of a sphere of radius r centered at the key object, where 1≤r≤R for the hemisphere of the future and −R≤r≤−1 for the hemisphere of the past. Thus, we get a set of Clusters of the past K_{-R}, . . . , Kᵣ, . . . , K₋₁ and a set of Clusters of the future K₁, . . . , Kᵣ, . . . , K_{R}, where the subscript r is the rank of the corresponding Cluster . . . . The rank of the Cluster is determined by the rank of the frequent objects of the corresponding rank that are included in it. FIG. 11 shows the Key Object (KO), as well as three frequent objects (−3, −2, and −1) each preceding the Key Object in a specific sequence and three (1, 2 and 3) located after the Key Object. Frequent objects of the first rank (−1 and 1) are objects directly related to the key object in the sequences recorded in the RI. Frequent objects of the second rank (−2 and 2) are objects separated from the Key Object by an object of the first rank, and objects of the third rank (−3 and 3) are objects separated from the Key Object by objects of the first and second ranks (−2, −1, 1 and 2) and so on. It is clear that the Cluster of the first rank includes frequent objects of the first rank, the Cluster of the second rank includes frequent objects of the second rank, and so on.

3.2.3. Technique for Retrieving Unnumbered Sequences from Memory

Let us illustrate the Rank Cluster technique, which allows us to retrieve unnumbered sequences from sequence memory. In order for the technique to work, it is necessary, in the process of memorizing sequences, to form the rank Clusters of each unique memory object for its occurrence with other unique sequence objects located in the memory of unnumbered sequences. Let us assume that the Attention Window is 7, so that for each unique object “N” in the process of learning the memory of sequences, six rank Clusters are formed—three for the past K⁻³, K⁻², K⁻¹ and three for the future K¹, K², K³ (FIG. 12).

Suppose the entered fragment of the sequence consists of three objects {1, 2, 3} (FIG. 13), the last entered of which is indicated by the number “3”, and we need to find the objects “4”, “5”, “6”, which are possible continuation of the fragment presented to us.

From the problem statement it follows that for the last introduced object we know three rank Clusters K₃¹, K₃², K₃³. The subscript in the designation of the rank Cluster K₃¹ means the object “3” for which the rank Cluster is built, and the rank of the Cluster “1”, “2” and “3” is indicated in the superscript. It is clear that object “4” is one of the objects of rank Clusters of the future K₃¹, K₂² and K₁³, and in each of rank Clusters of the past K₄⁻³, K₄⁻², K₄⁻¹ of the object itself, there must be objects of the past corresponding to the rank “3”, “2” and “1”:

«4»∈K₃¹

«4»∈K₂²

«4»∈K₁³

And to search for copies of the input sequence in memory, the conditions must also be met (Formula 21):

«3»∈K₄⁻¹

«2»∈K₄⁻²

«1»∈K₄⁻³

It should be noted that since the sequences are unnumbered, the named conditions (Formula 21) may correspond not one, but several unique memory objects, and we will consider this case below [3.2.5]. Suppose we have found one or more elements “4” satisfying the above conditions (FIG. 13). If the found object “4” is a continuation of a given fragment, then in its first rank Cluster of the future K₁⁴ there is an object “5”, which is a continuation of the sequence, for which the following conditions must be satisfied simultaneously (Formula 22—Confirmation of the hypothesis):

«5»∈K₄¹

«5»∈K₃²

«5»∈K₂³

And also for copies (Formula 23—The hypothesis confirms the presence of copies):

«4»∈K₅⁻¹

«3»∈K₅⁻²

«2»∈K₅⁻³

If earlier more than one challenger was found as object “4”, then at the stage of searching for object “5” some of the challenger for object “4” will not be able to satisfy the conditions (Formula 22), which will narrow the number of candidates at each next iteration of the search for the continuation of the fragment. For the next object “6”, which must be contained in the rank Cluster K₁⁵, the conditions already known to us must also be met:

«6»∈K₅¹

«6»∈K₄²

«6»∈K₃³

And also for copies (Formula 24):

«5»∈K₆⁻¹

«4»∈K₆⁻²

«3»∈K₆⁻³

And again, at this iteration, you can get rid of applicants for object “4” and “5” if they do not meet the conditions (Formula 24).

Thus, the use of backward and forward links, rank Clusters and their reverse projections, allows the extraction of sequences located in the memory of unnumbered sequences.

The technique of using Rank Clusters to retrieve sequences is provided as an example to demonstrate the ability to retrieve sequences from unnumbered sequences memory. At the same time, professionals can propose another extraction technique based on the use of memory of unnumbered sequences and the use of Clusters, in the spirit of the approach outlined in this work.

### 3.2.4. Weight Condition for Copies

If the input sequence is a copy of the sequence previously stored in the sequence memory, then the weight of the known (R−1) objects (C₁, C₂, . . . , C_{(R-1)}) of the input sequence in the Rank Clusters of the past generated by the last entered or predicted object C_{R}, must satisfy the condition (Formula 25—Weight condition for the presence of copies of the input sequence):

$$( {w}_{( R - 1 )} * {C}_{( R - 1 )} ) ∈ {K}_{R}^{- 1} wherein {w}_{( R - 1 )} \geq f ( 1 )$$

$$( {w}_{( R - 2 )} * {C}_{( R - 2 )} ) ∈ {K}_{R}^{- 2} wherein {w}_{( R - 2 )} \geq f ( 2 )$$

$$…… \\ ( {w}_{1} * {C}_{1} ) ∈ {K}_{R}^{R - 1} wherein {w}_{1} \geq f ( R - 1 )$$

If the conditions (Formula 25) are met, then the C_{R} object can be a continuation of the sequence previously allocated in the sequence memory.

3.2.5. Full and Ranked Clusters of the Key Object. The Pipe.

The technical result for the object “Method for creating and functioning of the Sequence Memory” is achieved due to the fact that in the specified method, where digital information is represented by a plurality of machine-readable data arrays, each of which is a sequence of a plurality of unique Objects, and each of the named Objects is represented by a unique machine-readable value of the Object, and each Object (hereinafter the “key Object”) appears, at least in some sequences, the Memory of Sequences is trained by feeding the sequences of Objects to the memory input, and the memory, each time the key Object appears, extracts from the named sequence the objects that precede the named key Object in of the named sequence (hereinafter referred to as “frequent Objects of the past”), increases by one the value of the counter of the co-occurrence of the key Object with each unique frequent Object and updates the counter value with a new value, and the set of counter values for different unique frequent Objects it combines into an array of weight coefficients of the mutual occurrence of the key Object with unique frequent Objects of the data array of the “Past”, as well as memory at each appearance of the key Object extracts from the named sequence the objects following the named key Object in the named sequence (hereinafter referred to as “frequent Objects of the future”), increases by one the value of the counter of the mutual occurrence of the key Object with each unique frequent Object and updates the counter value with a new value, and combines the set of counter values for different unique frequent Objects into an array of weight coefficients of the mutual occurrence of the key Object with unique frequent Objects of the data array “Future”; the set of objects of each of the derived data arrays “Past” and “Future” is divided into subsets (hereinafter “rank sets”), each of which contains only frequent Objects equidistant from the named key Object either in the “Past” or in the “Future”, and each unique key Object is put in mutual correspondence and stored in the PP the named key Object itself and at least one of the named rank sets of the named unique key Object, containing at least the value of the counter of the mutual occurrence of the named unique key Object with each unique frequent Object, and also making available the search for the named rank set of weights by the entered named unique key Object or the search for the named unique key Object by the named rank set or part thereof.

Continuing the reasoning of the previous section, we will consider numerical methods for predicting the appearance of Objects.

In general, the Full Cluster of the key object [symbol] C_{N} will be defined as follows (Formula 26):

K_{N}=[w₁*C₁;w₂*C₂; . . . ;wₙ*Cₙ;]

The weight coefficients wᵢ will be the sum of all the weights of the object Cᵢ in all sequences of the corpus (Formula 27):

$${w}_{i} = {\sum }_{i = 1}^{I} {\sum }_{r = 1}^{R} f ( r )$$

where I is the number of occurrences of the object C_{N} in the sequence corpus, R is the radius of the sphere, and the function ƒ(r) is defined only for 1≤r≤R where the object Cᵢ appeared.

Formula 26 describes the occurrence of an object with all other objects on the corpus of sequences, however, for some analysis tasks, it will be important to divide the Full Cluster of an object into Rank Clusters, each of which will include only frequent objects of the same rank 1≤r≤R (Formula 28—Cluster of rank z):

$${K}_{N}^{r} = [ {\sum }_{i = 1}^{k} {C}_{1} ; {\sum }_{i = 1}^{l} {C}_{2} ; … ; {\sum }_{i = 1}^{m} {C}_{n} ; ]$$

where k,l,m—the number of occurrences, respectively, of frequent objects C₁; C₂; . . . ; Cₙ at a distance r from the key object C_{N}.

The rank cluster shows the probability of the occurrence of specific frequent objects at a certain distance r from the key object in the entire corpus of sequences.

Now Formula 26 of the Full Cluster of a key object can be rewritten like this using Rank Clusters (Formula 29—Full Cluster of an object):

$${K}_{N} = \pm {\sum }_{r = 1}^{R} f ( r ) * {K}_{N}^{r}$$

Of course, Full and Ranked Clusters can be built both for the sphere of the future (with a plus sign) and for the sphere of the past (with a minus sign).

Just as an Object Cluster is an invariant representation of an object, a Sequence Cluster can serve as an invariant representation of a sequence.

Since each object of the sequence generates a Cluster, the connection between the generated Clusters will weaken (“fade”) with increasing distance between them according to the law ƒ(r). If the weakening function ƒ(r) is represented, for example, by Zipf's law, then the sum of Clusters, taking into account the weakening of bonds, can be represented as the sum:

$${K}_{\sum } = {\sum }_{r = 1}^{R} {K}_{r} * \frac{1}{r} = {K}_{1} + 0.50 * {K}_{2} + 0.33 * {K}_{3} + 0.25 * {K}_{4}$$

In general, the Full Sequence Cluster will be (Formula 30—Full Cluster of Object):

$${K}_{\sum } = {\sum }_{r = 1}^{R} {K}_{r} * f ( r )$$

where ƒ(r)—is the function of weakening the weight of the connection between the Clusters, and r is the distance between the clusters or the rank of the Cluster of the frequent object relative to the Cluster of the key object.

Considering that the Clusters themselves contain many frequent objects of common occurrence with the object that generated such a Cluster, and each frequent object in the Cluster is assigned a weight, then the weight of each frequent object when adding Clusters can be multiplied by the weight of the Cluster in the sequence of Clusters.

### Definition 3

The full Cluster of the sequence K_{Σ} (Formula 30) will further be called the Pipe and denoted by T. The operation of summing the Clusters generates a Cluster, so we can talk about the Convolution of Clusters of sequence objects into one Cluster—into a Pipe.

### 3.2.6. Coherent Rank Clusters

In the claimed method, rank sets of different ranks (hereinafter “Coherent sets”) are compared for known key Objects of the sequence, and the rank of the rank set for each key Object is selected corresponding to the number of Sequence Objects that separate the named key Object and the Hypothesis Object (hereinafter “Focal Object of coherent sets”), the possibility appearance of which is checked.

Let's call Coherent Clusters such Rank Clusters of different objects of the sequence, the rank of which is determined in relation to the location of the same object of the same sequence. In the figure (FIG. 14) Rank Clusters of objects are shown as circles. It can be seen that the object C₁ is simultaneously located at the intersection of Rank Clusters (K₄³∩K₃²∩K₂¹), respectively, of objects C₄, C₃ and C₂, therefore, the rank Clusters drawn in the form of circles are K₄³, K₃², K₂¹ and are called Coherent. Object C, should be a frequent object of the corresponding Coherent Clusters of objects C₂, C₃ and C₄, and this circumstance can be used to construct and analyze hypotheses for the appearance of objects, as well as to correct input errors.

Object C₁ for Coherent Clusters K₄³, K₃², K₂¹ will be called the “focal object” of Coherent Clusters or “focus of coherence” (see FIG. 14).

Obviously, the focal object is the result of the intersection of Coherent Clusters (Formula 31—Hypothesis as the intersection of Coherent Clusters):

C₁=(K₄³∩K₃²∩K₂¹)

C₂=(K₄²∩K₃¹∩K₁⁻¹)

C₃=(K₄¹∩K₂⁻¹∩K₁⁻²)

C₄=(K₃⁻¹∩K₂⁻²∩K₁⁻³)

Despite the fact that equal signs were used in the formula above (Formula 31), the intersection of Coherent Clusters may correspond not to one focal object, but to many. The presence of more than one focal object may be due to the presence of its synonyms or other reasons. Therefore, it would be more correct to write it like this (Formula 32—Hypothesis as one of the intersections of Coherent Clusters):

C₁∈(K₄³∩K₃²∩K₂¹)

C₂∈(K₄²∩K₃¹∩K₁⁻¹)

C₃∈(K₄¹∩K₂⁻¹∩K₁⁻²)

C₄=(K₃⁻¹∩K₂⁻²∩K₁⁻³)

Comparing the weight of the focal object or focal objects of the sum of Coherent Clusters (CC) with the weights of other frequent objects of the sum of CC, one can make a conclusion about the probability of the appearance of one or another focal object as the corresponding object of the sequence.

As mentioned above, the object of the sequence C₁ is simultaneously a frequent object of Coherent Clusters: K₄³ (Cluster of rank r=3 for object C₄), K₃² (Cluster of rank r=2 for object C₃) and K₂¹ (Cluster of rank r=1 for object C₂)). I.e.:

$${C}_{1} ∈ \{ \begin{matrix}{K}_{4}^{3} \\ {K}_{3}^{2} \\ {K}_{2}^{1}\end{matrix}$$

### Similarly:

$${C}_{2} ∈ \{ \begin{matrix}{K}_{4}^{2} \\ {K}_{3}^{1} \\ {K}_{1}^{- 1}\end{matrix} ,$$

and

$${C}_{3} ∈ \{ \begin{matrix}{K}_{4}^{1} \\ {K}_{2}^{- 1} \\ {K}_{1}^{- 2}\end{matrix}$$

And finally:

$${C}_{4} ∈ \{ \begin{matrix}{K}_{3}^{- 1} \\ {K}_{2}^{- 2} \\ {K}_{1}^{- 3}\end{matrix}$$

Obviously, the sum of the values of the weight function ƒ₁(r) for the object of the sequence C₁ (aka the focal object of Coherent Clusters) in the sum of Coherent Clusters K₄³, K₃² and K₂¹:

$${f}_{1}^{\sum } ( r ) = {\sum }_{i = 1}^{n} {f}_{1}^{i} ( r )$$

should tend to the maximum among the total weights ƒᵢ^{Σ}(r) all frequent objects Cᵢ of the sum of Coherent Clusters:

ƒ₁^{Σ}(r)→(ƒᵢ^{Σ}(r)) for all C₁∈(K₄³+K₃²+K₂¹)

Similarly, for other objects of the sequence in the example (FIG. 4) we get:

ƒ₂^{Σ}(r)→(ƒᵢ^{Σ}(r)) for all C₂∈(K₄²+K₃¹+K₁⁻¹)

and thus

ƒ₃^{Σ}(r)→(ƒᵢ^{Σ}(r)) for all C₃∈(K₄¹+K₂⁻¹+K₁⁻²)

and

ƒ₄^{Σ}(r)→(ƒᵢ^{Σ}(r)) for all C₄∈(K₃⁻¹K₂⁻²+K₁⁻³)

The described property of the hypothesis ƒₓ^{Σ}(r)→(ƒᵢ^{Σ}(r)) tending to the maximum weight among the total weights of frequent objects in the sum of Coherent Clusters can be used to solve the problems of “scientist” and “pathfinder”—searching for continuation hypotheses sequences to the future or the past, as well as to restore objects recorded with an error or missing sequence objects.

### 3.2.7. Forecasting the Future

If we know R objects of the sequence attention Window and we need to solve the scientist's problem by predicting the appearance in the future of an object C_{(R+n)} with number (R+n), then the sum of Coherent Clusters KK(C_{(R+1)}) in In general, it can be calculated as follows: Formula 33—Search for hypotheses of the future):

$${C}_{R + n} : \{ \begin{matrix}∈ KK ( {C}_{( R + n )} ) = {\sum }_{r = 1}^{R + n - 1} {K}_{r}^{( ( R + n ) + ( 1 - r ) )} \\ {f}_{R + n}^{\sum } ( r ) \to max ( {f}_{i}^{\sum } ( r ) ) for all {C}_{i} ∈ KK ( {C}_{( R + n )} ) \\ ∈ {{⋂}_{r = 1}}^{R + n - 1} {K}_{r}^{( ( R + n ) + ( 1 - r ) )}\end{matrix}$$

As shown above, when searching for previously recorded copies of a sequence (memory) for an object C_{R+n}, from a copy previously recorded in memory, simultaneously with the fulfillment of the condition (Formula 33), the following conditions must also be met (Formula 34—Additional conditions for searching copies):

$${C}_{( R + n ) - 1} ∈ {K}_{R + n}^{- 1} \\ {C}_{( R + n ) - 2} ∈ {K}_{R + n}^{- 2}$$

$$……$$

$${C}_{R} ∈ {K}_{R + n}^{- n}$$

$$……$$

$${C}_{R - 1} ∈ {K}_{R + n}^{- ( n + 1 )}$$

$$……$$

$${C}_{0} ∈ {K}_{R + n}^{- ( R + n )}$$

and also the weight conditions of the copy (Formula 25) must be met too.

### 3.2.8. Predicting the Past

And the pathfinders tasks (predicting the appearance of an object of the past C₍₋ₙ₎, the sum of Coherent Clusters can be found as follows (Formula 35—Search for hypotheses of the past):

$${C}_{- n} : \{ \begin{matrix}∈ KK ( {C}_{( R + n )} ) = {\sum }_{r = 1}^{R + n - 1} {K}_{r}^{( n + ( 1 - r ) )} \\ {f}_{- n}^{\sum } ( r ) \to max ( {f}_{i}^{\sum } ( r ) ) for all {C}_{i} ∈ KK ( {C}_{( - n )} ) \\ ∈ {{⋂}_{r = 1}}^{R + n - 1} {K}_{r}^{( n + ( 1 - r ) )}\end{matrix}$$

And also for searching copies (Formula 36—Additional conditions for searching copies):

$${C}_{- n + 1} ∈ {K}_{- n}^{1} \\ {C}_{- n + 2} ∈ {K}_{- n}^{2}$$

$$……$$

$${C}_{0} ∈ {K}_{- n}^{n}$$

$$……$$

$${C}_{R} ∈ {K}_{- n}^{( n + R )}$$

and also the weight conditions of the copy objects must be met (Formula 25).

### 3.2.9. Sequence of Predictions

Suppose we know R objects of the Window of Attention, and we want to solve the scientist's problem (Formula 33), constructing a hypothesis of the appearance of the following n objects of the future.

Obviously, predictions should be made by successively increasing the forecasting depth, starting with n=R+1, then moving on to n=R+2, and so on up to n=R+N.

Therefore, we start with hypotheses for object C_{(R+1)}:

$${C}_{( R + 1 )} : \{ \begin{matrix}∈ KK ( {C}_{( R + 1 )} ) = {\sum }_{r = 1}^{R} {K}_{r}^{( ( R + 1 ) + ( 1 - r ) )} \\ {f}_{R + 1}^{\sum } ( r ) \to max ( {f}_{i}^{\sum } ( r ) ) for all {C}_{i} ∈ KK ( {C}_{( R + 1 )} ) \\ ∈ {{⋂}_{r = 1}}^{R} {K}_{r}^{( ( R + 1 ) + ( 1 - r ) )}\end{matrix}$$

If we want to make sure that the input sequence is a copy of the previously recorded sequence, then for each of the hypotheses C_{(R+1)} we check the fulfillment of the conditions (Formula 25 and Formula 34).

For each of the hypotheses C_{(R+1)}, we look for an extension C_{(R+2)}:

$${C}_{R + 2} : \{ \begin{matrix}∈ KK ( {C}_{( R + 1 )} ) = {\sum }_{r = 1}^{R + 1} {K}_{r}^{( ( R + 2 ) + ( 1 - r ) )} \\ {f}_{R + 2}^{\sum } ( r ) \to max ( {f}_{i}^{\sum } ( r ) ) for all {C}_{i} ∈ KK ( {C}_{( R + 2 )} ) \\ ∈ {{⋂}_{r = 1}}^{R + 1} {K}_{r}^{( ( R + 2 ) + ( 1 - r ) )}\end{matrix}$$

For each of the hypotheses C_((R+2)), we check the fulfillment of the conditions (Formula 25 and Formula 34). And so on until n=N:

$${C}_{R + 2} : \{ \begin{matrix}∈ KK ( {C}_{( R + N )} ) = {\sum }_{r = 1}^{R + N - 1} {K}_{r}^{( ( R + N ) + ( 1 - r ) )} \\ {f}_{R + N}^{\sum } ( r ) \to max ( {f}_{i}^{\sum } ( r ) ) for all {C}_{i} ∈ KK ( {C}_{( R + N )} ) \\ ∈ {{⋂}_{r = 1}}^{R + N - 1} {K}_{r}^{( ( R + N ) + ( 1 - r ) )}\end{matrix}$$

for each of the hypotheses C_{(R+N)}, we check the presence of copies by fulfilling the conditions (Formula 25 and Formula 34).

The pathfinder task is solved in a similar way.

### 3.2.10. Cluster' Reverse Projection

Sequence memory allows mapping an object to its corresponding Cluster, and it can be expected that there is a reverse mapping of the Cluster to its corresponding object or objects—Parents, which could have spawned such a Cluster. If the operation of generating a Cluster for a unique object can be called a decomposition of an object into a Cluster, then the reverse operation is a projection of a Cluster onto an object. Therefore, the reverse mapping of the Cluster to the object or objects will be called the Reverse Projection of the Cluster.

One example of Reverse Cluster Projection is the technique of projecting Coherent Ranked Clusters onto one or more focal objects. Let's consider it in more detail.

Suppose three sequences are stored in memory containing the element A in the middle (FIG. 15).

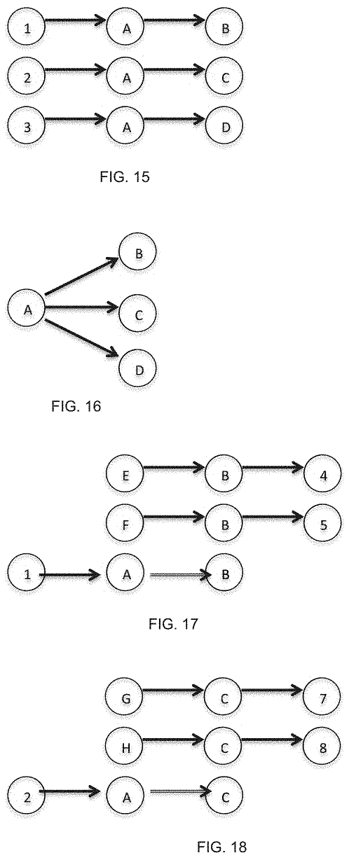

It is obvious (FIG. 16) that for element A the Cluster of the future will be the set K_{A}=(B, C, D).

Suppose that the memory also contains two more sequences with each of the elements B, C and D (FIG. 17-19).

Let us now build first rank Clusters of the past: −K_{B}, −K_{C} and K_{D}, respectively, for elements B, C and D (FIG. 20).

As you can see (FIG. 20), in each of the Clusters of the past of elements B, C and D there is element A, which allows it to be detected in two ways:
1. Object A can be found by looking for the intersection of sets of Clusters {−K_{B}⁻¹∩−K_{C}⁻¹∩−K_{D}⁻¹}, however, as with focal objects, the intersection can contain more than one object
2. If there are several objects in the intersection, the probability of each object appearing can be determined as its total weight W_{B}, W_{C} or W_{D} in the sum of Clusters {(K_{B}⁻¹)+(−K_{C}⁻¹)+(−K_{D}⁻¹)}
3. Obviously, objects found at the intersection of Clusters will have a higher weight than other frequent objects in the sum of Clusters.

Thus, the technique of constructing the Back projection allows you to highlight the hypotheses.

For the above example (FIG. 16) of the Cluster of the future K_{A}¹ object A containing frequent objects (B, C, D), the Reverse Projection of the First Rank is shown in FIG. 20. The dotted circles show the Past Clusters K_{B}⁻¹, K_{C}⁻¹ and K_{D}⁻¹ of frequent objects B, C and D, the intersection point of which is object A, which is the Parent of Cluster K_{A}¹. In this case, the Clusters are Ranked Clusters of the first rank (r=1) and they are Coherent. In the general case, not one, but several objects may appear in the focus of the Reverse Projection, the potential Parents of the Cluster for which the Reverse Projection was made.

If the previously considered technique for determining the focal object of Coherent Clusters can be called the technique of “longitudinal” projection, since objects-sources of intersecting Clusters (Coherent Ranked Clusters) are located on the sequence itself (in its plane), then the Reverse Projection should be called the “transverse” projection of Coherent Clusters because the source objects of intersecting Coherent Clusters lie in a plane perpendicular to the sequence line.

As in the case of the longitudinal projection of Coherent Clusters, the transverse projection (reverse projection) can define several focal objects. In the case of text, these can be, for example, “word forms” of one word or synonyms

### 3.2.11. Reverse Projection of Rank Cluster

To use the method for each of the frequent Objects of a set of specific rank or of a complete set, retrieve from memory a rank set for which the named frequent Object is a key Object, the extracted rank sets of the same rank are compared to determine at least one Hypothesis Object.

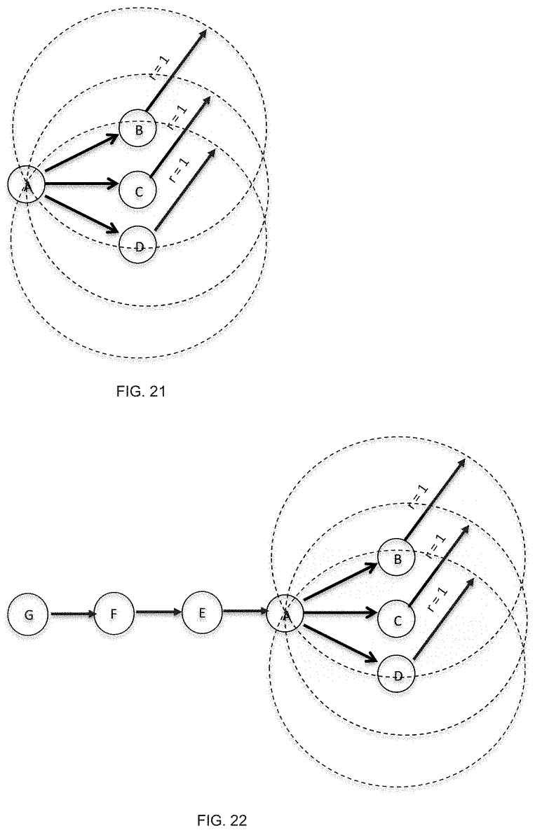

While FIG. 21 demonstrates the reverse projection of the first rank, it is clear that using the Back projection technique of the second and higher rank, it is possible to hypothesize the appearance of objects of the second and higher rank in the reverse projection onto the sequence. It is also clear that for a hypothesis that is part of a copy of a sequence stored in sequence memory, the Back projection of each rank must contain a known sequence object of the corresponding rank r with respect to the hypothesis. So for the sequence (FIG. 22) the condition must be fulfilled (Formula 37—Rank Reverse Projection)

G∈{−K_{B}⁻⁴∩−K_{C}⁻⁴∩K_{D}⁻⁴}
(W_{G}*G) is a member of the sum {(K_{B}⁻⁴)+(−K_{C}⁻⁴)+(−K_{D}⁻⁴)}

F∈{−K_{B}⁻³∩−K_{C}⁻³∩K_{D}⁻³}
(W_{F}*F) is a member of the sum {(K_{B}⁻³)+(−K_{C}⁻³)+(−K_{D}⁻³)}

G∈{−K_{B}⁻²∩−K_{c}⁻²∩K_{D}⁻²}
(W_{E}*E) is a member of the sum {(K_{B}⁻²)+(−K_{C}⁻²)+(−K_{D}⁻²)}

### 3.2.12. Data Structure of Unnumbered Sequence Memory

As noted above, [2.3.9] a complete Cluster of a unique object can be represented by a linear composition of one of Rank Clusters, therefore, it is sufficient to store any one Rank Cluster in memory, preferably the First Rank Cluster. Nevertheless, storing in the sequences memory of the complete Cluster reduces the access time to it, since it eliminates the need to calculate the complete Cluster as a linear composition of rank clusters. It is also possible to store several Clusters of sequential ranks from the first rank to rank N in memory, which makes it possible to reduce the complexity of operations for building back projections and performing operations on coherent rank clusters. Therefore, for each unique object, the sequence memory must store at least:

1. Unique digital code of the object

2. One Rank Cluster of an object, preferably a Cluster of the first rank

The advantage of the proposed data structure of the unnumbered memory of sequences over numbered index of search engines is a significantly higher forecasting performance due to the storage of at least one ranked Cluster.

The memory of unnumbered sequences can also store sequence fragments containing the Key Object, which is a queue of several objects of the corresponding sequence in which the Key Object occupies a previously defined permanent location (for example, in the middle, end, beginning or at another specific position of the queue), and when entering sequences in memory at each input cycle, the named queue of Attention Window objects is fed to the memory input, and at the next input cycle, the queue is shifted by at least one object into the future or past.

As with the search engine using numbered index, all sequence memory data can be stored in unnumbered index hits.

### 3.2.13. Application of the Proposed Forecasting Technique

### 3.2.13.1. Coherent Rank Cluster Technique

For all known objects of the sequence, Coherent Rank Clusters are built with a focus on the object of prediction. If the technique of Coherent Rank Clusters gave more than one hypothesis, then the problem arises of choosing the most appropriate one, which in its back projection should contain the maximum number of known preceding (scientist's task) or subsequent (pathfinders task) objects in the sequence.

### 3.2.13.2. Reverse Projection Technique

Since the set of hypotheses is a Cluster generated by known sequence objects, the Cluster Reverse Projection technique illustrated above can be applied to it. That is, to build for each hypothesis a complete Past Cluster and Rank Clusters of Past in order to find the known previous objects of the sequence in these Clusters. In the case of the scientist's task, the reverse projection of the set of hypotheses of future on the preceding objects of the sequence should be used, and for the pathfinders task, the reverse projection of the hypotheses of past on the subsequent objects of the sequence.

### 3.2.13.3. Rank Cluster Technique

For each of the hypotheses, Rank Clusters are built with a focus on the known sequence objects i.e. the preceding sequence objects for the scientist's task or subsequent objects for the pathfinders task. The known objects of the sequence must be contained in the corresponding Rank Clusters of the hypothesis, and the most suitable one can be considered the hypothesis the Rank Clusters of which contain more such objects or their weight is maximum.

### 3.2.13.4. Algorithm for Searching Hypotheses

Here is a summary of the hypothesis search algorithm described above:
1. construction of rank clusters for each of the known objects of the sequence (Formula 28)
2. calculation of coherent clusters for each of the objects in the sequence, the appearance of which is predicted—hypotheses. (Formula 33, Formula 35)
3. selection from a set of frequent objects of each Coherent Cluster (KK) as a hypothesis of such frequent objects KK, which have the maximum weights among all KK objects and are simultaneously focal objects of intersection of these Rank Clusters (Formula 33, Formula 35)
4. Constructing back-projection Rank Clusters for each hypothesis to assess the correctness of the forecast made by searching for known corresponding sequence objects in each of the Rank Clusters with a highest weight. (Formula 28)
5. Revealing the presence of copies of the input sequence in the memory by checking the condition (Formula 25).

### 3.2.14. Correction of Input Errors

In the claimed method, when entering an Object, the unique digital code of which could have been entered with an error, the comparison of rank sets is carried out in order to identify a possible error.

It is believed that a person's ear recognizes about 60% of the words spoken by other people, and 40% of what is said, a person conjectures, that is, builds hypotheses about what could be said based on what he heard and understood earlier. In this case, both the last heard word can be mistakenly recognized, and a previously recognized word can be recognized incorrectly. Input errors also occur when the recognition software is running. For example, OCR can misrecognize individual letters or words in the middle of a word or phrase.

Since it is reasonable to construct hypotheses based on the known (entered) objects of the sequence, the solution of a scientist's task or a pathfinders task is an extrapolation of the meaning of a known part of the sequence to the future or the past, respectively [3.2.13.4]. The detection of an input error within a known sequence region is an interpolation task. In the case of interpolation, the analysis of a possible “erroneous” object can be carried out by simultaneously solving both the scientist's task based on the known objects of the sequence preceding the “erroneous” one, and the pathfinders tasks based on the known sequence objects following the “erroneous” one using the hypothesis search algorithm [3.2.13.4].

### 3.2.15. Clusters as Raw Data or Feature Maps for Neural Networks

As shown above, Recursive Index implements two opposite processes:
decomposition of an object into a map of its features;
synthesis of an object based on a feature map.

Any object Cluster created by a Recursive Index is a decomposition of the object into its feature map. In turn, Coherent Rank Clusters and Back Projection of the Cluster allow solving the inverse problem—to identify an object to which a given feature map could correspond. This significantly expands the range of artificial intelligence tasks that can be solved by a system consisting of a Recursive Index and a neural network.

Sequence objects are introduced into the system. For each object of the input sequence, using the Recursive Index, a Cluster is generated and the Cluster is fed to the input of the neural network as a feature map. A sequence of objects using the Recursive Index is represented by a sequence of their Clusters, which is fed to the neural network for training the neural network, or for solving problems and making decisions. Not only the original Clusters of sequence objects, but also other types of Clusters described in this work can be fed to the input of the neural network.

According to experts, the algorithms and technologies used for training neural networks do not allow people to understand the mechanism of decision-making in neural networks. This limits the use of neural networks, especially in areas where decision making can be associated with a risk to human life. The unpredictability of the operation of neural networks, in particular, is associated with the use of the backpropagation method, which assigns weights to the network connections that cannot be predicted. Therefore, one of the advantages of generating feature maps using the Recursive Index (Sequence Memory) is that the Recursive Index (Sequence Memory) allows you to determine the weight of each of the frequent objects in the Cluster for any key sequence object, which can also allow you to determine the weights of neural network connections.

### 3.2.16. Generalizations

It is known that when the strength of many input signals to a neuron exceeds a certain action potential of the neuron, then the neuron generates an output impulse—a spike. What is important for us in this view is that noticing the constant excitation of the same group of neurons, the brain can “assign” a previously free neuron “responsible” for this group of neurons and whenever such a group of neurons is excited, it is the neuron monitors the level of excitation of the group, and if the level of excitation exceeds a certain critical level, then the “responsible” neuron spikes.

Next, we will consider the mechanisms of synthesis of new objects responsible for the simultaneous excitation of a group of objects, the condition of excitation of the profile of which was described earlier (Formula 6).

### 4. Pipes. Compression of Meaning and Time

### 4.1. Synthesis of Generalizations

As shown above, the proposed technique of reverse projection of the Cluster of the investigated object allows mapping the Cluster into a set of possible Cluster Parents. Such a set has a smaller dimension than a Cluster and consists of objects united by a semantic commonality. It can be synonymy in a broad sense—word forms of one word, different words with the same meaning (synonyms), parts of a generalized concept, and so on. We can talk about the synthesis of an invariant representation for the object under study and objects of the set of the back projection of the Cluster of the object under study.

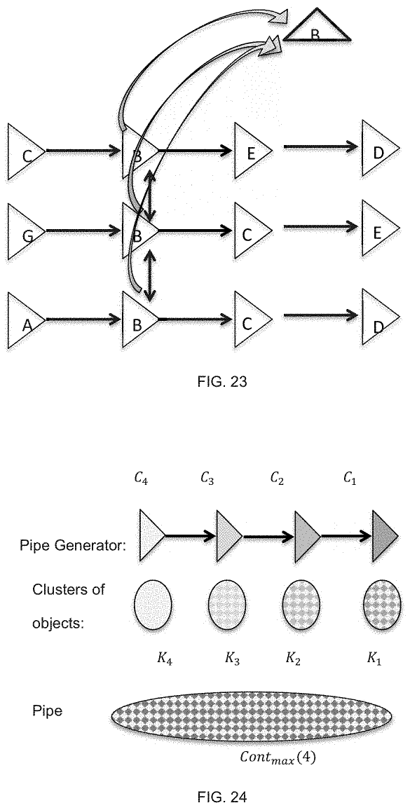

Since each of the unique objects of sequence memory can be represented by a Cluster, then vice-versa a Cluster can be represented by a separate object (FIG. 23), in particular, one that we artificially create for this—synthesize, therefore such an object is an analogue of the creation of abbreviations, as well as the appointment of one of the word forms as “initial” or “neutral”, so for example, all word forms “gone”, “went”, “go” are considered to be word forms of the source word “go”, although any of the word forms could pretend to be the source.

The synthesis of the reverse projection set for the Cluster will be referred to as “transverse synthesis”, meaning the possible replacement of the studied sequence object by another object from the reverse-projection set, which leads to the synthesis of alternative variants of the sequence. Next, we will consider “longitudinal synthesis”, meaning the compression of the original sequences to a shorter sequence of synthetic objects.

The Reverse Projection of the Cluster generates a set of comparable objects, one of which can be the object to which the Cluster belongs, subjected to the Back Projection, and in this case there is no need to synthesize a new object. Therefore, a mechanism is needed to make a decision on the synthesis of a new object or to abandon the synthesis in favor of an already existing unique object of sequences.

The decision to synthesize a new object is made if the error in the identity of the profile (or normalized profile) of the original Cluster when comparing it with similar profiles of Clusters of Back Projection objects exceeds the value of the admissible error ΔK̅ₘ̅ₐ̅ₓ̅ (Formula 6)

### 4.2. Semantic Compression of Sequence.

4.2.1. A Pipe. Pipe Caliber

In the claimed method, from the Set of Pipes, the weight coefficients of the occurrence of all frequent Objects are extracted and added, thus obtaining the Total Weight of the Pipe.

It seems obvious that the probability of the joint occurrence of the words “milk” and “cheese” in the text is higher than the words “milk” and “petroleum”, therefore the Clusters of the words “milk” and “cheese” should contain more of the same frequent words (for example, the word “cow”, “fermentation”, “livestock” and others) than Clusters of the words “milk” and “petroleum”. In other words, the intersection of the Clusters of the words “milk” and “cheese” will contain more objects than the intersection of the Clusters of the words “milk” and “petroleum”.

Number of objects of (Kₘᵢₗₖ∩K_{cheese})>Number of objects of (Kₘᵢₗₖ∩Kₚₑₜᵣₒₗₑᵤₘ)

This means that while summing Clusters of related words, such as “milk” and “cheese” (Kₘᵢₗₖ+K_{cheese}), we will discover an increase in the weight of words included in the intersection (Kₘᵢₗₖ∩K_{cheese}) and corresponding to the context of the both Clusters, in while the weights of words not included in the intersection set will not change. Mathematically, the set of objects with increasing weights will be called the context Cont and defined as the sum of the Clusters of objects (Kₘᵢₗₖ+K_{cheese}) without their symmetric difference (KₘᵢₗₖΔK_{cheese}):

Cont=(Kₘᵢₗₖ+K_{cheese})−ΔCont_{cheese}^{milk}

Where Δ Cont_{cheese}^{milk} is a representation of linear algebra for the operation of finding symmetric difference of sets (KₘᵢₗₖΔK_{cheese}).

In general, the context of a sequence referred further to as “a Pipe” for a sequence of R objects will be the sum of the Clusters for all R objects without their symmetric difference (Formula 38—Pipe—Sequence Context):

$$T = C o n t ( R ) = f ( 1 ) * {K}_{1} + {\sum }_{i = 2}^{R} \{ f ( i ) * {K}_{i} - Δ C o n {t}_{i - 1}^{i} \} = {\sum }_{i = 1}^{R} f ( i ) * {K}_{i} - Δ C o n t ( R )$$

[symbol]

Δ Contₙ^{m}—is a representation of linear algebra for the operation of finding symmetric difference of sets (KₘΔKₙ) of objects m and n: Δ Contₙ^{m}↔(KₘΔKₙ), and ƒ(i)—is the weakening function, which in some cases can be taken equal to one and then::

$$Cont ( R ) = {K}_{1} + {\sum }_{i = 2}^{R} \{ {K}_{i} - Δ C o n {t}_{i - 1}^{i} \} = {\sum }_{i = 1}^{R} {K}_{i} - Δ C o n t ( R )$$

It is clear that when the context of the sequence changes, the content of the set Cont(R) must also change. As you enter objects with an unchanged context, the rate of change of Cont(R) will decrease according to Hips's law, according to which the number of unique objects in the sequence is directly proportional to the square root of the number of all objects in the sequence and therefore the rate of increase in the number of unique objects will be lower than the rate of increase in the number of entered objects in proportion to the root from all objects in the sequence. So in a sequence of 250 thousand objects, unique will be 0.2% (strictly speaking, unique, there will be the number of words=c*0.2%, where c is some constant.), and for a sequence of 360 thousand objects, only 0.16% will be unique, that is, in the second sequence, the proportion of unique objects will be 25% less, while the second sequence itself will be 44% longer than the first. In addition, objects in a sequence, for example, words in a text, are not a random set, they are related by context and their order is subject to the laws of the language. Consequently, preserving the subject matter of the text should slow down the growth of the total weight of objects in the set Cont(R), and changing the subject should, on the contrary, lead to a rapid decrease in the number of objects in the set Cont(R) with a simultaneous decrease in the maximum weights of the objects included in Cont(R). The decrease in the number of objects and their weight when changing the context occurs due to the replacement of the previous group of frequent objects of the set Cont(R) corresponding to the previous context with new ones, as a result of which the total weight Cont(R) must first fall and then start to grow as the set Cont(R) is formed frequent objects of new context.

In the claimed method, the Total Weight of the Pipe of the previous Set of Pipes is subtracted from the Total Weight of the Pipe of the next Set of Pipes and, if the difference does not exceed the specified error, then the result is stored as a set of Pipe Caliber, an identifier of a synthetic Object is created and the named identifier, set of Pipe Caliber and the Attention Window Objects set, hereinafter referred to as the Generator of Pipe, are mapped to each other and stored in the Sequences Memory.

Memorizing the content of the set Cont(R) at the peak of the total weight of its objects allows synthesizing the Cluster of Cont(R) corresponding to the context of the sequence region located between the two successive peaks of Cont(R). By calculating the total weight of objects Cont(R) with the introduction of each new object in the sequence, we can determine the moment when the increase in the total weight will change to a decrease and the set of the context with the peak value of the total weight Contₘₐₓ(R) before the start of reducing the total weight will correspond to the Pipe context set.

The set Contₘₐₓ(R) is assigned the identifier of a previously non-existent “synthetic” object, and such a newly synthesized object is added to the set of unique Sequence Memory objects. At the same time, forward and backward links of such a synthetic object are created with all objects in the sequence, the input of which led to the appearance of a synthetic object (Formula 39—Maximum value of context and the pipe):

Tₘₐₓ=Contₘₐₓ(R)

In order to avoid errors in determining the context with a peak total value Contₘₐₓ(R) due to an accidental decrease in the total weight of objects, one should use well-known methods of averaging or smoothing the curve of change of the total weight.

The operation of determining Contₘₐₓ(R) allows you to “compress” (FIG. 24) the original sequence of objects to the Cluster Contₘₐₓ(R).

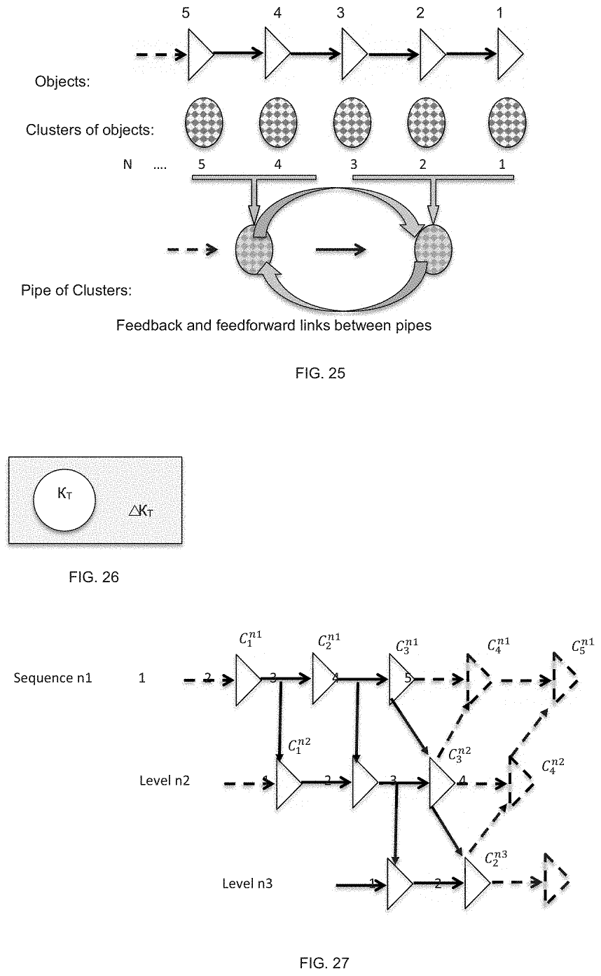

Dividing the sequence into segments or sections between the peak values Contₘₐₓ(R), allows one to replace the original sequence of objects or object′ Clusters (FIG. 25) with a shorter sequence of synthetic objects corresponding to the sequence of context clusters Contₘₐₓ(R), thus allowing perform semantic “compression” of the original sequence of objects to a sequence of synthetic objects Contₘₐₓ(R).

Definition 4

The Pipe Generator is a sequence of objects that spawned the Pipe Cluster.

Correspondence of a Cluster Contₘₐₓ(4) to four objects C₁, C₂, C₃ and C₄ at once and their Clusters K₁, K₂, K₃ and K₄ not only “compresses” the sequence to one Cluster Contₘₐₓ(R), but also creates backward and forward links of the synthetic object Contₘₐₓ(R) between objects C₁, C₂, C₃ and C₄ and their Clusters K₁, K₂, K₃ and K₄, creating the basis for the implementation of logical inferences.

The operation of removing the symmetric difference of Clusters of objects from the set of Pipes will be called Pipe Calibration, and the result will be called Caliber and will be denoted as K_{T}. It is obvious that the pipe gauge is the set Cont(R) (Formula 40):

K_{T}=Cont(R)

Now the expression for the context of the sequence (Formula 38) can be rewritten as follows (Formula 41—Pipe Caliber):

$$: {K}_{T} = T - Δ {K}_{T} = {\sum }_{i = 1}^{R} ( f ( r ) * {K}_{i} ) - Δ {K}_{T}$$

where

ΔK_{T}=Δ Cont(R)

The analysis of the change in the Pipe and its Caliber can be carried out using well-known methods of mathematical analysis, linear algebra, statistical analysis and other well-known mathematical techniques, so we will not dwell on them here.

Previously, we identified two types of Clusters—the Cluster of the Future and the Cluster of the Past, therefore, a Pipe built using only one type of Clusters will be, respectively, a Pipe of the future or a Pipe of the past. On the sequence of Pipes and their Calibers, one can also build both a Full Cluster and Ranked Clusters, which allows you to build hypotheses at different levels of abstraction and meaning, and also, in fact, creates feedback and anticipatory connections when moving from a higher hierarchy layers of the meaning to lower ones, giving rise to the possibility drawing conclusions and judgments.

It is known from combinatorics that the “number of placements with repetitions” is equal to N^{k} where N is the number of all unique objects in the set of unique objects, and k is the number of objects in the fragment on which the Pipe is built. For example, for a set of 100 thousand unique objects, the number of placements with repetitions will be equal to 100¹⁰ and, accordingly, the probability of repeating a fragment of 10 objects in different hits will be equal to 1/(100¹⁰). In fact, the probability of repetition will be much lower, because not all combinations of unique objects are acceptable, and repetitions are not frequent. Nevertheless, the given value of the probability allows us to understand that the Pipe, built on a fragment of ten objects, with a very high probability will contain a “memory” of the memory of sequences—the objects for the continuation of such a fragment.

### 4.2.2. Calculating Pipe Caliber

Each unique frequent Object that does not occur in at least one of the arrays or rank sets of the Attention Window′ objects should either be removed from the Pipe Set or its weight should be replaced by zero, and the resulting set is considered as the Caliber of the Pipe; the named set of Pipe Caliber is put into the correspondence of an existing or newly created Sequence Memory Object (hereinafter “Synthetic Object”), and also is put into the correspondence the object sequence of the Attention Window (hereinafter “Pipe′ Generator”); the mapped to each other named Synthetic Object, a set of Pipe Caliber, as well as the Generator are stored to the Sequence Memory.

It is easy to see that the Pipe of the future contains connections with the objects of the future in each of the sequences on which the sequence memory was trained, that is, the Pipe contains all connections with possible future objects of the current sequence “written” into the sequence memory. The pipe of the future contains branches (possible continuations or hypotheses) emanating to the future (or to the past) from each of the objects of the current sequence, but not all continuations of each single entered objects of the sequence can be continuations for all entered objects of the sequence in the aggregate. This means that to select in memory only the hypotheses of the continuations of the given sequence that are continuations for all know sequence objects same time together, one more operation is needed—“Pipe Calibration”.

Calibration allows you to remove such branches of the sequence development, which are not a continuation at the same time for all known sequence objects. If we consider as the entered objects of the sequence and those whose appearance was previously predicted, then this will allow us to extrapolate the forecast further into the future or past based on the set of the entered objects. In terms of hypothesis search, we can define Calibration like this:

Definition 5

Calibrating the Pipe of the Future is the operation of generating an array of the future containing the objects of the future with their weighting factors, which we will call the Pipe Caliber and which, in particular, contains all statistically admissible continuation of the current sequence in the future for solving the “scientist's task”. Accordingly, the Pipe Caliber of the Past array contains all statistically admissible continuation of the current sequence into the past for solving the “pathfinder's task”.

In the process of entering a sequence of “Attention Windows” objects into the Sequence Memory, for each of the Attention Window objects as for a key Object, at least one named array or rank set containing the weighting coefficients of the occurrence of frequent Objects is extracted from all named arrays or sets, weighting coefficients of occurrence of each unique frequent Object, that is common simultaneously for all named arrays or sets, and add them, thus forming the array of the Pipe, containing the total weight coefficients of occurrence of each unique frequene Object with all objects of the Attention Window.

By definition, Pipe Caliber K_{T} is equal to the sum of Hypotheses Hᵣ ( [symbol] 42):

$${K}_{T} = {\sum }_{r = 1}^{R} ( {H}_{r} )$$

As noted above, the Caliber of Pipe set is a subset of the Pipe (Formula 43):

$${K}_{T} = T - Δ {K}_{T} = {\sum }_{i = 1}^{R} ( {K}_{i} ) - Δ {K}_{T}$$

where K_{T} represents the symmetric difference of the complete Clusters Kᵢ of key sequence objects, and each complete Cluster Kᵢ is a set of frequent objects:

Kᵢ=(w₁*C₁,w₂*C₂,w₃*C₃, . . . ,wₙ*Cₙ,),

besides, the number of frequent objects n in each Cluster may be different.

To calculate the Caliber of the Pipe K_{T} by removing from the Pipe T objects of the named symmetric difference K_{T} in the claimed method, each unique frequent Object that does not occur in at least one of the arrays or rank sets of Objects of the Attention Window, or is removed from the Set of the Pipe, or its weight is equated to zero, and the resulting set is considered the set of the Pipe Caliber; the named set of the Pipe Caliber is being associated with an existing or newly created Sequence Memory Object (hereinafter “Synthetic Object”), and also with the Attention Window, hereinafter referred to as the Pipe Generator; the named Synthetic Object, a set of Pipe Caliber, and also a Pipe Generator are being mapped to each other and stored in the Sequence Memory.

The content of the difference ΔK_{T} is all “dead-end objects” Cᵢ, which are not simultaneously hypotheses for all objects of the sequence fragment on which the Pipe is built. The set of dead-end objects included in ΔK_{T} can be determined from the algebra of sets as the “complement” of the set K_{T} to the set T (Formula 44)

ΔK_{T}=T\K_{T}

In set theory, the complement operation corresponds to a logical negation, so the correction ΔK_{T} is a logical negation of the Pipe Caliber K_{T} (FIG. 26):

ΔK_{T}↔¬K_{T}↔K̅_̅{̅T̅}̅

The K_{T} value can also be defined as the symmetric difference of clusters of all objects in the sequence:

ΔK_{T}=K₁ΔK₂ΔK₃Δ . . . ΔKₙ

considering that the symmetric difference AΔB=(A\B)∪(B\A) (Formula 45):

ΔK_{T}=((((K₁\K₂)∪(K₁\K₂))\K₃)∪(K₃\((K₁\K₂)∪(K₁\K₂)))\K₄)∪ . . . .

To remove from the pipe T all objects C_i belonging to the set ΔK_{T}, we introduce into consideration the quantifier array Z of quantifiers (z₁, z₂, z₃, . . . , zᵢ, . . . , z_{N}), which is equipotent to the array T (in which 0<i≤N, and N is the number of frequent objects in the Pipe array T), wherein zᵢ=1 for each of the objects Cᵢ∈ΔK_{T}, and also zᵢ=0 for each of the objects Cᵢ∉ΔK_{T}. Then for arrey ΔK_{T} the equality will be true (Formula 46):

ΔK_{T}=Z̅*T

and finally the formula for calculating arrays of frequent objects of the Pipe Caliber will take the form (Formula 47):

$${K}_{T} = T - \overline{Z} * T = {\sum }_{i = 1}^{r} ( f ( r ) * {K}_{i} ) - \overline{Z} * ( {\sum }_{i = 1}^{r} ( f ( r ) * {K}_{i} ) ) = ( {\overline{Z}}_{1} - \overline{Z} ) * {\sum }_{i = 1}^{r} ( f ( r ) * {K}_{i} )$$

[symbol]

Z̅₁− [symbol] [symbol] [symbol] [symbol] Z̅, a Z̅₁— [symbol] B [symbol] [symbol] [symbol] [symbol] .

The weights of some of the Pipe Caliber objects calculated using the above formula will be excessive. When calculating the Pipe Caliber correction ΔK_{T} (see Formula 45), we did not take into account the fact that the weights of frequent objects from the Cluster of each object Cᵢ∈ΔK_{T}, when calculating the Pipe Caliber (see Formula 47), were summed with the weights of frequent objects from the Cluster of each object Cᵢ∉ΔK_{T}. Using neuroanalogy, we can say that we “inhibited” the primary neurons (Cᵢ∈ΔK_{T}) of dead-end sequences, but the “inhibition” did not affect the secondary, tertiary, and so on neurons of such dead-end sequences, and these neurons left excited by secondary and so on are capable of defocus the Pipe Caliber and contribute to the noise of the desired hypothesis. Therefore, the weights of the frequent objects remaining in the Pipe Caliber array (see Formula 47) must be additionally reduced by the value of their weights in the Clusters of dead-end objects (Cᵢ∈ΔK_{T}), and the ΔK_{T} value should be a “weight correction” ΔW (Formula 48—Weight correction of Pipe Caliber):

$$Δ W = {\sum }_{i = 1}^{R} {\sum }_{j = 1}^{n} ( {w}_{j i} * {C}_{j} )$$

therefore

ΔK_{T}=Z̅*T+ΔW

and then the formula for calculating the Pipe Caliber will take the form (Formula 49—Pipe Caliber, taking into account the weight correction):

$${K}_{T} = T - ( \overline{Z} * T + Δ W ) = ( {\overline{Z}}_{1} - \overline{Z} ) * {\sum }_{i = 1}^{R} ( {K}_{i} ) - {\sum }_{i = 1}^{R} {\sum }_{j = 1}^{n} ( {w}_{j i} * {C}_{j} )$$

Remark: 3

The pipe caliber (see Formula 49) does not contain objects of the sequence on which it was built, because the Cluster of the leftmost or rightmost sequence object for the Pipe of the future or the Pipe of the past will not contain sequence objects and therefore all sequence objects will appear as dead ends in the set ΔK_{T}. Thus, it is impossible to restore the sequence from the Pipe Caliber calculated according to the given formula (Formula 49).

The absence of sequence objects in the Pipe Caliber is understandable, because the Pipe Caliber essentially only contains the continuation of the sequence into the future (the scientist's task) or the past (the pathfinders task) from the last known sequence object. So memorizing the Pipe Generator (Definition 4) seems to be a necessary step to complement the Pipe Caliber calculation.

The absence of sequence objects in the Pipe Caliber on which the Pipe Caliber was built contradicts the known facts about the excitation of neurons—the primary neurons, to which the named sequence objects correspond in our model, remain excited taking into account the attenuation, but still transmitting the excitation to the secondary and so on neurons, which in our model corresponds to the Pipe Caliber objects.

(?) From the next Pipe′ Total Weight, the previous Pipe′ Total Weight is subtracted and, if the difference does not exceed the specified error, then the result is saved as a set of Pipe Caliber; an identifier of a synthetic Object is created and the named identifier, the set of Pipe Caliber and the set of the Attention Window Objects (hereinafter “Pipe Generator”) are mapped to each other; and the mapped to each other named Synthetic Object, set of Pipe Caliber, and the Pipe Generator are stored in the Sequence Memory.

During the named cycle, the set of Pipe is compared to at least one previously saved set of Pipe Caliber, and if the difference between the Set of Pipe and the set of Pipe Caliber is within error, then the Pipe Generator corresponding to the named Set of Pipe Caliber is retrieved from sequence memory and the named Pipe Generator is used as a result (hereinafter “memories”) of search in the sequence memory in response to input of the attention window as a search query.

To emulate the operation of neurons, the Pipe Caliber should be supplemented with objects of the Pipe Generator sequence S=(C₁, C₂, C₃, . . . , C_{R}), where R is the number of objects in the sequence for which the Pipe is being built. However, adding objects without their weights can make the addition of the scalar S to Caliber Δ K_{T} invisible, so it would be useful to assign each of the frequent objects Cᵢ of the set S weights corresponding to the total weight Wᵢ of the frequent objects of the Kᵢ Cluster such an object Cᵢ, and then:

S=(W₁*C₁;W₂*C₂;W₃*C₃; . . . ;W_{R}*C_{R})

where R—attention window size.

Therefore, it may be useful to take into account the correction in the Pipe Caliber K_{T} formula, which adds to the pipe T a set of known objects of the S sequence. This is justified from the point of view of neuroanalogy, because the sequence objects are essentially analogs of excited primary neurons. Objects (C₂, C₃, . . . , C_{R}) should be added with a negative sign, meaning that they are already “in the past”, and the object Cᵢ—with a positive one, since it is in the “present”. However, using neuro analogues, we can say that all objects (C₁, C₂, C₃, . . . C_{R}) remain excited and therefore are in the “present”, although the excitation of those of them that were introduced r cycles earlier than the last one should fade out according to the law of attenuation:

ƒᵣ=ƒ(r)

and then, taking into account the attenuation, the value of S will be:

S—(ƒ₁*W₁*C₁;ƒ₂*W₂*C₂;ƒ₃*W₃*C₃; . . . ;ƒ_{R}*W_{R}*C_{R})

where object C₁ is the last object entered into the queue, and object C_{R} is the oldest of the entered objects in the queue.

The K_{T} value with the specified correction will be as follows (Formula 50—Pipe Caliber, taking into account the weight correction and sequence objects):

$${K}_{T} = S + {K}_{T} = S + ( {\overline{Z}}_{1} - \overline{Z} ) * {\sum }_{i = 1}^{R} ( {K}_{i} ) - {\sum }_{i = 1}^{R} {\sum }_{j = 1}^{n} ( {w}_{j i} * {C}_{j} )$$

Regardless of considering attenuation, using the plus or minus sign for S in the formula (see Formula 50) will increase or decrease the weight of similar frequent objects of the Pipe Caliber, which should be taken into account in further considerations.

Like the Pipe, the Caliber can be built for the Pipe of the future and for the Pipe of the past, respectively, we will distinguish between the Caliber of the Pipe of the past and the Caliber of the Pipe of the Future, or simply the Caliber of the Future (K_{T}) and the Caliber of the Past (K_{-T}). As with the sequence of objects (or their Clusters), the convolution operation to form synthetic objects can also be defined for the sequence of Calibers.

### 4.2.3. The Meaning of the Amendment Δ W. Remnant of Caliber

Let us investigate the value of the “weight correction” Δ W by adding new objects C₁ without restriction and not removing old objects of the C_{R} sequence. To do this, let's calculate the value of the Pipe Caliber without taking into account the “weight correction” (see Formula 47) and see how the Pipe Caliber will change.

Let's imagine that we started to enter a sequence that may already be contained in the sequence memory. We introduce the first object of the sequence and, having built a Pipe Caliber for it, we find thousands of sequences in memory that can be a continuation of the introduced object. Then we introduce the second object and constructing the Pipe Caliber for the two entered objects, we find that the set of the Pipe Caliber objects has decreased, as well as the number of sequences that are contained in the sequence memory and can be a continuation of the two entered objects. That is, an increase in the number of entered objects will lead to a decrease in the Pipe Caliber of the number of sequences that could be a continuation of the entered sequence fragment. Continuing to introduce new objects of the fragment, at some point we will receive the Pipe Caliber containing only a copy of the input sequence, and then we will receive an array ΔW of frequent objects of the Pipe Caliber, not united by belonging to at least one sequence stored in memory, but consisting of frequent objects, contained in the Cluster of each of the objects in the sequence. It can be assumed that such a set of objects, while not being a set of hypotheses, nevertheless characterizes the context of the introduced sequence. We will call this array the Remnant of Caliber. Further input of objects of the input sequence, while maintaining its context, should lead to an increase in the total weight of frequent objects of the Remnant of Caliber or Remainder of Caliber. The increase in the total weight of the Remnant Caliber should continue until the context of the sequence changes—for example, until the topic of the presentation is changed, say, from animal husbandry to oil production.

Let us estimate the possible length of the sequence on which the Remainder of Caliber occurs. In everyday communication, people use a dictionary containing from 2 to 10 thousand words, so a sequence of 5 to 10 words can be considered “sufficiently long”. The probability of re-entering such a sequence is inversely proportional to the number of placements with repetitions (strictly speaking, the probability will be significantly higher, since the sequences are not a random set of objects, the following of objects one after another and their compatibility are subject to certain rules) from 10,000 to 5 words or from 10,000 to 10 words . . . . The length of 5-10 words roughly corresponds to the average length of a sentence in Russian—about 10 words. This means that the Remaining Caliber can occur on a medium-length sentence.

Remark 4

Due to the subtraction of the “weight correction” ΔW (Formula 49), in the case of an infinite increase in the size R of the Attention Window (that is, with the addition of a new C₁ object, the “old” C_{R} object is not removed from the Attention Window), one can expect that the Pipe Caliber converges to copies of the input sequence or to an empty set if the memory does not contain copies of the input sequence. With a constant value of the size R of the Attention Window (queue: entering a new C₁ object is accompanied by the deletion of the “oldest” object C_{R}), in each cycle the Pipe Caliber will be built on the updated queue of sequence objects, which should lead to a cyclical change in the total weight of all Caliber objects, for by changing the context as the Attention Window moves along the input sequence.

It should be noted that the search for the Context (the peak total value of the weight of the Pipe Gauge objects) can be replaced by the search for pauses and interruptions, which should stop the growth of the total weight of the Pipe objects. This can simplify the software and hardware implementation of the synthesis of new objects (Formula 51—Sequence pipe):

$$T = {\sum }_{i = 1}^{R} ( f ( r ) * {K}_{i} )$$

### 4.2.4. Rear Projection of Pipe.

In the claimed method, for each of the frequent Objects of a specific rank or full set, a rank set is retrieved from memory, for which the named frequent Object is a key Object, the extracted rank sets of the same rank are compared to determine at least one Hypothesis Object.

As noted above [3.2.10], using Back Projection, any Cluster can be projected onto one or more Parent objects of such a Cluster. Therefore, the Back Projection of the Pipe must spawn many potential Pipe Parent objects. In the latter case, you need to make sure that the weight profile in the Cluster of each existing Parent object coincides with a certain acceptable accuracy with the weight profile of the frequent pipe objects. If the accuracy of coincidence of the Cluster and Pipe profiles is sufficient, then the Pipe corresponds to an already existing unique object that can be considered the Parent of the Pipe.

It can be expected that if the subject (context) of the sequence remains unchanged, the value of the Back Projection of the Pipe will not change either. Therefore, each time you enter a new sequence object, you can calculate a new Back Projection Pipe value by comparing it to the Back Projection Pipe value when you entered the previous sequence object. The Rapid Change of the Back Projection of the Pipe should coincide with the passage of the peak of the values of the cumulative weights of the Pipe.

### 4.2.5. Selecting an Object to Designate a Pipe.

As the “best” Parent of the Pipe, one of the Parent objects generated by the Back Projection of the Pipe should be selected, the value of the permissible error for which ΔK̅ₘ̅ₐ̅ₓ̅ satisfies the condition (Formula 6) and is minimal among all potential Parents of the Back Projection of the Pipe.

If among the potential Parent objects there was no object that satisfies the condition (Formula 6), then a decision is made to synthesize a new unique object by assigning the Pipe Cluster to it. As a result, we get a set of synthetic objects, the mapping of which is the corresponding Pipe Cluster.

4.2.6. Sequence of Pipes and their Identification

In the claimed method, the sequence of creating sequential Pipe Calibers containing frequent objects of the Sequence Memory of the current hierarchy level (hereinafter referred to as “hierarchy level M1”) is stored in the Sequence Memory as a sequence of Synthetic Sequence Memory Objects of a higher hierarchy level (hereinafter “hierarchy level M2”).

In this case, each current set of Pipe Calibers is associated with a Synthetic Object (hereinafter referred to as the “Frequent Synthetic Object”), which is mapped to a preceding set of Pipe Calibers in the sequence of Pipe Calibers, by placing in the named current set of Pipe Calibers the weight coefficient of the mutual occurrence of the Synthetic Object (hereinafter “Key Synthetic Object”) assigned to the current set of Pipe Calibers, with named Frequent Synthetic Object.

The Sequence of Synthetic Objects is introduced into the Sequence Memory as one of the machine-readable data arrays of the Sequence Memory of the hierarchy level M2, which is a sequence of a plurality of unique Objects.

Let us give examples of algorithms for creating a sequence of Pipes for the input sequence of the hierarchy level M1 of sequence memory and their identification by existing or synthesized objects at the next level of the hierarchy M2 of sequence memory. Nevertheless, within the framework of the proposed approach for the creation of Pipes and their identification, use of various techniques and methods for comparing Clusters, the algorithm may be different.
1. Input the next sequence object into the Attention Window
2. Build a Pipe for the Window of Attention, build a Pipe and save its value
3. Compare the total weight of the frequent objects of the constructed Pipe (current weight) with the total weight of the Pipe objects obtained in the previous step (previous weight). If the current weight is greater than the previous one, then we remember the current weight as the previous one and continue entering. If the current weight of the previous one is less, then
   a. Normalize the weights of the frequent objects of the resulting Pipe [2.3.5.2]
   b. Determine the set of Parent objects of the resulting Pipe by calculating the Back Projection of the resulting Pipe
   c. Normalize the weights of frequent objects in the Clusters of Parent objects.
   d. Compare the normalized weights of Pipe Cluster with the normalized profiles of the Parent Clusters.
   e. Choose from the Parent objects an object with a minimum value of AK satisfying the condition ΔK̅ₘ̅ₐ̅ₓ̅≥ΔK̅ (Formula 6).
   f. If there is no object in the Back Projection that satisfies the described conditions, then we synthesize a new object and match it with the Cluster of the Pipe in the Sequence Memory.

### Or so:

1. Introduce the next sequence object into the Attention Window
2. Build a Pipe for the Window of Attention and remember its value
3. Build a Reverse Projection of the Pipe and remembering its value
4. Compare the value of the Back Projection of the Pipe with its previous value and if the changes do not exceed the permissible, then we continue entering the sequence, and if they do, we compare the normalized profile of the weights of the frequent objects of the Pipe with the normalized profiles of the frequent objects of the Clusters of the objects of the Back Projection and select the object with the minimum value AK satisfying the condition ΔK̅ₘ̅ₐ̅ₓ̅≥ΔK̅ (Formula 6).
5. If there is no object in the Back Projection that satisfies the described conditions, then we synthesize a new object and match it with the Cluster of the Pipe in the Sequence Memory.

It is clear that the algorithms given are only examples, while a person with the necessary knowledge can offer other algorithms, within the framework of the approach described in this work.

### 4.2.7. Role of the Attention Window for Sequence Memory

In the claimed method, the input of sequences into memory is carried out, as a rule, in cycles, and at each cycle, a queue of sequence objects (hereinafter the “Attention Window”) is entered into the memory, and when moving to the next cycle, the queue of objects is increased or shifted by at least one an object into the future or the past.

In the introductory part, we gave a fairly simple definition of the Attention Window and now we will detail and deepen this definition.

In the Sequence Memory, each object corresponds to a Cluster, and an object can correspond to each Cluster. Let's present it in a slightly different way.

Suppose we have two devices apple chopper and apple restorer. Suppose also that if an apple is fed to the chopper input, then at the exit from the chopper we get applesauce, and if we feed applesauce into the restorer input, then at the output from the restorer we get the original apple, but by 10% smaller of original.

Now let's connect the output of the chopper with the input of the restorer (forward link), and the output of the restorer with the input of the chopper (feedback), take a large bag of apples of the same size and start feeding them to the input of the chopper at the moment when the previous apples reduced by 10% are returned from restorer agent in the chopper.

What will we notice? We put the first apple of the original size in the Chopper and it came back reduced by 10%. Now we put two apples in the Chopper—a new one of standard size and an old one reduced by 10%. On the second cycle of the system operation, two apples will come out of the restorer-one reduced by 10% and the other reduced by 19% and by adding an apple of a standard size to them, we will start these three apples into a cycle again, and so on each time we will put in the Chopper an increasingly long line of apples of different sizes. Obviously, we now can restore the order in which apples were fed into the system by ranking the apples by size. This is the physical meaning of the Attention Window: to create a recurrent connection between objects and inherit the order of objects from the original sequence. Despite the fact that we did not describe the restorer earlier, we will do it later.

Earlier we talked about the Window of Attention of constant length, however, the recurrent mechanism for feeding apples shown in the example allows you to always feed only one new apple to the system and at the same time keep an order of all the apples of the “Attention Window” in the system. This approach allows the Memory of Sequences to overcome the limitation on the length of the Attention Window and use a dynamic Attention Window of variable length.

The size of the Attention Window cannot grow indefinitely, and we should determine the conditions under which the Attention Window size will cease to increase, or the current Attention Window will be canceled. Previously, the conditions limiting the use of the current Attention Window were: 1) reaching the maximum value of the total weight of objects of the Frequent Pipe Caliber and 2) inputting of the sequence interruption. In the first case, we compare two consecutive measurements of the total weight of the Pipe Gauge and, if the last amount is less than the previous one, then we assume that during the previous measurement the maximum total weight of the Pipe Gauge was reached, and the context of the sequence changed. In the second case, interruption, in particular, is the input of an empty object, which leads to the equality of two successive measurements of the total weight of the Pipe, that is, the total weight of the Pipe in two successive measurements did not change. Therefore, both the first and the second conditions are associated with a change in the total weight of the Pipe or Pipe Caliber. Although the above conditions seem to be true for textual information and the language as a whole, sequences of objects of a different nature may require the fulfillment of conditions that are unknown in advance and may differ from those listed, but it can be noted that these conditions should probably be associated with the measurement of the total context, because context is an invariant pattern of an input sequence of any nature. Thus, the use of the Adder for artificial neurons is the only solution, but the conditions of the neuron activation function for sequences of different nature and possibly for different cases of sequences of objects of the same nature may nevertheless differ.

In addition, it is necessary to agree on the exact meaning of the expression “Window of Attention will stop growing”, for example: 1) when the conditions for changing the context occur, the current “dynamic Window of Attention” is canceled and replaced by a new “dynamic Window of Attention”, in which the next object will become the only object, and the “dynamic Window of Attention” is used until the next occurrence of the conditions for changing the context, or 2) under certain conditions, we end the “growth phase” of the Window of Attention and fix the current length of the “dynamic Window of Attention”, and then change it according to the queue principle (FIFO) as a “static Window of Attention”, adding a new (latest) object to the Attention Window and discarding the earliest object, or 3) if the context change conditions do not occur, then upon reaching a certain maximum length of the “dynamic Window of Attention” we fix its length and further change the Attention Window on a queue basis (FIFO) as a “static Attention Window”, adding a new (latest) object to the Attention Window and discarding the earliest object.

The third option for changing the Attention Window seems to be the most reasonable. Thus, the “growth phase” of the “dynamic Window of Attention” is terminated if either 1) the conditions for changing the context have occurred, or 2) an interruption is introduced, or 3) the maximum length of the dynamic Window of Attention is reached, and in the latter case, the dynamic Window of Attention becomes “static” and a queue changes before the conditions for changing the context or before entering an interrupt.

### 5. Hierarchical Memory

### 5.1. Hierarchy of Stable Combinations

### 5.1.1. Memory of Stable Combinations

As noted (Remark 1), the search for stable combinations on a set of N objects has complexity N^{R}. Let us show how the use of Sequence Memory reduces the laboriousness of identifying stable combinations and makes the process simple.

Let us assign a new object identifier to each pair of consecutive objects. In the case of the phrase “Organization of United Nations”, this will lead to the formation of two new artificial objects, C₁=“Organization of United” and C₂=“United Nations”. Whenever objects C₁ and C₂ meet together the weight of their first rank link in the Sequence Memory will increase, that is, in the 1st rank Cluster of object C₁, object C₂ will probably have either the maximum weight or one of the maximum weights, which is a “hint” for its preferential use after object C₁.

Thus, coding each pair of objects in the sequence with a new synthetic object, we have solved the problem with labor input N², so we will call the set of newly created objects “layer n2” or “objects n2”.

Likewise, we will go to finding stable combinations of objects in layer n2 by creating many new objects in layer n3, then layer n4, and so on.

### 5.1.2. Rank 1 Combinations

Stable combinations in each layer n2, n3, n4 and so on can only be of the first rank and this simplifies the work with them. To each artificial identifier of layer n2 we assign a directional link of a pair of objects of sequences n1, to each artificial identifier of layer n3 we associate a directional link of a pair of objects of sequences n2, and so on (FIG. 27) (Formula 52—Artificial objects for combinations of objects of the lower layer):

C₁ⁿ²={C₁ⁿ¹→C₂ⁿ¹}

C₁ⁿ³={C₁ⁿ²→C₂ⁿ²}

Now the Cluster of each object in layer n1 can be represented by a set of objects in layer n2 (Formula 53—Cluster of an object in layer n1 containing frequent objects in layer n2):

K(C₁ⁿ²)={wₐ*Cₐⁿ²;w_{b}*C_{b}ⁿ²;w_{c}*C_{c}ⁿ²; . . . ,wₓ*Cₓⁿ²;}

Choosing the most significant wᵢ connections n2 from the set of the Cluster (Formula 53), and then constructing a hypothesis of the appearance of the next object of such a connection, knowing which pair of objects such a connection corresponds to (Formula 52).

The formation of hypotheses is shown by dotted arrows (FIG. 27). In order to predict the appearance of the fourth object in the sequence (object C₄ⁿ¹), we find the object with the highest weight C₃ⁿ² in layer n2 and build a hypothesis about the appearance of the object C₄ⁿ¹ of the sequence. Similarly, we construct a hypothesis for the appearance of the object C₄ⁿ² and with its help the hypothesis for the appearance of the object C₅ⁿ¹. The presence of several levels n2, n3, n4 and so on makes it possible to predict the appearance of objects located in the distant future.

Those stable combinations of objects that were not “forgotten” during the “cleaning” process will return a “hint” of what the next object in the sequence should be. Since the objects of layer n2 are essentially a connection of existing objects C₁ⁿ²={C₁ⁿ¹→C₂ⁿ¹} of layer n1, then to identify objects of layer n2, you can use the object identifier of layer n1 to which the connection is directed within a pair of these objects:

C₁ⁿ²=C₂ⁿ¹

For layer n3, we similarly have

$$\{ \begin{matrix}{C}_{1}^{n 3} = \{ {C}_{1}^{n 2} \to {C}_{2}^{n 2} ] \\ {C}_{1}^{n 2} = {C}_{2}^{n 1} \\ {C}_{2}^{n 2} = {C}_{3}^{n 1}\end{matrix}$$

and then

C₁ⁿ³={C₂ⁿ¹→C₃ⁿ¹}

Therefore, we can assume that

C₁ⁿ³=C₃ⁿ¹

And so forth.

Remark 5

As you can see, object n2 is a 1st rank link between objects C₁ⁿ¹→C₂ⁿ¹, objects n3 is a 1st rank link between objects C₂ⁿ¹→C₃ⁿ¹, and so on along the chain of future sequence objects. Therefore, creating identifiers for combinations can be avoided and instead use existing object identifiers and their 1st rank Clusters.

The forecasting algorithm is reduced to the following steps:
1. Build a 1st rank Cluster for a known key object,
2. Search in the constructed Cluster for frequent objects with the highest co-occurrence weight and consider one or more found objects as hypotheses of sequence continuation.
3. Repeat steps 1 and 2 for the found hypotheses until we reach the required prediction depth.

What sense will the given algorithm have if instead of the 1st rank Cluster we use the 2nd or higher rank Cluster?

### 5.1.3. High Rank Stable Combinations

In the claimed method, rank sets of different ranks (hereinafter referred to as “Coherent sets”) of known key Objects of the sequence are compared, and the rank of the rank set for each key Object is selected corresponding to the number of Sequence Objects that are separating the named key Object and the Hypothesis Object (hereinafter “Focal Object of coherent sets”), the appearance′ possibility of which is checked.

If the use of the 1st rank Cluster allowed us to predict the appearance of the next object, then the use of the 2nd rank Cluster allows us to predict future objects of the sequence, separated by one unknown object. And the use of Clusters of the 3rd rank will make it possible to predict the appearance of every third object in the sequence, separated by two unknown objects. Etc. . . .

Thus, the execution of three steps of the algorithm using the 1st rank Cluster gives a forecast sequence with a length of 3 objects; execution of three steps of the algorithm using a Cluster of the 2nd rank gives a forecast sequence with a length of 3 objects and a prediction depth of 6 objects, so on . . . executing k steps of the algorithm using a n-rank Cluster gives a forecast sequence of k objects with a prediction depth (n*k) sequence objects.

Each of the obtained forecast sequences is a Window of Attention of the same length, but with a different forecasting depth, and this allows you to compare forecasts of different depths by comparing the full Clusters of each of the Attention Windows with the Sequence Pipe Cluster. If the error ΔK̅ (Formula 6) between the forecast context (Cluster of the corresponding forecasting depth) and the current sequence context (Sequence Pipe Cluster) does not exceed the maximum ΔK̅ₘ̅ₐ̅ₓ̅>ΔK̅, then it can be concluded that the forecast context corresponds to the current context sequence, and if ΔK̅>ΔK̅ₘ̅ₐ̅ₓ̅, then the prediction context differs from the current context of the sequence, which may indicate a prediction error.

### 5.1.4. “Cleaning” the Memory of Stable Combinations

In everyday life, people use a dictionary of 2,000-10,000 words. For a set of 10,000 words, the maximum possible is one hundred million combinations of two words (10,000*10,000), and although not all combinations are possible, the presence of a mechanism for “forgetting” rare combinations seems necessary in order to avoid overflowing memory with unnecessary combinations.

The forgetting mechanism can be implemented in many ways. A preferred method can be a method in which that part of the combinations that are included in X % (for example, 5, 10, 20, 30 and so on percent) with the lowest weight of the joint occurrence among the combinations of the layer is “forgotten”. Thus, “cleaning” the memory will prevent it from overflowing, while “weak” combinations will be deleted from the memory, and “strong” combinations will remain.

### 5.2. Hierarchy of Pipes

### 5.2.1. Pipe Connectivity

Being the next layer of the Sequence Memory hierarchy, Pipes establish a connection between a specific sequence segment (Pipe Generator) which is represented by the sum of Clusters generated by the objects of this sequence segment, on the one hand, and the next layer of the sequence memory sequence hierarchy, in which the Pipes are members of the sequence.

The objects in the next layer of the hierarchy should be linked in the same way as they were connected in the previous one—in the layer of input sequences, namely, the objects following the key object should be present in the Cluster of the future of this key object. Each Pipe Cluster can be associated with a Pipe identifier, since in the Sequence Memory each object has a corresponding Cluster, and each Cluster must have an object (a parent key object).

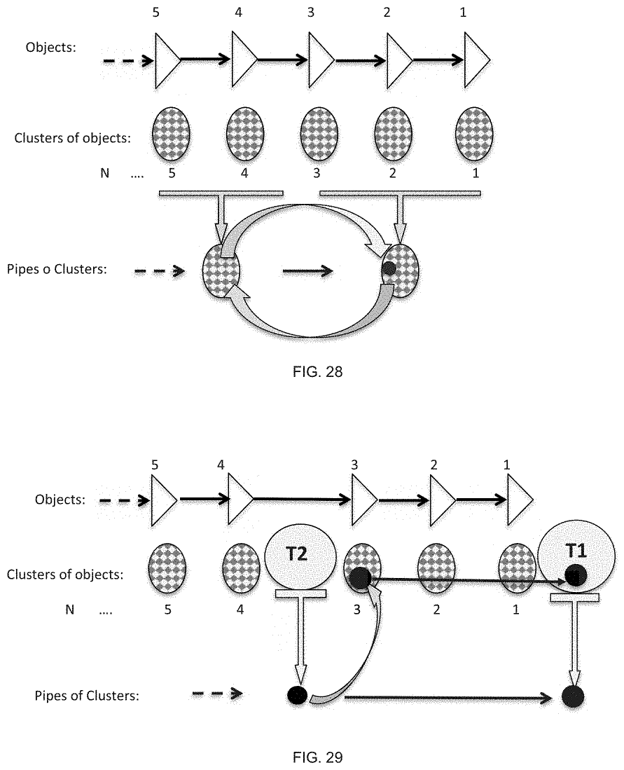

Let's designate Pipe Cluster T2 with T2 object which looks like a small dark object in Pipe Cluster T1 (FIG. 28).

Since the Clusters of Pipes appear during the operation of summing the Clusters of objects, we are talking about adding the identifier T1 Pipes to the Clusters of sequence objects as a feedback to the previous Pipe. This can be illustrated by a more accurate drawing (FIG. 29).

Object clusters 5 and 4 spawned Pipe T2 which was assigned the T2 identifier shown in a circle. This object identifier T2 was then inherited by Object Clusters 3, 2 and 1 (was added to them) and as a result, the T2 object was in the T1 Pipe Cluster, and the T1 Pipe itself was represented as a T1 object. Thus, a link was created between objects T1 and T2. Continuing the process of spawning new Pipes of the sequence and adding the identifier of the previous Pipe to the Cluster of the new Pipe, we get a sequence of identifiers of the Pipes that spawn the Clusters of Pipes containing the identifier of the previous Pipe.

Despite the fact that adding the Pipe identifier to the next Pipe's Cluster seems to be an artificial step, it is quite consistent with the logic of constructing the Clusters of the future and the past, into which the objects that follow the current or preceding it in the sequence of objects fall. Within the framework of this logic, we can say that we created a feedback between two Pipes following one after the other in a sequence of Pipes, although it was possible to create a forward communication instead by placing the identifier T1 in the Cluster of the previous Pipe T2, which, of course, does not change the essence: we created a mechanism for representing individual Pipes as a coherent sequence of identifiers of these Pipes.

Bearing in mind that we assign an identifier to each of the Pipes, as well as to other Sequence Memory objects, then, as for other objects of unnumbered sequence memory, the Pipes hit must contain a fragment (Formula 18) of the sequence—the Pipe Generator, over which the Pipe is built.

Remark 6

The Pipe ID should not only match the Pipe Cluster, but also the Pipe Generator, otherwise the Pipe model will be incomplete. Creating connectivity in the Pipes layer allows you to:
Reconstruct parallel sequences, that is, segments of sequences that could serve as Generators of the Pipe Cluster, having the same context (meaning);
Restore the complete sequence of objects from its segments using the sequence of pipe identifiers and their Generators.
The associated sequence of Pipes identifiers with the Clusters corresponding to each Pipe is itself a sequence of fully connected Sequence Memory, and the segments of this sequence of Pipes can also be collapsed into Pipes, thereby creating the next more compact layer of the Sequence Memory hierarchy.

### 5.2.2. Layers of Pipes

As already noted, the original sequence of objects can be represented as a sequence of synthetic objects—Pipes. Pipes can be constructed using the principle of maximizing the total weight of frequent objects of the Pipes Cluster, or by dividing the sequence into adjacent sections, for example, by dividing the text into sentences, or by dividing the sequence into equal segments in length, or in another way. A sequence of Pipes can be represented by a sequence of their identifiers and collapsed into a Pipe of the next level.

Repeating this process at different levels of the hierarchy, we get many layers of Pipes above the layer of objects of the original sequence.

Definition 6

Pipes built over a sequence of objects will be called Pipes of the 1st kind, and Pipes built over a sequence of Pipes of the 1st kind will be called Pipes of the 2nd kind, and so on up to Pipes of the kth kind.

This creates a powerful mechanism of semantic and temporal compaction of the original sequences of objects into more compact synthetic formations.

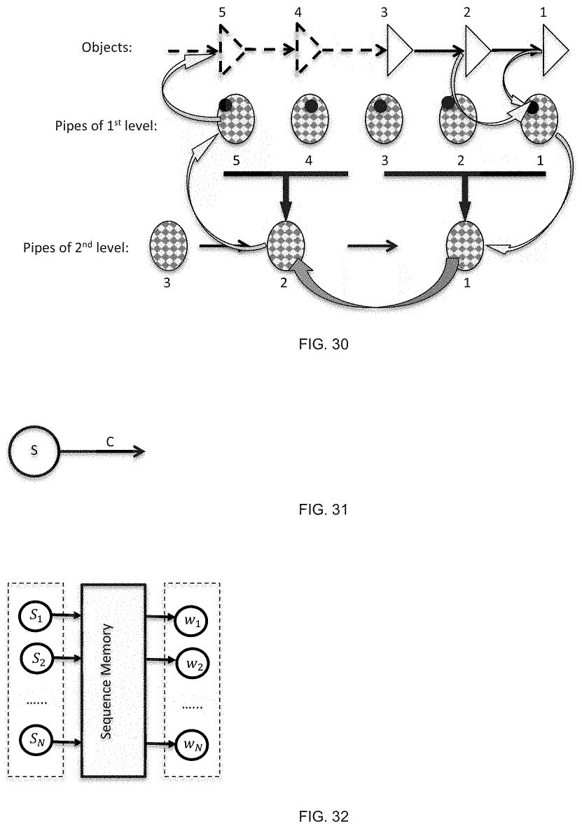

Collapsing different layers of the hierarchy into Pipes allows for multiple semantic compression of the sequence at different levels of the hierarchy, creates a forward-backward connection with the accumulated experience and serves as the basis for the memory mechanism, as well as the production of inferences and conclusions (FIG. 30).

### 5.2.3. Adjacent Pipes

Pipes that follow one another will be called adjacent. Adjacent Pipes are constructed for adjacent sections of the sequence or Adjacent Attention Windows. You can break a sequence into sections in different ways. For example:
1. Arbitrarily split the sequence into sections, the length of which is dictated by technical limitations, for example, the number of microcircuit legs into which signals from the Attention Window objects are input or other features of the technical implementation that limit the size of the Attention Window.
2. Split the sequence into segments separated by input pauses or interrupts [2.2.8].
3. Divide the original sequence into segments determined by the condition of the maximum total weight of the frequent objects Pipes (Formula 39) and so on.

It should be noted that if the context of the sequence remains unchanged, an arbitrary partition cannot reduce the growth of the total weight of the frequent objects of the Pipe (Formula 39), and the introduction of pauses or interruptions can only stop this growth. Thus, dividing the original sequence of objects into segments of arbitrary length or separated by interruptions, and then constructing Pipes for each of the sections, we obtain a sequence of Pipes of the 1st kind, for which it is possible to construct a sequence of Pipes of the 2nd kind and investigate it for the condition reaching the maximum total weight of the frequent pipe objects (Formula 39). However, to fold the sequence of Type 2 Pipes into Type 3 Pipes, the sequence of Type 2 Pipes, as well as the original sequence of objects, can be split into adjacent sections by the methods described above, and already the sequence of Type 3 Pipes can be investigated for execution conditions for reaching the maximum total weight of frequent objects of the 4th kind (Formula 39). Etc.

Therefore, the simplest way to divide the original sequence into adjacent sections is to divide it into sections separated by pauses, and if there is no pause for a long time, then into segments of some maximum length determined by the technical constraints of the input system.

### 6. Memory of Emotions

The nature of emotions is well described in the book by Alexei Redozubov “The Logic of Emotions” [http://www.aboutbrainsu/wp-content/plugins/download-monitor/download.php?id=6]. Alexey Redozubov notes that emotional memory plays an essential role in planning and making decisions, namely, the assessment on the “bad-good” scale, which a person assigns to everything that happens to him. Emotions and reflexes are the same nature:
assessment of sensations—the state of “good-bad” associated directly with sensations, with how we reflexively respond to receptor signals;
evaluation by emotions—the state of “good-bad”, which follows from how our brain evaluated the meaning of what is happening.

Thus, we can say that emotions are a virtual summary assessment of a person's physical sensations.

In his further reasoning, Alexey Redozubov shows that in a situation of choice, planning or decision-making, a person builds hypotheses on the topic of various scenarios of his behavior (possible sequences of his actions and the consequences of such actions) and receives from memory a reflex and emotional assessment of such scenarios, and the resulting assessments for different scenarios compares with each other and makes a choice in favor of the emotionally more preferable scenario. So the situation of choice, known as the Buridan's donkey paradox, forces the donkeys brain to fantasize about how it eats a shovel of hay A or a shovel of hay B and compares the emotional response of these fantasies—and the one that turns out to be emotionally more attractive on the scale of “good-bad”. One of the hays may be preferable, for example, if a donkey noticed a bunch of favorite grass in one of the hays, or, for example, if, due to some circumstances, the earlier experience of choosing the right or left hay was emotionally more pleasant or, on the contrary, unpleasant.

Emotion memory is one of the channels of multichannel sequence memory (see the section “Multithreaded sequence memory”). Emotions are sequences of signals of feelings and sensations from the spectrum “good-bad”, and the source of signals are signals from the nervous system and the experience accumulated by the intellect and associated with the memory received through the channels of other feelings and sensations. Thus, any sequence of actions that led a person to burn his hand from touching a hot frying pan will receive an emotional assessment of “bad” in his memory, and a scenario with a possible touch of a frying pan will reproduce the virtual sensation of a hand burn, recalling the negative experience received earlier. As a result, when planning to touch the pan, a person will build in memory a virtual sequence of his actions in each of the scenarios, build hypotheses of the possible results of such actions, extract from memory an emotional assessment of such possible results and begin to choose between different scenarios of touching the pan, based on the total emotional assessment of each from scripts. As a result, the scenario in which, before touching the pan, a person tries to determine whether the pan is hot, will win in the memory of a person, while not touching the pan itself, or the person will simply give up the thought of touching the pan.

The memory of emotions can be represented by a variety of objects representing the dispersed meanings of the emotional and ethical assessment of “bad-good”. During training, these emotional evaluation objects should be added to the Pipe Cluster along with the input sequence objects during the training of Sequence Memory. When playing back (reading) a sequence from Memory, the objects of the sequence will be reproduced together with the objects of emotional assessment, and we will use the objects of emotional assessment to rank decisions on the “bad-good” scale and make emotionally acceptable decisions.

### 7. Hardware Implementation of Sequence Memory (PP)

The specified technical result for the PP object is achieved due to the fact that in the PP, containing two interconnected sets of N parallel numbered buses, of which the first set is located above the second set so that the buses of the first and second set form in the plan a set of intersections of the form Crossbar, where the ends of each set of N parallel buses located on one of the sides of the “matrix” are used as inputs, and the opposite ends are used as outputs so that the signals applied to the inputs of the first set of N parallel numbered buses are read both from the outputs of the first set of N parallel numbered buses, and from the outputs of the second set of N parallel numbered buses in the presence in intersections of the first and second sets buses of Commutative elements of the first and second sets, the intersection of the first and second set; the angle β\hat{ }0 between the buses of the first and second sets is chosen, based on the functional and geometric requirements for the memory device, wherein, the buses of the first and second sets with the same numbers are connected to each other at their intersection so that the set of such connections forms a diagonal of the matrix, dividing the matrix into two symmetric triangular semi-matrices (hereinafter referred to as “Triangles”), at least one of which (hereinafter the “First Triangle”) is used by connecting each two buses, at least with mismatching numbers from the first and second sets at their intersection by means of at least one Artificial Neuron of Occurrence (INV) so that the ends of the buses of the first set are inputs and the ends of the second set of buses are outputs of the Triangle, and INV is used as the named Switching Element for accumulating, storing and reading the weight of the co-occurrence of objects to which the buses connected by the named INV correspond; each of said INVs functions at least as a Counter with an activation function and a memory cell for storing the last value and the value of the INV activation threshold; before starting the device operation, the last value is assigned some initial value, which is saved in the memory cell of the Counter; the value of the INV activation threshold is also stored in the memory cell; in the learning mode, each time when signals are applied simultaneously to each of the buses connected by means of the INV, the named INV measures one of the signal characteristics on each of their buses, then compares the measured values of the characteristics and, if the comparison result corresponds to the value of the INV activation threshold, the INV reads the last value from the memory cell, increases the named last value by the amount of change in the occurrence and stores the new last value in the memory cell, and in the playback mode the signal is fed to at least one of the named buses connected by means of the INV, the signal is passed through the INV, where from the memory cell the last value is extracted, one of the signal characteristics is changed according to the extracted last value, and the named modified signal is transmitted to the second of the named buses connected by means of the INV, to extract the named last value from the named one of the signal characteristics and use the named last s values as the weight of the coincidence of objects to which the buses correspond.

### 7.1. Sequence Memory Device (PP)

In working on the architecture, we will proceed from the fact that we have a set of M unique objects S of sequences, each of which can have a connection with any other object of the set M. Each object in the architecture is represented by the input S of the bus C (FIG. 31). The sequence object is entered into the PCB by applying the signal S to the input of bus C.

Thus, physically the object C is represented by the signal S, which is fed to the input of the bus C of the Sequence Memory (FIG. 32), which should lead to the generation of a set of weight coefficients W={w₁, w₂, . . . wₙ} corresponding to the frequent objects of the Cluster K={w₁*C₁, w₂*C₂, . . . , wₙ*Cₙ}.

### 7.1.1. Triangles

As before, we will call links of the first rank the links between two adjacent objects of the sequence; links of the second rank—a link between objects in a sequence separated by one object; . . . ; the link of the N-th rank is the link between the objects of the sequence separated (N−1) objects (see FIG. 33).

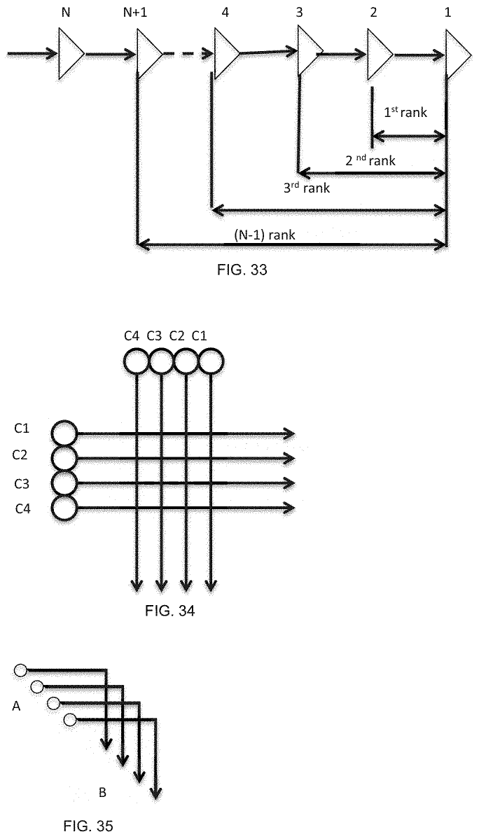

Consider the matrix architecture of the Sequence Memory in a form of N*N crossbar buses C={C₁, C₂, C₃, . . . , Cₙ}, which provides the communication of buses “each with each”, that is, the architecture represents a fully connected layer of buses (see FIG. 34).

The buses C1, C2, C3, C4 shown in the vertical and horizontal rows (FIG. 34) are the buses of the same objects S of a set of unique Sequence Memory objects M=(S1, S2, S3, S4). The disadvantage of the crossbar geometry (FIG. 34) is that the signal of the object must be simultaneously applied to two of its buses—vertical and horizontal. To send an object's signal to only one bus, it is necessary to connect the vertical and horizontal buses of each of the objects, however, the crossbar geometry prevents this, since the distance between the buses is determined by the size of the matrix and the more buses in the matrix, the more buses are used to separate the vertical and horizontal buses of the object and the more difficult it is to connect them. The crossbar geometry can be improved by using only half of the crossbar matrix (FIG. 35).

Artificial Neurons of Occurrence (INV) are placed at the intersections of buses with matching numbers, each of which contains at least one counter of mutual occurrence weight, and buses with matching numbers are connected by a parallel connection that is parallel to the Neuron of Occurrence.

Parallel communication is equipped with an element that changes the signal when switching from one bus with matching numbers to another, in order to set the reading direction for the Counter named INV.

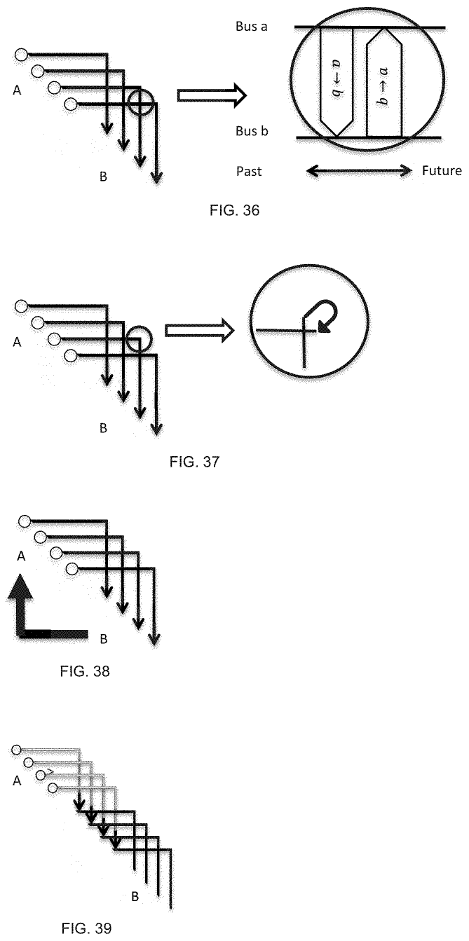

On the diagonal of the matrix there are N intersections “with itself”, and the number of intersections “each with the others” is duplicated due to the matrix nodes symmetric with respect to the diagonal, differing only in the sequence of the objects a→b and b→a above and below the matrix diagonal. If we “fold” the matrix diagonally, then the nodes of the links a→b and b→a will be one above the other. If the named links a→b and b→a are arranged parallel to each other at the intersection of buses a and b, and each of the links is used depending on the order of objects a and b in the sequence a→b or b→a, then this will allow using for each object not two, but one bus, eliminating the matrix from redundancy and eliminating the need for commutation of the vertical and horizontal buses of the same object (FIG. 36). If signals are simultaneously applied to the buses of objects a and b one of whose characteristics differs (for example, voltage), then the direction a→b or b→a will be determined by the named difference (for example, the potential difference). Thus, to write or read the connection weight of objects a and b on their buses, it is necessary, for example, that a potential difference is formed at the intersection of the buses, which corresponds to reading or writing the connection a→b or b→a. The number of simultaneous switching on of both buses in the learning mode is memorized by the Counter, the value of which each time increases by a known value of the joint occurrence, preferably by one. Since we may be interested in reading the connection weight of objects in the direction of the “future” and in the direction of the “past”, this may correspond, for example, to a change in polarity (swap of input and output of buses) on the bus of each of the objects.

Therefore, in the declared PP, in some cases, the Triangles inputs are used as outputs, and the outputs as inputs.

Obviously, the proposed architecture makes it possible to implement the “Memory State” matrix (Formula 17), which means “Statement 7” is also true for the proposed architecture, and any sequence memory state can be obtained using linear transformations over the weights of links located at the bus intersections of the proposed architecture.

In accordance with the claimed method, the rank set of the unique object is a set of the first rank and contains the weights of the frequent Objects immediately adjacent to the named key Object in the named sequences. In addition, a limited number of rank sets are stored in the memory, and the “Future” data set and the “Past” data set are formed as a linear composition of weight coefficients or rank sets of the instant memory state (MSP) data set.

Perhaps, for some cases it will be useful to get rid of the intersections “with itself”, but in the case of the presence of links “with itself”, they can be implemented using a “loop” from the bus as shown below (FIG. 37), and the “loop” In fact is a parallel connection of buses with the same ones, which are already connected by means of the Counter. Thus, the signal from one of the buses passes to the other bus through such a parallel connection, and since the occurrence “with itself” does not have a direction a→a, then the occurrence value can be read only in one direction. However, in order to set the direction of the signal flow through the Counter—the signal at the Counter input was different from the signal at the Counter output, an element should be built into the parallel connection of buses, which properly changes the characteristics of the signal when passing from one bus to another.

We will write in the matrix only the first rank links for each object Cₙ with every other object Cₖ belonging to the full set of Sequence Memory objects. Then the full Cluster of weights for the object Cₙ can be read from the triangle as a recurrent connection (FIG. 38):
Step 1. We input the object Cₙ into the triangle, and at the output we obtain links of the first rank of the object Cₙ—the set of weights Wₖ for co-occurrence of frequent objects Cₖ with the object Cₙ in sequences.
Step 2. We input into the triangle the objects Cₖ obtained at the previous step, and at the output we obtain links of the first rank for each of the introduced objects Cₖ—the set of frequent objects Cⱼ and the weight wⱼ of their co-occurrence with the key object Cₖ;
Step 3. We repeat Step 2 until we have completed the required number of input and output cycles.
Step 4. Let us summarize the weights w_{uz} obtained at each of the steps z for a unique object Cᵤ from the complete set of Sequence Memory objects w_{uΣ}=Σ_{z=1}^{z}w_{uz}.
Step 5. We represent the complete Cluster of the object Cₙ as a set Kₙ={w_{1Σ}*C₁, w_{2Σ}*C₂, w_{3Σ}*C₃, . . . , w_{NΣ}*C_{N}}.

To take into account the weakening function (Formula 10) before adding the weights (Step 4), the weight w_{uz} of the link of the rank z of the object Cₙ with the object Cᵤ should be multiplied by the value of the weakening function ƒ(r) of the link of the corresponding rank.

Remark 7

In the process of training the matrix, feedbacks of the nth rank are created, which can be read as anticipatory when changing the direction of reading.

Remark 8

Summarizing the weights obtained at each of the input cycles for each of the unique objects Cᵢ of the complete set of Sequence Memory objects, we obtain the total weight of the corresponding object Cᵢ in the full Cluster of the object Cₙ for the Attention Window, the size of which is equal to the number of input cycles. Thus, to obtain a full Cluster of an object, you can use only one triangle of Sequence Memory.

Artificial Neurons of Occurrence (INV) of such a single triangle accumulates and stores the weights of co-occurrence in sequences for each unique object (key object) with all other unique objects (frequent objects).

Thus, for each unique key Object, at least one either “future” or “past” set of weights of a rank that is the same for all unique key Objects (hereinafter the “base rank” of the set) is stored in memory, and each weighting coefficient of mutual occurrence key object and frequent Object of a named rank set refers to a frequent Object that is directly adjacent in sequences with a named key Object or is separated from the named key Object by such a number of frequent objects which corresponds to the base rank.

A certain set of all rank sets of the base rank is stored in memory as a reference (hereinafter referred to as the “Reference Memory State” or “ESP”), and any “Instant memory state” (hereinafter “MSP”) or its part is compared with the ESP or its part to identify deviations of the MSP from the ESP.

An array of “future” or an array of “past”, or a rank set of a rank other than a set of base rank are represented by a set derived from a set of SMEs.

The “Future” data array and the “Past” data array are formed as a linear composition of weight coefficients or rank sets of the MSP data array.

### 7.1.2. One-Section Matrix

Artificial Neurons of Occurrence (INV) in a one-section matrix encode a rank set of weights of the same rank, preferably of the first rank.

For each unique key Object, at least one rank set of “future” or “past” the rank of which is the same for all unique key Objects (hereinafter, the “base rank” of the set), is stored in memory, and each weight coefficient of the mutual occurrence of the key Object with a frequent Object in the named rank′ set refers to a frequent Object that is directly adjacent in sequences to the named key Object or is separated with the named Key object by the number of frequent objects corresponding to the base rank.

The named rank′ set, being the set of the first rank, contains the weights of the frequent Objects immediately adjacent to the named key Object in the named sequences.

A limited number of rank sets are stored in memory.

The triangle (FIG. 38) can be used to obtain both a full and a ranked Cluster of a sphere of the future or past with a certain radius R.

To obtain a Full Cluster of a sphere of radius R, it is necessary to organize a cycle in which the signals of the objects at the output are transmitted to the input of the triangle, and the weights of each of the unique objects of the Full Cluster are summed up with the weights of this object obtained in the previous cycles. The total number of cycles must match the radius of the sphere R.

To obtain a R-rank Cluster, it is necessary to organize a cycle in which the signals of the objects at the output are transmitted to the input of the triangle, and the weights of each of the unique objects of the Ranked Cluster are read at the output from the matrix only at the end of the last cycle. The total number of cycles must correspond to the Cluster R rank.

The disadvantage of using a matrix with one triangle is its slow operation, namely, that in order to obtain both Full and Rank Clusters, the number of necessary triangle work cycles is equal to the radius of the sphere (aka the rank) for which the Cluster is calculated. An even more time-consuming process will be to extract Rank Clusters for constructing hypotheses for the continuation of the sequence and for constructing the Back Projection of Coherent Clusters.

The Sequence Memory, represented by the One-Section Matrix, is the array matrix “Memory States” (Formula 16) and [2.3.11]. If we send signals to the inputs of the buses of all objects of the One-Section Matrix, then at the output we will receive a set of weights representing the projection of the “State of consciousness” vector onto the coordinate axes of the Sequence memory objects. Any Sequence Memory Cluster can be reproduced using the One-Section Matrix as the projection of the vector \vec{K}ₛₜₐₜₑ onto the named axes. This makes it possible to implement the Sequences Memory only using a One-section matrix, for example, a One-Section Matrix of the first rank. However, we will look at other architectures that provide better performance.

It is easy to see that the connections of the “States of Consciousness” triangle can be graphically represented (FIG. 38) by points located at the crossings of the triangle, and the weight of co-occurrence can be conveyed either by different sizes of points or by color or in another way. This allows you to represent the triangle in the form of a picture and use the picture as input data for perceptronic or convolutional or other neural networks with a known architecture. The purpose of such training of a neural network can be to establish a correspondence between the graphical representation of the weights of the “State of consciousness” of the triangle and the set of objects that formed such a graphical representation. In robotics, a neural network of known architecture trained in this way can control deviations of the “State of consciousness” of the Robot Sequence Memory (Instant Memory State—MSP) from a given reference state (Reference Memory State—ESP) in order to correct the memory state and respond to other human-defined PP states. For example, the use of neural networks to work with Sequence Memory can be training a neural network to recognize Clusters of Pipes or Clusters of Pipe Calibers, which may allow activating the buses of Pipes and Generators of the Pipes in the Memory of Sequences using the mechanisms of recognition of neural networks.

The differences between ESP and MSP can also be used to predict the appearance of new objects, and therefore to search (detect) and correct errors in sequence input.

When the MSP deviates from the ESP, a search algorithm or a prediction algorithm, or an error correction algorithm, or their combination is performed.

When entering an Object, a unique digital code of which could have been entered with an error, the comparison of rank sets is carried out in order to identify a possible error.

### 7.1.3. One-Rank Matrix

In the PP, one or more Triangles (hereinafter referred to as the “Sections”) are connected in series, and in the named INVs of each of the Sections only the weights of the First Rank links are accumulated, stored and provided for reading, and the buses with the same numbers of each two consecutive Sections N and (N+1) are connected so that the outputs of the buses of Section N serve as inputs of the buses of the adjacent Section (N+1), and in the learning mode either all Sections are trained simultaneously or only one Section X is trained, and the last value of the co-occurrence in the memory of the Counter located at the intersection of two specific buses any of the sections, is equal to the last value of the Counter located at the intersection of the same two specific buses of Section X, and in playback mode Section (N+1) is used to re-modify the signals received from Section N.

The performance of the “One-Section Matrix” [7.1.2] with links of the first rank can be improved by increasing the number of triangles in the matrix. As noted earlier [2.3.9], the link between any two neighboring objects of the sequence is a link of the first rank and by successively connecting the triangles containing links of the first rank with another triangle containing the same links of the first rank, then connecting the first two with the third same triangle, and so on, you can create a matrix containing only triangles with links of the first rank, connected in series with each other. Below is shown a matrix having two triangles with bonds of the first rank (FIG. 39).

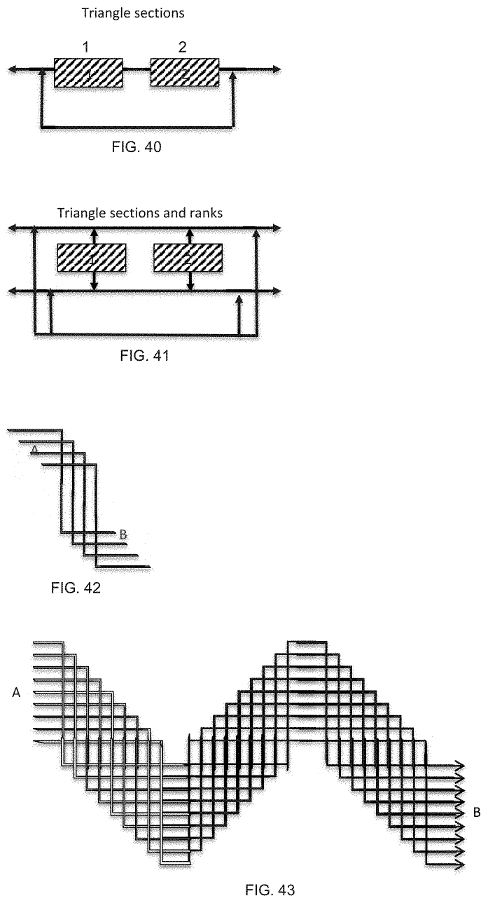

The matrix containing R of identical triangles with connections of the first rank will henceforth be called “One-rank matrix”. The series connection of triangles can be conventionally depicted as shown below (FIG. 40).

By “sequence” of connections of triangles, we mean that the bus outputs of the first section are the inputs of the second section, and so on. In the case of a matrix of two sections, one cycle can extract the Cluster for a sphere with radius R=2. In this case, the weights of the objects after reading are transferred to the output of the matrix and there, they are added with the weights of this object obtained from other sections of the matrix.

Serial connection of one-section matrices allows for one cycle of operation of the One-rank matrix to obtain Clusters for spheres of different radius at the output of each single-section matrix.

### 7.1.4. Multi-Rank Matrix

In the PP, one or more Triangles (hereinafter referred to as the “Rank Sections”) are connected in series, and in the named INVs of each of the Sections, the weights of links of the same Rank are accumulated, stored and provided for reading (hereinafter the “Rank of the Section”) and the Ranks of adjacent Sections differ in value by one or more, and buses with the same numbers of each two adjacent Sections of Rank N and Rank (N+1) are connected so that the outputs of the buses of the Rank N Section serve as inputs of the buses of the adjacent Rank Section (N+1), and in the learning mode Neurons of Occurrences of each Section are trained on the links of the Rank corresponding to the Rank of the Section, and in the playback mode each Section of a certain Rank is used to read signals changed by the named INVs of the Section of the corresponding Rank.

The disadvantage of the “triangle” architecture (FIG. 35) is that it has a high laboriousness of the study of high rank links—the mutual occurrence of objects separated in sequence by many other objects.

Nevertheless, the triangle architecture [7.1.1] can be used as a “Rank Triangle” for storing higher rank links. For links of the corresponding rank, its own triangle is created and links of Cₙ objects with objects Cₖ of the corresponding rank are stored in it, and the links of the Cₙ object with Cₖ objects of the corresponding rank are read either once or in accordance with the step-by-step algorithm described in section [7.1.1]. Using a separate Rank triangle for storing links of the corresponding rank and combining Rank triangles of different ranks into a single architecture, you can simultaneously work with links of different ranks—write and read them as described in section [7.1.1]. Different sections of such a matrix can independently reproduce a Cluster of the corresponding rank, so the links between the sections are parallel-sequential (see FIG. 41).

It should be noted that, like the One-Section Matrix [7.1.2], each of the rank triangles characterize a stable statistical “state of memory” of sequences or “state of consciousness” [2.3.11] with different depths of connections (ranks), and this is what makes it possible to increase deep prediction using the Multi-Rank Matrix architecture and, as a consequence, increase the performance of the architecture.

### 7.1.5. Matrix Geometry Generator

The architecture of the matrix (FIG. 35) can be improved for this by using the “triangle” as a generator of more complex geometry with links “each to each”. FIG. 42 shows a generator consisting of two triangles and having connections of the first and second ranks “each to each”, respectively. In what follows, any architecture with a “triangle” generator or a more complex generator of several triangles will simply be called a “matrix”.

By increasing the number of triangles or generators (FIG. 42) of the matrix, we can linearly increase the number of intersections “each with each” (see FIG. 43)

The proposed matrix of links (FIG. 43) allows you to implement links of the 1st rank in the first “triangle” of the matrix, links of the 2nd rank in the second “triangle” and so on up to the N-th “triangle” that implements the links of the Nth rank.

Remark 9

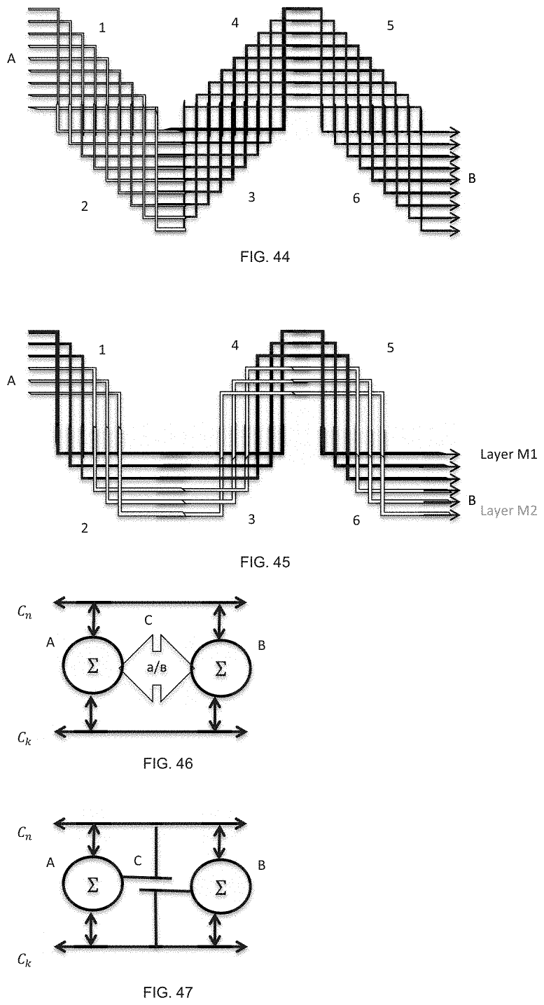

In the process of the matrix learning, feedbacks are created, which can be read as anticipatory when changing the direction of reading. Therefore, despite the fact that in the matrix (FIG. 43) the inputs A are shown on the right and the outputs B are on the left, the rank blocks can follow from left to right or from right to left depending on which matrix mode is turned on. To write sequences into the matrix and to read the links of the “past”, the numbering of the rank blocks will be straight lines 1, 2, 3, . . . , N. To read the “future” links, the numbering of the rank blocks would be from right to left. Therefore, it is convenient to draw matrices by numbering the rank blocks without indicating the direction of input-output (FIG. 44), since if the numbering remains unchanged, the inputs and outputs can be reversed.

Thus, triangle inputs can be used as outputs and outputs as inputs.

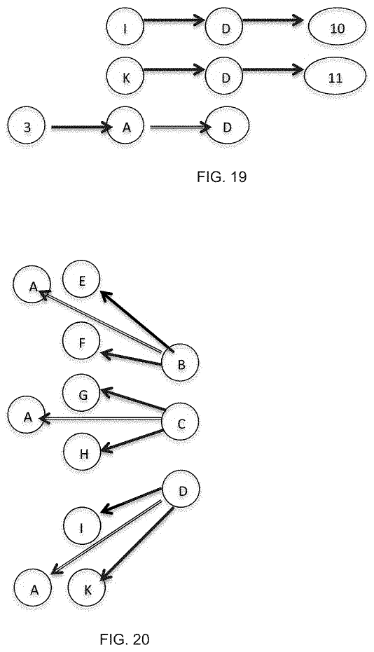

It is clear that the shape of the matrix (FIG. 43) depends on the used matrix generator (shown by light bus lines) and depending on the shape of the generator, the number of triangles included in the generator and their connections within the generator, as well as the connection of generators to each other, the matrix can take different forms. The matrix can be not only flat in shape, but also three-dimensional, ascending in a spiral, like a DNA molecule, creating the required number of crossings “each with each” of the next rank with the addition of each new generator to the matrix on a new turn/layer. By changing the angle between inputs A and outputs B (see FIG. 19), it is possible to physically change the geometry of the generator, and hence the topology of the architecture, depending on production conditions or design requirements. By connecting generators located one above the other, it is possible to obtain a layered (wafer) chip architecture, each layer of which is represented by a separate generator or an architecture generated by the generator.

### 7.1.6. Matrix Layers

The matrix contains two layers: the object layer—Layer M1, and the Pipes layer—Layer M2 (FIG. 45).

### 7.1.7. Some Remarks

To separate the learning, recall and possibly other modes, the matrix must have a mode control channel and switch to the corresponding mode after receiving a control signal.

Since, due to the large number of unique objects, all the matrix buses cannot be output to separate legs of the microcircuit connector, a switching unit is required that provides switching of the matrix buses with a limited number of microcircuit legs, which allows transmitting of the incoming signals of objects received on the legs to the matrix buses corresponding to the signal and also allows you to read outgoing signals of objects from the matrix buses and transmit them to the microcircuit connector pins.

Another solution for switching the matrix with external devices is wireless input and output of object signals. For this, the matrix is equipped with a radio transmitting and receiving radio switch (RK). The input signal for each of the matrix buses can be received by the RK and transmitted to the corresponding bus. The signals read at the output from the buses enter the RC, which transmits the signals via the radio channel to external consumers.

In the process of work of the PP, synthetic objects emerge. Therefore, the matrix must have additional buses that do not belong to any known object of PN sequences.

### 7.2. Object Layer

### 7.2.1. Artificial Neuron of Mutual Occurrence of Objects (INV)

The named INV accumulates, stores and provides for reading the value of the co-occurrence weight for two objects of the sequence, which are either not separated by other objects, but directly follow each other in sequence, forming a First Rank link, or are separated by one or more objects in sequence, forming, respectively link of the Second or higher Rank.

### 7.2.1.1. Artificial Neuron of Occurrence (INV) Device

Artificial Neuron of Co-Occurrence (INV) or “Counter” is an element located at the intersection of the buses of objects Cₙ and Cₖ and designed to accumulate the value of cases of mutual occurrence of objects Cₙ→Cₖ in the process of matrix learning, as well as reproducing the accumulated value in the process of reading. As noted above [7.1.1], at the intersection of the buses of objects Cₙ and Cₖ, not one, but two Counters (A and B) should be located, one of which remembers the direct Cₙ→Cₖ, and the second, the reverse Cₖ→Cₙ occurrence of the objects Cₙ and Cₖ, as well as sensor C, which measures the ratio of the weights of forward and reverse occurrence i=a/b (hereinafter i is the “inversion indicator”), as well as the direction of inversion i, which we will call the direction from higher weight to lower, the inversion value for which should be greater than one i>1. (FIG. 46).

The inversion sensor can be made, for example, in the form of a capacitor C (FIG. 47). Namely, in the learning mode, signals of different strengths are sent to the bus of two Attention Window objects, which makes it possible to power both Counters, each of which is connected to one of the plates of the capacitor C, and the charge of the capacitor and its polarity depend on the value of the inversion index i and on the direction of inversion \vec{l}. Thus, in the learning mode, the capacitor is charged the more, the higher the inversion rate, and the charge polarity coincides with the direction of the inversion. In the “play” mode that follows the teach mode, the capacitor is discharged and a potential difference appears at the inputs/outputs of the A and B buses, corresponding to the inversion value, and the polarity indicates the direction of the inversion. This allows you to “predict” the next object in the sequence. Despite the fact that here is an example using a capacitor, one skilled in the art can suggest other ways to implement the inversion sensor, without going beyond the level disclosed in this work.

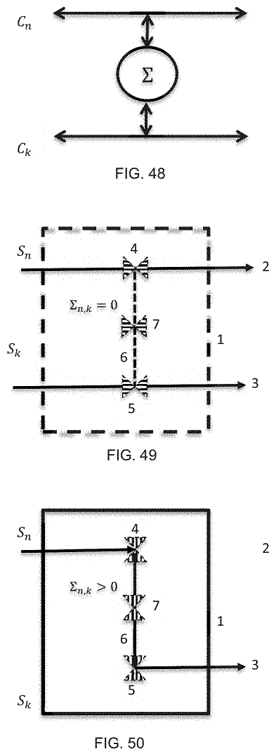

However, in what follows, we will illustrate the process of learning and reading connections only in one of the directions (FIG. 48), for example, in the direction Cₙ→Cₖ. Let us also recall that a change in the polarity of the buses of objects corresponds to a change in direction from “future” to “past” or vice versa.

Since the Neurons of Occurrence are located in the “triangles” of the matrix, the Counters have a Rank corresponding to the “triangle”. Thus, each Counter can be uniquely identified by the identifiers of two objects n and k, as well as by the rank r. Therefore, the following counter identification can be used: Σ_{n,k,r}.

Counter is a conventional name, it can be, for example, a memristor or an element using other physical principles, however, in any case, the Counters task is to accumulate the value of the co-occurrence of objects at the intersection of the buses of which such a Counter is located.

The counter may also have the ability to partially or completely “forget” the number of occurrences of an object in sequences, depending on the frequency of occurrence of an object in the sequences. The latter property allows one to “forget” about the occurrence of objects that are rarely found in sequences.

The counter must process the incoming signal in opposite directions and generate an output signal corresponding to the incoming direction.

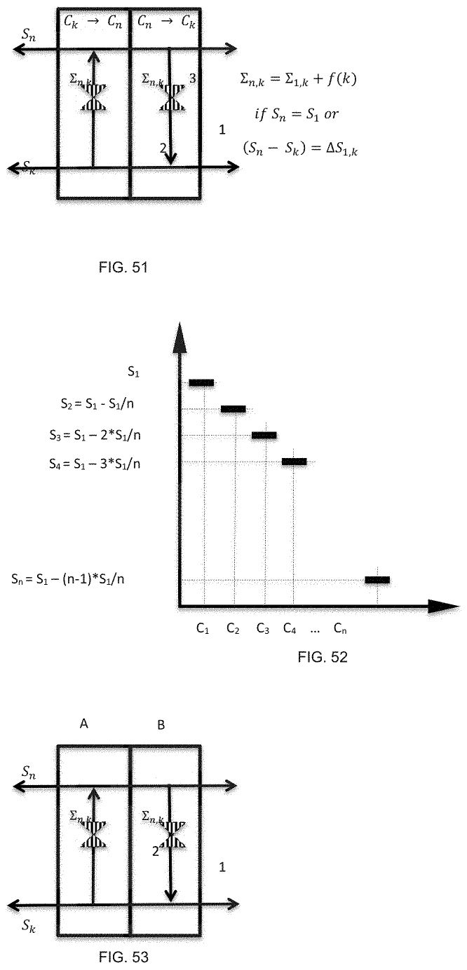

Each of the combinations of objects Cₖ→Cₙ and Cₙ→Cₖ must be represented by a separate counter (FIG. 51).

Since in the learning mode the matrix records feedbacks, then if the memory read signal coincides with the direction of the training signals, then the matrix will reproduce the Cluster of the past (forward playback), and if the incoming signal is opposite to the training signals, then the matrix will reproduce the Cluster of the future (reverse playback).

### 7.2.1.2. Neuron State Before Learning

Before learning, a neuron can be conventionally represented as shown below (FIG. 49) Before learning, the memory of neuron 1 is empty, so neuron 1 is shown with a dashed line. As long as the link weight Σ_{n,k,k}=0, link 6 at the intersection of the buses of objects Cₙ and Cₖ does not exist, which corresponds to the “closed” position of conditional gate 7. In the state with closed gate 7, link 6 cannot pass the signal between buses of neuron 1 and therefore in the read mode conditional gates 4 and 5 of the buses of objects are in the “open” position, passing signals further along the buses of objects.

7.2.1.3. Neuron State after Learning

The memory of the trained neuron is not empty and therefore neuron 1 is shown with a solid line. If any value of co-occurrence Σ_{n,k,k}>0 is written to the neuron, the connection at the intersection of the buses of objects Cₙ and Cₖ opens, which corresponds to the “open” position of conditional gate 7. In the state with open gate 7, connection 6 can miss signal between the buses of neuron 1 and therefore in the read mode conditional gates 4 and 5 of the buses of objects are in the “closed” position without passing signals further along the buses of objects, and instead, gates 4 and 5 switch the buses of objects with the connection of the neuron, which allows the signal to pass from one bus of the object Cₙ through link 6 to the other bus Cₖ, reading the weight value Σ_{n,k,k} and transferring it to the second bus Cₖ.

Remark 10

Learning of neurons is possible only in the direction of feedback, however, the value of the co-occurrence of a neuron can be read both in the direction of the feedback and in the direction of the anticipatory connection, and the reading of the anticipatory and feedback should be possible both in the direction Cₙ→Cₖ and in the opposite direction Cₖ→Cₙ.

### 7.2.1.4. Writing to the Memory of Neurons of a Multi-Rank Matrix

The recording takes place in the mode of neurons learning (memorization). To train neurons at the intersection of the buses of input objects, at least two sequence objects are simultaneously introduced into the matrix. To enter objects into the matrix, they are encoded, respectively, by signals S₁, . . . , Sₙ, which are fed to the object buses. Signals of objects should encode the identifier of the object, and the place of the object in the Window of Attention should be encoded by another measurable characteristic of the signal of the object, which we will conventionally call the “strength” of the signal. The strongest signal is S₁ of the latest Attention Window object, and the signal strength of any Attention Window object Cₖ is calculated as a function of the signal strength S₁ and the rank of object k in the Attention Window (Formula 54):

Sₖ=ƒ(k,S₁)

Formula 54 allows you to calculate the difference ΔS₁ₖ=(S₁−Sₖ) between the signal strength S₁ and Sₖ of objects C₁ and Cₖ. If the difference between the signal strengths of the buses of objects C₁ and Cₖ is equal to ΔS_{1,k}, then this makes it possible to train the triangle neurons of rank k only on the difference ΔS_{1,k}. Therefore, the preferred solution is that only neurons are trained at the intersections of the bus of the latest Attention Window object C₁, with the buses of other Cₖ Attention Window objects. Only Counters with identifiers Σ_{1,k,k} located on the bus of the latest Attention Window object C₁ at intersections with other Attention Window objects Cₖ will memorize the mutual occurrence values, and the rank k of the Counter will correspond to the rank of the Cₖ object in the Attention Window. That is, the value of the mutual occurrence of objects C₁ and C₂ will be recorded in the triangle counter of the 2nd rank. In fact, this is a triangle of the 1st rank, since the objects C₁ and C₂ are not separated by other objects, but then the sum would have to be denoted not by Σ_{1,k,k}, but by Σ_{1,k,k+1}. The value of C₁ and C₃ will be recorded in the 3rd rank triangle counter, and so on, the value of C₁ and Cₙ will be recorded in the nth rank triangle counter.

Thus, the learning process of a neuron can be described as follows:
1. Before training, neurons contain a zero value Σ_{n,k}=0. The value of the weight of the co-occurrence of objects Cₙ and Cₖ separated by (r−1) objects of the sequence before learning is equal to zero Σ_{n,k}=0, and after the start of learning neurons accumulate the value of co-occurrence weights Σ_{n,k}=Σ_{n,k}+ƒ(k).
2. During learning, the Counter simultaneously receives two input signals S₁ and Sₖ, respectively, on the buses C₁ and Cₖ of the triangle of rank k.
3. The weight of co-occurrence link between of objects C₁ and Cₖ increases only in the triangle neuron of rank k, where the difference in signal strength corresponds to the value (S₁−Sₖ)=ΔS_{1,k}, so the Counter remembers the new value Σ_{1,n,k}=Σ_{1,k}+ƒ(k) of the co-occurrence of objects C₁ and Cₖ, where k is the rank of object Cₖ in the Attention Window and the rank of the matrix triangle, and the value ƒ (k) can change or be constant, in particular, it can be ƒ (k)=1.

### EXAMPLE

Consider an example of a linear signal attenuation function ƒ (n)=(1−(n−1)/N) and then the signal strength on the buses of Attention Window objects in the matrix memorization mode will be (Formula 55):

Sₙ=S₁*(1−(n−1)/N)

where N is the total number of rank blocks in the PP, and the identifying number of a specific rank block n is an integer value that satisfies the condition 0<n≤N.

Since the attenuation function is linear, the difference S=(Sₙ−Sₙ₊₁) in the measured signal characteristic between every two consecutive inputs Cₙ and Cₙ₊₁ will be constant. However, the attenuation function can also be selected non-linear.

A signal with strength S₁ is always applied to the bus of the latest Attention Window object; a signal with strength S₂—to the bus of the penultimate object and so on up to Sₙ, which is fed to the bus of the n-th object of the Attention Window entered on (n−1) object earlier than the latest one. Then at each moment of time the distribution of the signal strength of the Attention Window objects will be as shown in FIG. 52.

The “strength” of a signal is understood as any measurable characteristic—resistance, capacitance, voltage, current, frequencies, and so on, or any other characteristic depending on the listed ones.

In the 1-rank matrix block, the Counter value changes between the bus with the signal strength S₁ and the bus with the signal strength S₂, the difference between which is ΔS₁=S₁/n.

In the block of the 2nd rank matrix, the Counter value changes between the bus with the signal strength S₁ and the bus with the signal strength S₃, the difference between which is ΔS₂=2*ΔS₁.

In the 3rd rank matrix block, the Counter value changes between the bus with the signal strength S₁ and the bus with the signal strength S₄, that is, between the bus with the signal strength S₁ and the bus whose signal is weaker than S₁ by the value ΔS₃=3*ΔS₁.

And so on, in the (n−1)-th rank block of matrix, the counter value changes between the bus with the signal strength S₁ and the bus with the signal strength Sₙ, the difference between which is ΔS₍ₙ₋₁₎=(n−1)*ΔS₁.

### 7.2.1.5. Reading the Memory of the Matrix Neuron

Despite the fact that we used the attenuation function to number the Attention Window objects when writing to the PP, when reading the PCB there is no such need, the signals of all buses at the input to the matrix can be of the same strength. This, in particular, gives an advantage, since it avoids the need to normalize the profile of the Pipe Cluster at the exit from the matrix and allows comparing not normalized, but true Clusters of Pipes and Subpipes.

While writing to the memory of a neuron occurs only in one direction—in the direction of feedbacks, the memory of a neuron can be read in both directions, both in the direction of reverse and in the direction of anticipatory connections, both in the direction Cₖ→Cₙ, and in the opposite direction Cₙ→Cₖ (FIG. 53).

To read the values of the mutual occurrence of the object Cₙ with other objects Cₖ in the mode of reading the memory of neurons, the signal of the named object S, is supplied to the bus of the object Cₙ. Reading the neuron memory value (reading the Counter value) at the intersection of the buses of objects Cₙ and Cₖ in a triangle of rank r is possible only if the value of the mutual occurrence of the named objects is greater than zero Σ_{n,k,r}>0.

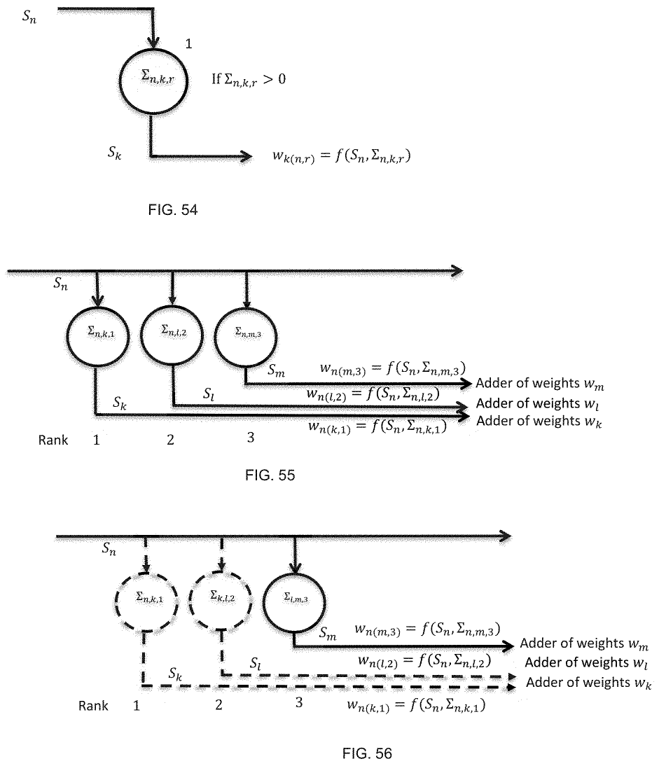

If at the intersection of the buses of objects Cₙ and Cₖ the value of the counter Σ_{n,k,r}>0, then the signal from the bus of the object Cₙ goes through the neuron to the bus of the object Cₖ while reading the value Σ_{n,k,r} and calculating the weight value co-occurrence W_{k(n,r)}=ƒ(Sₙ,Σ_{n,k,r}) the signal Cₖ and the weight value w_{k(n,r)} are output to the bus of the object Cₖ (FIG. 54). Thus, at the input of the bus of the object Cₙ, we have the original signal Sₙ, and at the output of the neuron, we have the signal of the weight of the joint occurrence w_{k(n,r)}=ƒ(Sₙ,Σ_{n,k,r}) which is output to object bus Cₖ.

### 7.2.1.6. Reading the Rank Cluster of an Object.

Multi-Rank Matrix

The multi-rank matrix is shown in FIG. 55.

For reading the rank Cluster Kₙ of the object Cₙ (FIG. 55), a read signal is sent to the bus of the object Cₙ, and the weights of the co-occurrence of the object Cₙ with other objects Cₖ are read from the triangle neurons of rank r, located at the intersection of the buses of the objects Cₙ and Cₖ. At the output of the bus of the object Cₖ, we obtain the weight of the co-occurrence w_{k(n,r)}.

Thus, the process of reading the memory of a neuron can be described as follows:
1. To read the weights of the co-occurrence of the Cₙ object with other Sequence Memory objects, the Sₙ signal is sent to the bus of the Cₙ object
2. If the value of the Counter located at the intersection of the buses Cₙ and Cₖ is not zero, then using the value of the Counter Σ_{n,k,r} the Counter converts the input signal Sₙ into a signal of the weight of the co-occurrence w_{k(n,r)}:w_{k(n,r)}=ƒ(Sₙ,Σ_{n,k,r})
3. The co-occurrence signal w_{k(n,r)} is transmitted to the bus of the object Cₖ where the co-occurrence weight wₖ is read
4. The Rank Cluster Kₙⁱ of the object Cₙ is formed as the weight wₖ received from the bus of the object Cₖ, read from the triangle of rank i of the matrix of links.

Let's demonstrate this with an example. Suppose that we need to count all links of the third rank for the object Cₙ, and the object Cₙ in the triangle of links of rank 1 has a connection only with the object Cₖ, and in the triangle of links of rank 2 it has a connection only with the object Cₗ, and in the triangle of links of rank 3 it has a connection only with the object Cₘ (FIG. 56).

Weights will be read from the matrix only from the rank triangle of rank three, therefore, the result of reading the weights of the third rank will be the only weight wₘ of the object Cₘ, and the Cluster will be as follows:

Kₙ³={w_{l(m,3)}*Cₘ}

One-Rank Matrix

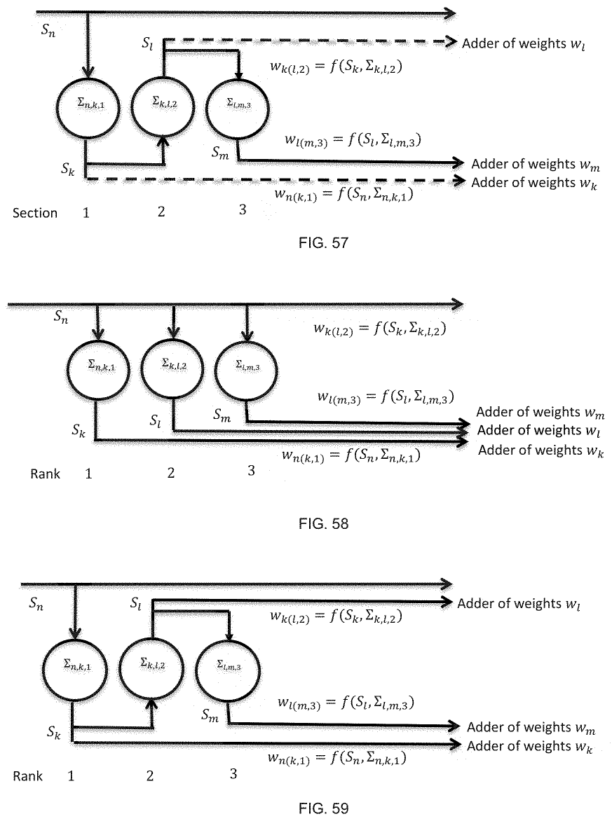

To read the Cluster of the Cₙ object, the Sₙ signal is sent to its bus. In this case, only the weights of the 1st rank are read in the matrix between the triangles of the matrix of successive sections [1 and 2], . . . , [r and (r+1)], [(r+1) and (r+2)], . . . and etc. This is illustrated below (FIG. 57).

Consider a matrix that has three triangles (sections) with connections of the first rank (FIG. 57). We are faced with the task of reading of the Cluster of the third rank Kₙ³ of the object Cₙ, therefore the adders at the output of the matrix buses are tuned to store only the weights obtained from the third triangle. Suppose that object Cₙ in triangle 1 has a link only with object Cₖ, and object Cₖ in triangle 2 has a link only with object Cₗ, and object Cₗ in triangle 3 has a link only with object Cₘ. To read the Cluster of the third rank Kₙ³ of the object Cₙ, the signal Sₙ is fed to the bus of the object Cₙ and after reading the weight of the co-occurrence w_{n(k,1)}=ƒ(Sₙ,Σ_{n,k,1}) between the objects Cₙ and Cₖ, the weight of co-occurrence is output to the adder of the weights of the frequent object Cₖ, and the signal Sₖ from the bus of the object Cₖ enters the adder between the buses of objects Cₖ and Cₗ, where it reads the value of the weight of the co-occurrence w_{k(l,2)}=ƒ(Sₖ,Σ_{k,l,2}) of objects Cₖ and Cₗ and transfers the weight value to the adder of the weights of the bus of object Cₗ, and the signal Sₗ, from the bus of object Cₗ, enters the adder between the buses of objects Cₗ and Cₘ, where reads the value of the weight of co-occurrence w_{l(m,3)}=ƒ(Sₗ,Σ_{l,m,3}) of the objects Cₗ and Cₘ and transfers the weight value to the adder of the weights of the bus of the Cₘ object.

Bus adders select only the weights obtained from the counters of the third section and the Cluster of the third rank for the object Cₙ will contain only the weight of the Cₘ object:

Kₙ³={w_{l(m,3)}*Cₘ}

### 7.2.1.7. Reading a Complete Cluster of Object.

Multi-Rank Matrix

To read the complete Cluster of the Cₙ object, the sum of all the rank Clusters of the Cₙ object should be read. For this, a read signal is supplied to the bus of the object Cₙ, and the values of the Counters are read at the intersection of the bus of the object Cₙ with each object Cₖ of each of the rank triangles. The total weight wₖ of the co-occurrence of the object Cₙ with the object Cₖ is calculated as the sum of all the weights of the occurrence of the named objects in triangles of different ranks w_{k(n,r)} (Formula 56):

$${w}_{k} = {\sum }_{i = 1}^{N} {\sum }_{j = 1}^{R} {w}_{k ( i , j )}$$

Where j—is the rank of the triangle, and R is the total number of triangles, i—is the number/identifier of the object, and N—is the total number of unique objects Cᵢ.

Thus, the process of reading the memory of a neuron can be described as follows:
1. To read the weights of the co-occurrence of the Cₙ object with other Sequence Memory objects, the Sₙ signal is sent to the bus of the Cₙ object
2. If the value of the Counter located at the intersection of the buses Cₙ and Cₖ is not zero, then using the value of the Counter Σ_{n,k,r} the Counter converts the input signal Sₙ into a signal of the weight of the co-occurrence w_{k(n,r)}:w_{k(n,r)}=ƒ(Sₙ,Σ_{n,k,r})
3. The co-occurrence signal W_{k(n,r)} is transmitted to the bus of the Cₖ object where it is added to the weights of the co-occurrence of the Cₖ object obtained from the Counters at the intersections of the Cₖ bus with the Cₙ object in triangles of other Sequence Memory ranks:

$${w}_{k} = {\sum }_{i = 1}^{N} {\sum }_{j = 1}^{R} {w}_{k ( i , j )}$$

Where R—is the rank of the triangle and N—is the total number of unique objects Cᵢ.
4. At the output of the matrix from the bus of each object Cₖ of the Sequence Memory, the signal of the total weight of the co-occurrence wₖ of the object Cₖ with the object Cₙ is read, forming a complete Cluster of the Cₙ object.

Let's demonstrate this with an example. Suppose that we need to count all links of all ranks for object Cₙ, and object Cₙ in the triangle of rank 1 has a link only with object Cₖ, and in the link triangle of rank 2 it has a link only with object Cₗ, and in the link triangle of rank 3 it has a link only with the object Cₘ (FIG. 58).

To read the full Cluster of the object Cₙ, the signal Sₙ is fed to the bus of the object Cₙ and in parallel enters the neurons located at the intersection with the buses of objects Cₖ, Cₗ and Cₘ. The value of the weight of the co-occurrence W_{n(k,1)}=ƒ(Sₙ,Σ_{n,k,1}) between the objects Cₙ and Cₖ is output to the adder of the weights of the frequent object Cₖ, the value of the weight of the co-occurrence W_{k(l,2)}=ƒ(Sₖ,Σ_{k,l,2}) of objects Cₖ and Cₗ is output to the adder of the weights of the bus of object Cₗ, and the value of the weight of co-occurrence w_{l(m,3)}=ƒ(Sₗ,Σ_{l,m,3}) of objects Cₗ and Cₘ is output to the adder of weights of the bus of object Cₘ.

Thus, we get a full Cluster of the Cₙ object:

Kₙ={w_{n(k,1)}*Cₖ;w_{k(l,2)}*Cₗ;w_{l(m,3)}*Cₘ}

One-Rank Matrix

When the Cluster of the C_n object is read, the S_n signal is sent to its bus. In this case, only the weights of the 1st rank are read in the matrix between the triangles of the matrix of successive sections, 1 and 2, . . . , r and (r+1), (r+1) and (r+2), . . . and etc. This is illustrated below (FIG. 59).

Consider a matrix that has three triangles with links of the first rank (FIG. 59). Our task is to read the complete Cluster of the Cₙ object. Suppose that object Cₙ in triangle 1 has a link only with object Cₖ, and object Cₖ in triangle 2 has a link only with object C₁, and object C₁ in triangle 3 has a link only with object Cₘ. To read the full Cluster of the Cₙ object, the Sₙ signal is fed to the bus of the Cₙ object and after reading the weight of the co-occurrence w_{n(k,1)}=ƒ(Sₙ,Σ_{n,k,1}) between the Cₙ and Cₖ objects the weight of the co-occurrence is output to the adder of the weights of the frequent object Cₖ, and the signal Sₖ from the bus of the object Cₖ enters the adder between the buses of the objects Cₖ and Cₗ, where it reads the value of the weight of the co-occurrence w_{k(l,2)}=ƒ(Sₖ,Σ_{k,l,2}) of objects Cₖ and Cₗ and transfers the weight value to the weight adder of the bus of the object Cₗ, and the signal Sₗ, from the bus of object Cₗ enters the adder between the buses of objects Cₗ and Cₘ, where it reads the weight value of the co-occurrence w_{l(m,3)}=ƒ(Sₗ,Σ_{l,m,3}) objects Cₗ and Cₘ and transfers the weight value to the adder of the weights of the bus of the object Cₘ.

Thus, we get a full Cluster of the Cₙ object

Kₙ={w_{n(k,1)}*Cₖ;w_{k(l,2)}*Cₗ;w_{l(m,3)}*Cₘ}

### 7.2.1.8. Reading Coherent Rank Clusters

Coherent Rank Clusters were discussed in detail in section [3.2.6], and in this section we will only consider how to read Coherent Rank Clusters from a matrix, taking into account the peculiarities of working with a matrix [Remark 9].

The named Clusters Kᵢ^{(k-i)} can be read by sending signals to the buses of Attention Window objects at the matrix input and reading their rank Clusters in the corresponding rank block of the matrix:

Each object Cᵢ out of (k−1) objects of the the Window of Attention, is fed to the input of the corresponding bus of the matrix and read from the matrix the rank cluster Kᵢ^{(k-i)}, where the superscript means the rank of the Cluster, and the subscript means the number of the object in the Window Attention. For the latest WA object, a Cluster of rank 1 will be read, for the previous WA object—a Cluster of rank 2, and so on for the earliest WA object—a Cluster of rank (k−1).

After reading the rank Clusters Kᵢ^{(k-i)} for all Objects of the Window of Attention, the obtained Clusters are operated as with coherent rank Clusters of the objects of the Window of Attention.

7.3. Integration of PP with a Neural Network of Known Architecture

Since in the process of PP operation at the outputs of the buses of the PP matrix, a set of weights of the co-occurrence of sequence objects can be read, such a set can be used as initial data (for example, represented as a feature map) for feeding to the input of the Neural Network with a known architecture, containing or only a fully connected layer of perceptrons, or multiple layers, including Convolutional Convolution, ReLU, Pooling, (Subsampling) and fully connected perceptron layers, connected using any known architecture, including GoogleNet Inception, ResNet, Inception-ResNet and any other known architectures.

Another way to integrate with a traditional neural network is to connect the outputs of the PP matrix to the inputs of a traditional neural network to transfer the weights of the Pipe cluster or the Pipe caliber to the input of the traditional neural network as input data.

At least one of the named arrays of the future or the past, or the named sets of the Pipe or the Caliber of the Pipe, or the Reference State of Memory (ESP), or the Instantaneous State of Memory (IMP), or the aggregate of the named arrays and sets, or any set that is derived from the named arrays and sets, are introduced as input data into an artificial neural network of perceptrons or a convolutional neural network or other artificial neural network with a known architecture.

The outputs of the PP buses of the hierarchy level M1 are used as inputs for an artificial neural network of perceptrons or a convolutional neural network or other artificial neural network with a known architecture, which is used as the named set of INIs.

### 7.4. Disadvantages of Traditional Neural Networks

It is known that a neural network with a well-known architecture (traditional neural network) is capable of creating or creates synthetic objects. For example, convolutional layers of convolutional networks create new objects of a higher level of the hierarchy by convolving the original images and creating feature maps, and the process of convolving images is well described and understood. Each of the perceptrons of the fully connected layer of traditional neural networks is in fact an object of a higher hierarchy level than the objects for which the perceptron was trained and with which many perceptron inputs are connected. However, the known methods of training perceptron layers and the perceptron device do not allow specific perceptrons to form recurrent connections with specific sequences or fragments of sequences on which a fully connected perceptron layer was trained. Moreover, all perceptrons of a fully connected layer are trained simultaneously, which does not allow determining the order of training specific perceptrons of the layer and constructing sequences of objects from the trained perceptrons of the next level of the hierarchy. As a consequence, traditional neural networks do not allow creating Memory of Sequences of different levels of hierarchy.

The named limitations of traditional neural networks do not allow analyzing the semantic occurrence at different levels of the semantic hierarchy, that is, do not allow investigating the cause-and-effect relationships at different levels of the hierarchy.

The listed disadvantages limit the use of traditional neural networks to individual specialized tasks, not allowing the creation of a universal Artificial Intelligence, the so-called Strong AI, on their basis.

To eliminate the aforementioned disadvantages of traditional neural networks, it is necessary to use several different artificial neurons of a new type, the description of which is given below, as well as the Hierarchical PP.

The specified technical result for the object “Hierarchical Sequence Memory (IPP)” is achieved due to the fact that the IPP consists of a plurality of interconnected Sequence Memory (PP) devices, so that each pair of adjacent hierarchy levels N and (N+1) of Sequence Memory (hereinafter referred to as “the levels of the hierarchy M1 and M2”) is connected by a set of artificial neurons (hereinafter referred to as artificial neurons of the hierarchy—INI).

### 7.5. Artificial Neuron of Hierarchy (INI) of the Sequence Memory

INI contains a Totalizer with a Totalizer activation function, a plurality of Group A Sensors, each of which is equipped with an activation function and a memory cell for placing the Corresponding weight value A and is located at the output of one of the buses of the sequence memory device (PP) of the hierarchy of level N, as well as a plurality of Sensors D, each of which is equipped with a memory cell and a device for measuring and changing at least one of the signal characteristics and is located at the inputs of one of the PP buses of the hierarchy level N; moreover, each of the Group D Sensors is connected to the output of the Adder, and each of the Sensors of the A group is connected to the input of the Adder, in addition, the output of the Totalizer is equipped with a connection with the input of one of the buses of the PP device of the upper hierarchy level (N+1); The INI learning mode is performed in cycles, and at each cycle an ordered set of one or more learning signals (hereinafter the Attention Window) are fed to the inputs of one or more PP buses of the hierarchy level N, and the signals in the Attention Window are ordered using the attenuation function. Each of the signals passes through one or more INVs located in the hierarchy level N PP and the named one or more INV changes one of the signal characteristics encoding the co-occurrence weight and at the output of each of the plurality of PP buses of the hierarchy level N a signal is obtained encoding the co-occurrence weight from which the value of the weight of the co-occurrence of the corresponding bus is extracted and transferred to the Totalizer, where the weights obtained from the outputs of different buses are added and the value of the cycle sum is stored, after which the Attention Window changes and the learning cycle is repeated, and on each next training cycle the value of the sum of the next cycle is compared with the sum value the previous cycle, and if the value of the sum of the next learning cycle is equal to or less than the value of the sum of the previous learning cycle, the learning of INI stops and each sensor of group A is assigned with the Corresponding value of the weight of A (hereinafter “activation weight”) obtained for the learning cycle with the maximum sum of weights, and the weight is used as the activation value of the activation function of sensor A. The Totalizer assigns the value of the maximum sum of the weights or assigns the value of the number of sensors of group A with non-zero values of the Corresponding weights A or assigns both of these values to the activation function of the Totalizer; and each sensor of INI of group D at the input of each of the PP buses of the hierarchy level N, to which signals were applied during the learning cycle with the maximum sum of weights, measures and places in the Sensor D memory cell the corresponding value D of at least one of the characteristics of the learning signal encoding the named value of the attenuation function D of the bus signal in the Window Attention. In the INI playback mode, the playback signal is fed to one or a plurality of SP buses of the hierarchy level N and the co-occurrence weight is obtained at the output of the plurality of PP buses of the hierarchy level N and, if the co-occurrence weight obtained at the bus output is equal to or exceeds the value of the sensor activation function A of such a bus, sensor A sends to the Totalizer either the value of the activation weight or a value one or both values, and the Totalizer sums the obtained values of the activation functions of sensors A and compares the resulting sum with the value of the activation sum of the Totalizer and, if the total value is equal to or exceeds the value of the activation function of the Totalizer, the INI activation signal is fed to the output of the Totalizer and simultaneously fed to the input of one of the buses of the hierarchy level (N+1) PP and to the inputs of the sensors of the group D of the hierarchy level N of PP, the memory cell of each of which contains the named Corresponding value of the attenuation function D, and each of the named sensors of group D changes the Totalizer signal in accordance with the Corresponding value of the attenuation function D and feeds the modified signal to the input of the corresponding PP bus of the hierarchy level N or does not change the signal and feeds the unchanged signal to the input of the corresponding PP bus of the hierarchy level N.

In accordance with the claimed method, during the cycle of inputting a sequence of Attention Window objects, the Set of Pipe (at the output of the matrix) is compared with the previously saved at least one set of the Pipe Caliber, and if the difference of the Set of the Pipe from the set of the Pipe Caliber is comparable with some error, then the Pipe Generator corresponding to the named Pipe Gauge set is extracted from the Sequence Memory and the named Pipe Generator is used as the result of the Sequence Memory search (hereinafter “memories”) in response to the Attention Window input as a search query.

### 7.5.1. Artificial Neuron of Hierarchy' Device (INI)

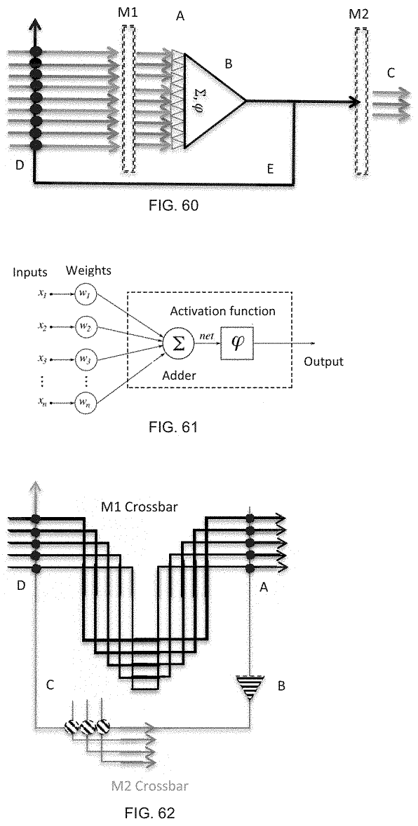

The scheme of the Artificial Neuron of the Sequence Memory Hierarchy—INI (FIG. 60) differs from the scheme of the artificial neuron of traditional neural networks—the perceptron (FIG. 61) in that the INI connects two Sequence Memory matrices M1 and M2, each of which represents adjacent levels of the Sequence Memory hierarchy, and the inputs of the INIs Totalizer are the outputs of all the buses of the matrix of the lower level of the hierarchy M1, and the only output of the INI has feedback with the inputs of all the buses of the matrix of the lower level M1 of the hierarchy and is used to memorize the Pipe generator, at the same time the output of the INI is also the input of one of the buses matrix M2 and therefore is connected according “each with each” with all buses of the matrix of the upper level M2 of hierarchy.

The INI connection with matrices M1 and M2 is shown in FIG. 62.

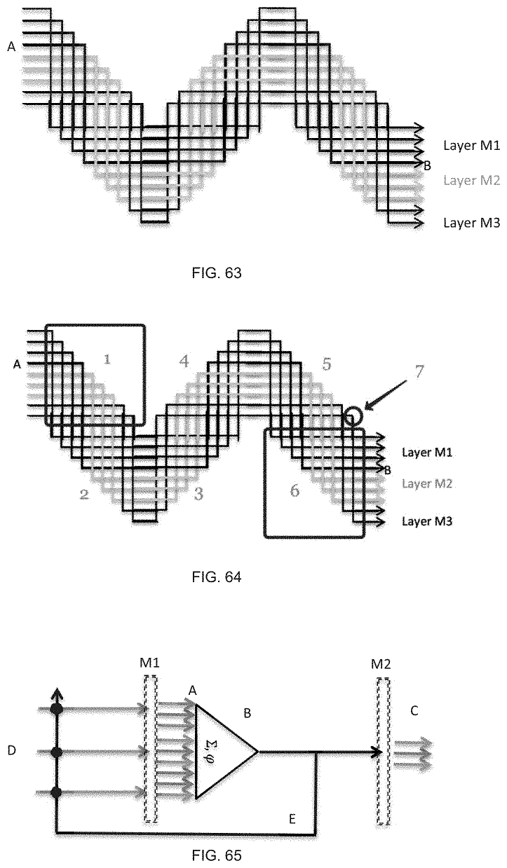

Although fully connected matrices of different levels of the hierarchy M1, M2, . . . , MX are commutated with each other using INI (FIG. 62), due to the fact that each INI is the input of one of the buses of the next level matrix, matrices of all levels can be made in the form of one matrix or one “triangle” (FIG. 63), while it is necessary that the connections between the buses of matrices of different levels were not “each with each”, but corresponded to the connection diagram of the INI (FIG. 62) using sensors of group A and D with inputs and outputs of level M1 matrix. Moreover, the INI output is connected “each with each” with all buses only inside the layer of the matrix M2 (FIG. 63)

In order to separate the layers, the group of sensors D is placed in one of the triangles, for example, in the first triangle—rectangular region 1, the group of sensors A corresponds, for example, the last sixth triangle—rectangular area 6, and the groups of counters C of the matrix of each level are located in the triangles 2, 3, 4 and 5, and in the intersection of buses belonging to different levels of the hierarchy, counters are preferably absent, and communication between buses of different levels of the hierarchy is carried out only by means of INI and their sensors of groups A and D. Adders B must be located anywhere between areas 1 and 6, for example, an INI adder can be placed on the diagonal in the area 7 (circled) where the INI bus intersects “with itself” (FIG. 64).

7.5.2. Group a Sensors with Activation Function

### 7.5.2.1. Learning

During the learning process, the sensors of group A have an activation function and only work if the Pipes bus is active, that is, if a learn signal is present in the Pipe bus. We will call the bus of such a Pipe or “Active” or “Hot” bus of a Pipe or just a Pipe. The sensor at the intersection of the Pipe's bus with the bus of the frequent object of the Pipe's Cluster fixes the total weight of the frequent object in the Pipe's Cluster at each cycle of the Attention Window input (FIG. 65).

At each cycle, the value of the total weight of the frequent object w_{iΣ} of the Pipe's Cluster in each sensor A is compared with the new value w_{(i+1)Σ} and, if w_{(i+1)Σ}≤w_{iΣ}, then the sensor value is zeroed w_{(i+1)Σ}=0, and the sensor itself is blocked. This is done in order to remove from the Pipe's Cluster the symmetric set difference of the Attention Window key objects' Clusters. A new non-zero value w_{iΣ} by each sensor A is transferred to the totalizer B where the obtained value is summed up with similar values obtained from other sensors A in order to calculate the value of the Pipe Caliber:

$${K}_{T} = {\sum }_{i = 1}^{n} {w}_{i Σ}$$

The summation result is compared by the Totalizer with the result of the previous cycle and, if the result is equal to or less than the previous one, then the totalizer B disables the Pipe's learn mode, and the totalizer saves the maximum value K_{Tmax} of the sum of the Pipe Gauge weights as the value of the Totalizer activation function. After disabling the Pipe's learning mode, the w_{iΣ} value of the sensor of block A corresponding to the K_{Tmax} value is stored in the sensor as the threshold value w_{iφ} of the φ activation function of sensor A.

### 7.5.2.2. Operation

After training, all sensors A of the Pipe continue to fix the current value of the total weight of the frequent object w_{iΣ} in the current Cluster at the output of the matrix M1 and compare it with the value of the sensor activation function w_{iφ}. If the total weight of a frequent object in the Current Cluster is equal to or greater than the value of the activation function (Formula 57—Pipe activation conditions):

w_{iΣ}≥w_{iφ}

then the sensor A sends a signal of “1” (logical “yes”) or the value of the activation weight or both values to the adder B. Sensors with zero activation values (passive sensors) do not participate in the operation and do not send signals to the totalizer or their signals are not taken into account by the totalizer.

7.5.3. Totalizer B with Activation Function

### 7.5.3.1. Learning.

On the first training cycle of the Pipe, the adder receives the values of the total weight of the frequent object from all buses of the frequent objects, and the sensors of all other buses are blocked by the adder until the end of learning. On each cycle, the adder also blocks the sensors, the value of the total weight of which has not increased in at least two consecutive cycles w_{(i+1)Σ}=w_{iΣ}. This allows to remove from the Pipe' Cluster the symmetric set difference of the Attention Window key object′ Clusters.

The obtained from the sensors values of the total weight of the frequent object Cₖ of the Pipe's Cluster w_{iΣ}^{k} are added, and the value of the sum of the total weights is compared with the same value obtained in the previous cycle of the Attention Window input w_{(i+1)Σ}^{k} and if the sum has ceased increase:

$${\sum }_{k = 1}^{K} {w}_{i Σ}^{k} \geq {\sum }_{k = 1}^{N} {w}_{( i + 1 ) Σ}^{k}$$

then the adder sends a learning mode disable signal to all sensors A, and each sensor with non-zero total weights sends a readiness signal to the adder. The “one” value can serve as a readiness signal, and then the sum of units will be equal to the number of sensors, or the weight value can serve as a readiness signal, and then the sum will be the total weight of co-occurrence of all frequent objects of the Pipe Cluster. The adder adds up the readiness signals and stores the sum as the value of the function φ of activation of the INI neuron.

### 7.5.3.2. Operation.

During operation, the adder receives activation signals from the sensors of group A, and if the sum of the signals is equal to the value of the activation function φ, then the Pipe is activated and the Pipe signal is sent to the adder output, which is simultaneously fed to the input of the Pipe's bus in the M2 matrix where it generates a Cluster for which the Pipe's bus is a key object, and is also fed to the inputs of the M1 matrix, activating the Pipe Generator.

### 7.5.4. Sensors Group C (Co-Occurrence Counters of Matrix M2)

### 7.5.4.1. Learning

During Pipes learning on the Pipe's bus in group C, the strength of the Pipe's teach signal is supplied without using the attenuation function, since during learning the Pipe is the latest object of the Attention Window of the M2 matrix and therefore its signal in the Attention Window of M2 layer should not be attenuated. The strength of the signals of the previous Trumpets in the Attention Window of the M2 matrix is weakened in the same way as the signals of objects in the Attention Window of the M1 matrix are weakened. At the same time, the values of the counters at the intersections of buses of the Attention Window' Pipes increase.

### 7.5.4.2. Operation

When adder B is activated, the Pipe's signal is fed to the Pipe's bus input of matrix, which generates a Pipe Cluster at the output of matrix M2.

### 7.5.5. Group D Sensors

### 7.5.5.1. Learning.

In the process of teaching the Pipe, the signals of the Attention Window objects numbered/ranked in the Attention Window using the attenuation function are sent to the input of the Matrix M1 of the lower hierarchy level. Therefore, in order to memorize the Pipe Generator, sensor D of each bus of Attention Window objects memorizes the signal strength values or the value of the attenuation function on the active buses of Attention Window objects.

### 7.5.5.2. Operation

When the adder B is activated, the signal from it is sent to all sensors of group D, where the stored value of the attenuation function is applied to the signal or the signal is brought into line with the stored value of the signal strength on the object's bus during teaching. This allows the input of the matrix M1 the signals of objects ordered as in the Attention Window, which corresponded to the Pipe when it was memorized (created).

### 7.5.6. INI Work Sequence

When the adder B is activated, the signal at the output of the INI through the feedback activates the Pipe Generator at the input of the lower-level matrix, simultaneously passing through the INI bus through the fully connected matrix of upper-level objects buses, where it generates a Cluster of links with the objects of the upper hierarchy level corresponding to the direction of the feedback. If only links of the first rank are used, then the set of links of INI of the past will not differ from the set of links of INI of the future, and therefore the reading of the links of occurrence of INI and other objects of the upper-level matrix will not depend on the direction of reading the links of INI in the upper-level matrix.

Thus, when the adder B is activated, the architecture returns an INI Generator at the input and the corresponding INI Cluster at the output of the lower-level matrix, and as a key object of the upper-level matrix, INI generates a Cluster of frequent objects at the output of the upper-level matrix.

Obviously, the Cluster of frequent objects at the output of the matrix of the upper level of the hierarchy can activate the INI adder of a higher level of the hierarchy, and so on, which makes it possible to recursively return to the inputs of the matrices the Pipe Generators of higher and higher levels, thereby returning more and more deeper memories.

### 7.5.7. The Advantages of INI Over the Perceptron

The prototype of the Artificial Neuron of Hierarchy of the Sequence Memory (INI) is the perceptron of traditional neural networks, including convolutional ones. The advantages of the INI over the prototype are that:
1. INI connects two fully connected matrices M1 and M2 of different levels of the sequence memory hierarchy,
2. The INI inputs are connected to the outputs of the M1 matrix, which allows the INI to use the weights determined by the statistics of the co-occurrence of the objects of the M1 matrix, and not by the backpropagation algorithm, which makes the values of the weight of specific neuron inputs unpredictable.
3. The output channel of the INI adder is connected by a forward link with one input of the M2 matrix (the pipe bus) and feedback with a set of inputs of the M1 matrix (a set of objects of the Pipe Generator),
4. The presence of feedback, provides INI
   a. auto-associativity of the sequence memory, allowing you to retrieve from the memory the sequences entered into it and their parts (Pipe Generator), which correspond to the Cluster of weights of frequent objects of the pipe, and
   b. implements communication between different levels of the hierarchy of fully connected sequence memory.

Outwardly, the INI differs from the perceptron mainly by the presence of feedback with the Pipe Generator, however, the operation of the INI differs significantly from the operation of the perceptron, which allows achieving the following technical result:
1. To supply the inputs to the INI with a set of weights, each of which is determined by the statistics of the co-occurrence of objects of the matrix M1, while the weights of the inputs of the perceptron are determined using an abstract mathematical apparatus.
2. Associate the set of weights at the input to the INI with the object (Pipe's bus) of the next level of the hierarchy (in the matrix M2), while the signal from the output of the perceptron can be used as initial data of the same abstract mathematical apparatus, which does not allow identifying the object the next level of the hierarchy;
3. The presence of the named feedback in the INI during the learning process of the INI allows associating the named set of weights of the mutual occurrence of the Pipe objects with the sequence of the Pipe Generator objects
4. The presence of the named feedback in the INI upon activation of the INI allows activating the also named sequence of the Pipe Generator at the input of the matrix M1 as a memory, which “sharpens” the context of the input sequence (memories corresponding to the context of the input sequence are retrieved) and this action is similar to the effect of lateral inhibition taking place in the cerebral cortex.

### 7.6. Layers of Stable Combinations

Stable combinations are probably a level of hierarchy, which in the case of text sequences can be represented both by abbreviations and stable short constructions (sequences) of objects. For example, in the examples “I went to the cinema”, “you went to the cinema” and “he went to the cinema”, two constructions can be distinguished: “ . . . went to the cinema” which does not change, and the more complex “someone went to/on . . . ” With a change of pronoun. Nevertheless, stable combinations can be represented in the object layer as one of the objects, which allows the memory of the sequence of the object layer to accumulate statistics of the co-occurrence of such a stable combination with other objects. In general, a stable combination should be understood as a sequence of objects, the length of which is shorter than a certain characteristic length of the Window of Attention, and therefore the combinations may not be detected using the Attention Windows.

Knowledge of stable combinations makes it easier to predict the appearance of the next object in the sequence if the current context of the sequence assumes the use of a stable combination, the beginning of which has already appeared in the sequence, and the ending may still follow. In this situation, the system must generate a hint and the hint must be the next object of a stable combination or all objects of a stable combination, ordered in the order of their combination. Thus, the problem of predicting the appearance of the next object in the sequence using stable combinations splits into two problems:
1. A sample of a set of objects—hypotheses, the inversion index of which, together with the last known object of the sequence, exceeds a certain threshold value of the inversion index (see below 7.4.1).
2. Testing each object—hypothesis for compliance with the current context of the sequence

As noted earlier [3.2.1], identification of stable combinations can be solved within the framework of a general approach to forecasting. We also said (Remark 5) that the creation of synthetic identifiers of stable combinations and buses for them can be avoided if we use the prediction of the appearance of a new object using coherent rank clusters in the focus of which is an unknown object of the sequence. Nevertheless, it is useful to assign synthetic identifiers to stable combinations of objects, as it helps to build sequences from stable combinations.

### 7.6.1. Inversion Indicator

One of the ways to detect stable combinations can be the technique of comparing the weight of the co-occurrence of objects in the forward and backward directions, as described above [2.1.3] and [7.2.1.1]. To do this, recall that the Artificial Neuron of Occurrence (INV) located at the intersections of each pair of buses contains not one, but two Counters, one each for summing the weights of the occurrence of two objects in each of the directions Cₙ→Cₖ and Cₖ→Cₙ, and it is these values of the occurrence that should be compared with that to highlight stable combinations for which the ratio of the weight of direct occurrence to the weight of inverse occurrence (hereinafter referred to as the “inversion indicator”) should be higher than some critical value characteristic of stable combinations

I>Iₘₐₓ

or fall into the small X % of pairs with the highest co-occurrence weight:

$$( 1 - \frac{w}{{w}_{max}} ) * 100 \% \leq X \%$$

or simultaneously have a high inversion and fall into a small percentage of pairs (Formula 58—Critical values of the inversion index and/or weight as a condition for the stability of the combination):

$$( \begin{matrix}I > {I}_{max} \\ ( 1 - \frac{w}{{w}_{max}} ) * 100 \% \leq X \%\end{matrix} )$$

However, measuring the inversion index alone may not be enough if the frequency of occurrence of specific two objects, for example, is significantly lower than the average frequency of occurrence of objects in the Memory of Sequences. Therefore, it may be useful, in addition to the inversion, to measure the largest of the two co-occurrence weights (forward or reverse) and compare it with the average occurrence for the entire matrix or for stable combinations of objects.

Thus, to highlight a stable combination of objects and assign it an object identifier, one should at least compare the values of the inversion index of a particular pair of objects (the ratio of the weights of the forward and reverse occurrence of objects) with the average value of the inversion index for other pairs of objects in the matrix. If the inversion index of a particular pair of objects falls into the X % with the highest inversion index, then a decision is made that the pair of these specific objects is a stable combination in the direction determined by the highest weight of the co-occurrence of these objects. A pair of objects is stored as a Pipe Generator, their sequence in a stable combination is set by the value of the attenuation function or the corresponding numbering function, and the function values are stored as the weights of the Counters at the intersection of the Pipe Generator with the bus of the corresponding object. Combining pairs of objects into stable combinations should reduce the number of objects that satisfy the conditions (Formula 58).

In the particular case of the of the PP implementation, each of the named Artificial Neurons of Occurrence (INV) is additionally equipped with an Inversion sensor with an activation function and memory for reading the weight of the co-occurrence of objects from Counters of opposite directions of co-occurrences of a particular INV, as well as for determining the ratio of weights of the co-occurrence of opposite directions, and before training the sensor Inversions of the activation function of the named sensor are assigned a threshold value, which is stored in memory, and when learning, at the inputs of at least two buses of the named Device, connected by one of the named INVs with the Inversion Sensor, teach signals are ordered using the attenuation function so that the measured difference of the named one of the signal characteristics corresponds to the value of the activation threshold of such INV, INV is activated and forces the Inversion sensor to read the value of the Counters in each of the opposite directions of occurrence and compare one value with another, and, if the ratio of the named values exceeds the threshold value, then the Inversion sensor is forced to send a signal to the named at least two buses, and the received signal is used as a signal for learning two Artificial Neurons of Occurrence (hereinafter “Sensors D”) installed at the intersection of each of the named, at least two buses and a bus of a stable combination, which is thus trained, and the named Sensors D store the values of the said attenuation function as the weight of the coincidence, which reflect the sequence of the combination objects.

### 7.6.2. Current Context of Stable Combination

It is clear that if the last word entered is the word “organization”, then this may be the beginning of a stable combination “the organization of the United Nations”, if the general context is international political and not criminal, for example. If the context is “criminal”, then the continuation could be “the organization of criminal associations”, and not “the organization of the united nations”. Therefore, multiple hypothesis objects should be checked against the current context of the sequence.

It can also be assumed that a particular stable combination can correspond to several contexts, and therefore, in the case of stable combinations, memorization of many contexts must be initiated by a stable combination—the Pipe Generator. In order to avoid the generation of an infinite number of Pipes for the same pair of objects, we recall that during matrix learning, the Output Cluster constantly activates Pipes, whose Clusters are subsets of the current Cluster. This should activate the bus of Pipe of the stable combination. Therefore, a new Pipe for a stable combination should only be created if the current Cluster has not led to the activation of the Pipe for that particular stable combination.

Another feature of the formation of stable combinations is that it is not known beforehand how many objects a stable combination contains. Therefore, the technique of creating a pipe of a stable combination allows you to lengthen a stable combination with a “new object” by recording a new pipe for an “extended” combination. The number of objects in each new Pipe can increase as long as the inversion rate of the occurrence of the Pipe of the next stable combination with a “new object” exceeds the threshold value.

This requirement will result in two Pipes being created for a combination of three objects—the first Pipe to combine the first and second objects, and the second Pipe to combine the first Pipe with the third object. This seems wasteful, but creates a mechanism to increase the length of stable combinations and add variability to them. An example of variability can be the occurrence of the combination “I am going” with the combinations “to the cinema” or “to the stadium”, while the first pipe can be created for the combination “I am going”, the second pipe for “I am going”+“to the cinema” and the Third pipe for “I go”+“to the stadium”.

Let's consider the structure of such a neuron in more detail.

### 7.6.3. Neuron of Combinations (INS)

At each level of the PP hierarchy, the weight of the co-occurrence of sequence objects reflects the measure of the causal relationship between objects, and the Neuron of Combinations allows us to identify stable cause-and-effect relationships in each of the levels of the Hierarchical PP. Thus, the search for cause-and-effect relationships is reduced to the analysis of the co-occurrence of objects at different levels of the hierarchy. When any sequence is entered into the PP, it creates the current Cluster of Pipes at the output of the matrix, and this Cluster activates the Clusters of Pipes, which are subsets of the current Pipe′ Cluster, and they, in turn, activate through the neurons-INIs activate the Generators of similar sequences, as well as buses of the next hierarchy level. All this should ultimately lead to the activation of all levels of the PP hierarchy and to the activation of the Pipe Generators in each level of the hierarchy. Neuron of Combinations (INS) should provide identification of active stable combinations.

The PP can be additionally equipped with Artificial Neurons of Combinations (INS), consisting of an Adder with an activation function and memory of the threshold value of the Adder activation function, the Adder of INS is connected to the outputs of the group of Sensors D and to outputs of a group of sensors C, the input of each of which is connected with the output of one of the buses of the named set of buses of the level M1, and the learning of the INS is produced if the learning signal is received from the two named Sensors D, and the received learning signal is transmitted to the Adder associated with Sensors D, and the Adder is forced to activate a group of sensors C, each of which measures and stores the value of the co-occurrence weight at the output of a named one of the buses from the set of M1 level buses, and also returns either “1” value (logical “true”) or the named measured co-occurrence value or both of these values to the Adder, which sums ones and stores the number of sensors C with nonzero values or sums up the weights and stores the sum of the weights of all sensors C, or sums up the “one” values and weights separately and stores both named values as the threshold value of the Adder activation function; and in the “playback” mode, each sensor from the group of sensors C measures the weight value and transmits either a unit or a weight value or both of these values to the Adder, and the totalizer adds up the named values and compares them with the threshold value of the Adder activation function and, if the sum exceeds the threshold value, then the adder sends a playback signal to the inputs of the named pair of sensors of group D, with the help of which the stored values of the attenuation function are retrieved from the memory and the “playback” signal is transmitted to the inputs of one of the pair of buses or to both buses of the named set of buses of the named Device.

### 7.6.3.1. The Neuron of Combinations' Learning

The learning mode is the matrix learning mode. Learning the bus of a stable combination occurs when the Attention Window of the input sequence is entered (FIG. 66), and the two latest Attention Window objects are checked for the presence of stable combinations. The bus for learning a new stable combination is selected either randomly or sequentially the next free bus is taken. A learning signal is sent to the selected bus of the stable combination busses in the object layer, and the stable combination′ bus switches to the mode of waiting for the learning signal from Sensor F at the intersection of the stable combination objects. In the figure, the weights of the forward and reverse occurrence of the named objects are connected by the F sensor and are shown by circles of different sizes.

When entering the Attention Window, the signals are received, among other things, on the buses of the two latest Attention Window objects and the inversion sensor F at the intersection of the named buses measures the value and direction of inversion at the intersection of the bus of the first and second combination objects and, if the combination stability conditions are met (Formula 58), then Sensor F transmits a learning signal to the buses of each of the objects, and they, in turn, transmit the learning signal to the active bus of a stable combination through the Neurons of Occurrence located at the intersection of the bus of a stable combination with the buses of objects of a stable combination, and the named neurons remember the weight of the joint occurrence for the bus of a stable combination and each of the combination objects.

After that, it remains to associate the bus of the stable combination with the context, namely, to connect the bus of the stable combination with a plurality of sensors of group A (FIG. 66 and FIG. 68), which connect the Combiner B of the bus of the stable combination with the buses of the Cluster of frequent objects of the context.

Thus:
1. Sequence Memory activates a bus of Pipe in the combination′ layer for learning.
2. When the conditions (Formula 58) are met, the Sensor F of Neuron of Occurrence at the intersection of the buses of combination objects activates the buses of objects for training and sends an activation signal of the bus of the stable combination to the INV neurons at the intersection of the active bus of the stable combination and each of the buses of the objects of the stable combination, and each INV remembers the weight of the co-occurrence of the buses of the objects with the combination′ bus. In this case, the occurrence value can be either zero or one, since the bus of the stable combination is dedicated to these combination objects.
3. Through the INV neurons, the signal of the Sensor F enters the adder B and the group of sensors A to the outputs of the Sequence Memory matrix of the M1 level and to one of the M2 inputs of the combination pipes layer.
4. The adder B memorizes either the number of all sensors A, which is equal to the number of frequent objects in the current Cluster at the output of the matrix M1 or the total weight of all frequent objects of the named Cluster, or both
5. Each of sensors A remembers the current weight value of the frequent object in the Attention Window Cluster at the output of the matrix M1
6. Sensors of group D memorize OR the latest object of the combination OR a pair of objects of a stable combination as a Pipe Generator by placing the values of the attenuation function for each of the objects in the sensors of group D at the intersection of the pipe bus and objects of the combination, and for a later object the value of the attenuation function is greater (less reduces the signal strength of the object at the input of the matrix).
7. The bus of stable combination in the M2 layer creates links “each with each” with other combinations, namely with the previous combination and the next combination in the sequence of combinations. Layer M2 can be:
   a. or a layer of objects, and then there is no connection with the level M2, and the bus of combinations has connections “each with each” in the layer of objects;
   b. or a layer of Pipes, and then the bus of combinations can have “each-to-everyone” links with the buses of the contextual Pipes and with the buses of combinations.

A bus of a stable combination can have intersections both with all buses of layer M1 (layer of objects), because the combination is often a new object, and with all buses of layer M2 (layer of combinations or pipes), which is a layer of stable combination. The presence of an intersection with all buses of the M1 layer also allows to increase the length of the stable combination by adding to it new objects with which the bus of the stable combination forms stable combinations.

The signal arriving at the input of the stable combination's bus of the M2 matrix creates a memory of sequences with the previous stable combination or Pipe, which appeared in the input sequence, and the buses of the stable combination sequence form the Attention Windows of the M2 matrix.

### 7.6.3.2. Neuron of Combination′ Operation

In the playback mode, each of the sensors A of the adder B of the neuron of combination monitors the weight of the corresponding frequent object in the Cluster at the output of the matrix M1 and, if the weight of the frequent object corresponds to the activation weight, then, as in the case of INI, the sensor A of the neuron of combination:
1. or sends a value “one” signal to the adder (logical “true”)
2. or sends the weight of the frequent object in the Cluster to the adder
Adder B:
1. or sums up “ones” from sensors of group A and activates a neuron if the sum of ‘ones’ is equal to the number of frequent objects of the Cluster, on which the Neuron of Combinations was taught
2. or sums up the weights of frequent objects received from sensors A and the activation function activates the neuron of combination if the sum of the weights of the frequent objects exceeds the sum on which the neuron of combination was trained.
3. Or simultaneously counts the number of objects according to item 1 and the sum of weights according to item 2 and activates the neuron if both conditions are met

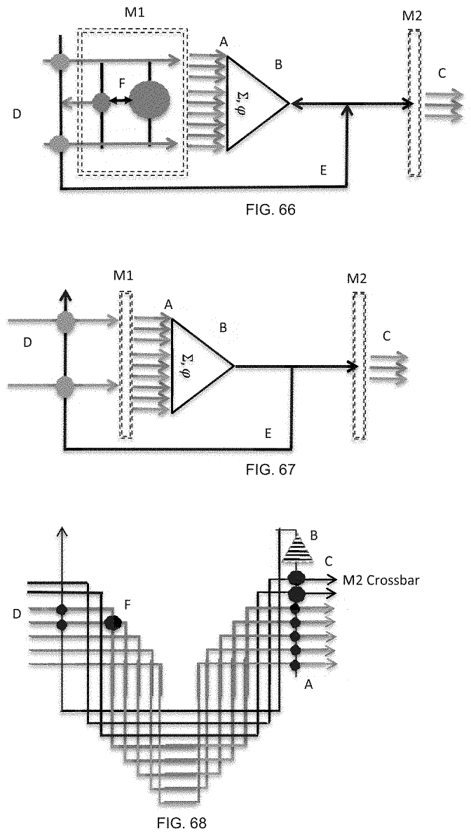

When activated, the adder B sends a feedback signal to the sensor of group D of the later object of a stable combination or to sensors D of both objects of the combination and activates the bus of the later or a pair of objects of the combination (Pipe Generator), which leads to a signal being sent to the bus of the later or a pair of objects to the input of the matrix M1 as a “hint”. “Hints” should be used to replace a pair of object buses with one combination bus when entering the next Attention Window, since if such a replacement is not done, then entering the Attention Window consisting of the original combination objects will not allow increasing the number of objects in the Combination Pipe and, as a result, will not allow increasing length of stable combination. Feedback can also send a signal to sensors D of a pair of objects of a stable combination, taking into account the values of the attenuation function, on which the Neuron of Combinations was trained; this leads to the input of signals to the buses of both objects of a stable combination. In the first case, the Pipe Generator of a stable combination will be the later object of the combination, and in the second case, both objects will be the Pipe Generator, and their order will be determined by the attenuation function (FIG. 67).

Thus, when at the output of the M1 matrix occurs the Cluster on which the Combination Neuron was trained, such a neuron is activated and sends a “hint” to the input of the M1 matrix—the Pipe Generator as “memories” of a stable combination of two objects, and also activates the sequence memory of stable combinations corresponding to the original sequence in the matrix M2 of stable combinations.

### 7.7. Pipe' Layer

Layers of Pipes are located above the layer of stable combinations and also use the triangle architecture and INI neurons, which provide inter-level connectivity of the matrix of different sequence memory hierarchies (FIG. 69).

### 7.7.1. Subpipes—Subsets of Pipes

As the objects of the next sequence are entered and the Clusters of objects at the output are added to obtain the Pipes of the input sequence, the existing Pipes (hereinafter referred to as “Subpipes”) will be excited in the matrix, in the Clusters of which a specific set of frequent objects has a weight less than the current weight of these frequent objects at the output of matrix (Formula 57). Thus, Subpipes are “subsets” of the Pipe′ Cluster of the input sequence. This will activate the buses of the Pipes' layer, the identifiers of which are subsets of the current Cluster at the matrix output. Accordingly, the Pipe's Cluster of the input sequence in the Pipes layer will also have the Subpipe bus signals previously created by the matrix. This will show the Pipes in the Pipe and activate the Counters at the bus intersections of the Sequence memory tubes layer at the intersections of the Pipes bus with the Subtubes buses. This provides a contextual connection between the same meanings (contexts) of different sequences, and also creates a hierarchy of meanings as the PP is filled from the object layer to the Pipes layer, then to the Type-1 Pipes layer, and so on along the PP hierarchy.

Physically, the contextual connection between the Pipes will appear at the nodes of the matrix at the intersection of the input of the newly created Pipe of the input sequence and the previously created Pipes. The mechanism for creating links in nodes has already been described earlier and therefore we will not dwell on this here. It should, nevertheless, be noted that applying a signal to any of the Pipe′ layer inputs will generate a Cluster at the output of the Pipes layer of the matrix, containing the identifiers of the Pipes as frequent objects. Such a Cluster is a set of contexts represented by objects of frequent Pipes-subsets of the Pipe of such a Cluster.

### 7.7.2. Type-k Pipe Layer.

FIG. 69 illustrates the addition of inputs of one matrix layer of Pipes (Type 1 Pipes Layer) to the matrix. We will call successive layers of Pipes Pipes of the 1st, 2nd, 3rd and so on of the kth kind or a layer type-1, type-2 etc. Neighboring layers of the Pipes are matrices of successive levels and are connected by INI neurons. The layer of pipes of the kth kind, like all other layers of the matrix, are fully connected and operate in the same way in the learning mode and in the playback mode: in the learning mode, the counters in the matrix nodes store and incrementally increase the weight of the mutual occurrence of the pipes at the intersection of the buses of which the counter is located; in playback mode, upon activation of any input of the Pipes layer of matrix, it generates a Cluster of frequent objects of this Pipes layer and excites the Subtube Clusters of the next higher hierarchy level at the output of this matrix layer. Sensors located in the current layer of Pipes and belonging to neurons (NIs) of the next hierarchy level will be trained and activated as described earlier [7.3].

As shown, the Object Layer followed by the K-th Pipe Layer works in a similar way, providing a convolution of the sequence of objects generated by the previous layer. Therefore, the presented matrix architecture has the ability to scale both vertically with an increase in Layers and horizontal with an increase in the number of rank blocks. This means that the need to expand the matrix can only face technical constraints. At the same time, it seems that, like the cerebral cortex, the matrix architecture represented may be sufficient and with several layers.

### 7.7.3. Pipe Sequence Memory

Pipes are represented as Sequence Memory objects only in the corresponding Pipes' layers. Therefore, for the Pipe of the 1st kind, its Cluster (hereinafter Cluster M1—Cluster of objects of the lower level of the hierarchy), generally speaking, does not contain frequent objects with which the Pipe as a key object of the M2 layer occurs in the Memory of Sequences of the Layer of Pipes (the layer of the upper level of the hierarchy). Such a Cluster M1 is just a context by which the Pipe can be recognized at the output of the Objects' Layer (the Layer of the lower hierarchy M1). Nevertheless, the Pipe is the key object of the Memory of the Sequences of the Layer M2 and there its Cluster is the Cluster M2—the Cluster of the upper level of the hierarchy, the frequent objects of which are other Pipes of the Layer of Pipes (M2). Since each frequent object of Cluster M2 (each frequent Pipe included in Cluster M2) corresponds to Cluster M1, the set of frequent objects of Cluster M2 can be rewritten as a set of frequent Clusters M1 with their frequent objects M1. The linear composition of the named frequent M1 Clusters must be identical to the Cluster M1, which we assigned to the key Pipe as a context in Layer M1. That is, the construction of the Back Projection of the M1 Clusters for each of the Pipes, which are frequent objects of the M2 Cluster (future or past), as a result should give us the M1 Cluster of the key Pipe, for which the M2 Cluster of frequent Pipes was built.

Thus, the hierarchical Memory of Sequences has recurrent cyclic links between the levels of the hierarchy and represents a single whole.

### 7.7.4. Pipe Generators

### 7.7.4.1. Constant Length Attention Window

As noted above [5.2.3], you should choose the maximum length of the Attention Window, determined by the technical limitations of the matrix, for example, the number of microcircuit pins or other limitations. It is desirable that such a limit exceed the average length of the segment (“continuous” segment) between adjacent interrupts [2.2.8]. For example, the average length of a sentence in Russian is 10 words, so the length of the segments between interruptions (punctuation marks) will, on average, be equal to 10 objects of the Russian language, and the “maximum” length of the Attention Window of several dozen objects may serve as a technical limitation. In some cases, the length of “continuous” segments and segments with constant context may exceed the maximum length of the Attention Window. To enter the Pipe Generator of such a “long” sequence, it will be necessary to enter many successive Windows of Attention, maximum length, into memory. Therefore, we will further consider this particular case as the most general one, and all the rest will be special cases of this general one. Consider sequential input of constant-length Attention Windows.

The purpose of spawning Pipes is the semantic compression of the original sequence of objects [4.2.1] and extraction from the Memory of the Pipe Generator. The Pipe Formula (Formula 39) does not take into account the length of the Pipe Generator, and if the Pipe Generator is longer than the Attention Window, then the function of numbering objects in the Attention Window, which is the opposite of the attenuation function (Formula 10 and Formula 11), should be extended to the entire length of the Pipe Generator.

At each step of entering a sequence of Pipe Generator objects, the Attention Window objects queue is shifted by one object into the Future inside the Pipe Generator, while the earliest object is removed from the Attention Window queue and the latest queue object is added. This leads to the fact that the weights of the “earliest” objects dropped out of the queue will have the same weight—the smallest for the Attention Window, and the numbering function must be applied to these identical weights. For this, any numbering function can be used, for example, the one that was used to number the Attention Window objects. Another solution may be to abandon the numbering of objects that have dropped out of the Attention Window, however, it is preferable to apply the numbering function (inverse of the weight function) to all objects of the Pipe Generator. We will assume further that the weights of all the objects of the Pipe Generator are determined, and the ranking of the weights is a function of the numbering of the Generator objects.

### 7.7.4.2. Dynamic Attention Window

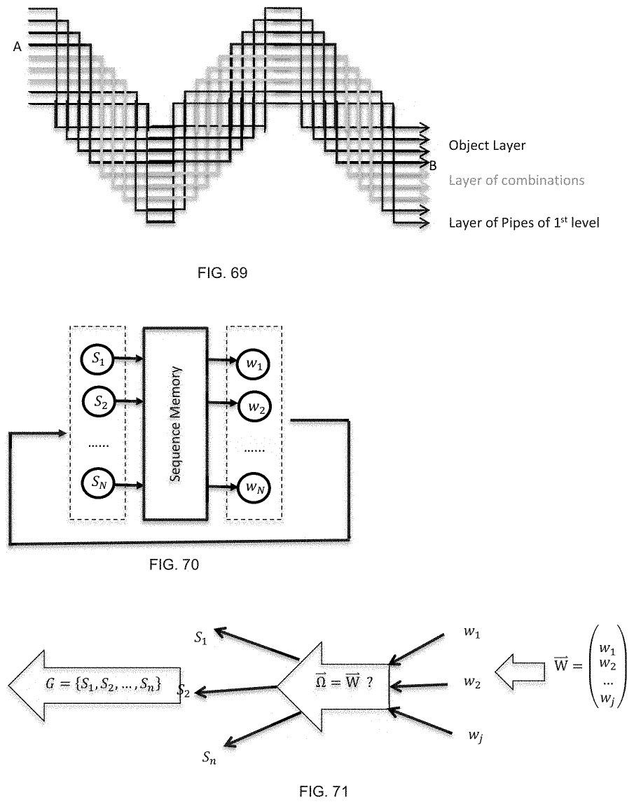

The dynamic Attention Window has been illustrated with an example of apples [4.2.7]. An important advantage of the dynamic Attention Window is that only one object can be fed into the system at each step, which eliminates the limitations of entering the Attention Window of a large size. However, the implementation of a dynamic Attention Window requires a block, which in the example [4.2.7] was called “Restorer”, which could restore objects by their Clusters, providing a recurrent link with previous input. To implement the recurrent mechanism, the bus of objects must be duplicated with a new layer of buses of the recurrent—feedback. With this in mind, the Sequence Memory Functional Diagram (FIG. 32) should be supplemented with a recurrent link, which is part of the Pipes concept (FIG. 70).

It is easy to see that the architecture of the Pipe as a recurrent connection is similar to the architecture of the “triangle” (FIG. 38), considered earlier [7.1.1].

The properties of the “Restorer” are possessed by the sensors of group A of artificial neurons of the hierarchy described above. The described technique of teaching and reading the Pipes can be used for teaching and reading individual objects with the only difference that the Generator will not serve as a set of Objects of the Attention Window, but one object that generated the Cluster. Stable combinations of objects can be memorized in the same way. The use of artificial neurons of Pipes to create a recurrent connection for buses of objects allows creating a mechanism for searching for synonyms, the Clusters of which are identical with some error. In this case, the Cluster Generator can be a set of synonyms, and the back projection of such a Cluster allows you to define such a set of synonyms.

### 7.7.5. Using an Unnormalized Cluster of Pipe

Since we expect to find Subpipe′ Clusters at the output of the matrix, the normalization of the entire output Pipe Cluster, its comparison with individual normalized Subpipe Clusters, which are a subset of the Pipe Cluster, may not give the desired result—it can be difficult to detect Subpipes in this way. This can make it difficult to use the normalized representation of the Pipe for the purpose of using the Pipe as a semantic feedback.

Another limitation when reading the Cluster may be the use of the function of attenuating the signals of Attention Window objects at the matrix input. The use of the weakening function when memorizing the co-occurrence of objects in the input sequence was dictated by the use of a rank matrix instead of a matrix consisting of a single triangle [7.1.1]. However, the strength of the input signal is not used when generating the Cluster, since the Cluster takes into account only the weights of the objects that fall into it, and not the signal strength on their buses. In addition, if the signal strength were taken into account when reading the Cluster at the matrix output, then the application of the weighting function to the input signals of the Attention Window objects could lead to the inclusion of the most recent Attention Window object in the Cluster of predominantly frequent objects, since the value of the attenuation function for it is equal to one and its signal is not attenuated at all and the stronger the attenuation function, the stronger the influence of the Cluster of the latest Attention Window object in the output Cluster of the matrix. If a sufficiently strong attenuation function is used, this could lead to the practical identity of the Cluster of the latest AW object and the output AW Cluster at the matrix output.

For the reasons stated above, in the Cluster read mode, object signals can be fed to the input buses of the matrix taking into account the force weakening function (for the purposes of numbering the Generator objects) or the same strength, and also refuse to normalize the Cluster at the matrix output. This can simplify the architecture and design of the matrix, as well as reduce the complexity of its operation by eliminating the normalization of vectors to check the collinearity condition and the transition to equality of vectors. The equality [symbol] = [symbol] can, for example, mean equality of coordinates or (Formula 59)

ωᵢ−Δωᵢ≤wᵢ

where ωᵢ are the weights of the frequent objects of the previously stored Pipes, and wᵢ are the current weights of the frequent objects of the Cluster at the output from the matrix.

Thus, in the preferred design of the matrix in the Cluster readout mode, the signals of the Attention Window objects are fed to the matrix input with or without the attenuation function, and at the matrix output, when measuring the weight coefficients of frequent objects of the Cluster, the influence of the attenuation function is not taken into account and the weights are not normalized, but instead of comparing the normalized values of the weights of the resulting Cluster with the normalized weights previously created in the Pipes matrix, the values of the unnormalized weights of the Cluster frequent objects are compared with the weights of the Cluster frequent objects of the previously created Pipes or Subpipes. The equality of these weights (Formula 59) means the equality (collinearity) of the vectors of the obtained Cluster (its part) and the previously recorded Pipes (Subpipes) of the identical meaning (FIG. 71).

### 7.7.6. Reading the Pipe for the Attention Window

To read the Pipe, the signals of all Objects of the Attention Window {C₁, C₂, C₃, . . . , C_{R},} for which the Pipe is being built taking into account attenuation are sent to the matrix buses simultaneously or sequentially, or in series-parallel:

$$T = {\sum }_{i = 1}^{R} f ( i ) * {K}_{i}$$

where R is the size of the Attention Window for which the Pipe is built. Excluding attenuation ƒ (i)=1.

### 7.7.7. Reading of Sequence Context (Pipe)

As noted in section [4.2], the context of the sequence is the Pipe with the maximum value of the total weight of the frequent objects of the Pipe Cluster (Formula 39):

Tₘₐₓ=Contₘₐₓ(R)

### 7.7.7.1. Fixed Length Attention Window

The Pipes built on the Attention Windows with a constant size R can be compared. While entering the sequence, first the size of the length of Attention Window increases from one object to R objects, and when the size R objects is reached, the earliest object in the sequence is removed from the Attention Window queue with adding each new object in the sequence, as a result of which the AW is, as it were, shifted into the future along the sequence by one object. For each n-th Window of Attention, a Tₙ Pipe is constructed:

$${T}_{n} = {\sum }_{i = 1}^{R} f ( i ) * {K}_{i}$$

And the total weights of successive Pipes are compared in order to find the inflection point of the curve of the total weight W_{Σ,n} of the frequent objects of the Pipe Cluster Tₙ (Formula 3), in which the curve changes the trend from upward to downward and the value of T_max is taken equal to the value of the Pipe Tₙ at the found point inflection where W_{Σ,n}>W_{Σ(n+1)}

If the inequality is satisfied, then we take Tₘₐₓ=T_{N}.

The sequence of Attention Window objects that created the Tₘₐₓ Pipe is stored as the Pipe Generator.

### 7.7.7.2. Variable Length Attention Window

The size of the Attention Window increases indefinitely starting from one object in the sequence. The size of the Attention Window can be limited either by the appearance of a pause (the growth of the sum of the weights of the Pipes frequent objects has stopped) or by reaching the maximum weight of the Pipes frequent objects. For each n-th Window of Attention, a Tₙ Pipe is constructed:

$${T}_{n} = {\sum }_{i = 1}^{R} f ( i ) * {K}_{i}$$

and the total weights of successive Pipes are compared in order to find the inflection point of the curve of the total weight W_{Σ,n} of the frequent objects of the Pipes Cluster Tₙ (Formula 3), in which the curve changes the trend from upward to downward and the Tₘₐₓ value is taken equal to the value of the Pipe Tₙ at the found inflection point where W_{Σ,n}>W_{Σ,(n+1)}. If the inequality is satisfied, then we take Tₘₐₓ=T_{N}.

Obviously, comparing longer Pipes will give a smoother curve of the total weight of the frequent objects of the Pipe Cluster.

We memorize the Tₘₐₓ pipe in the sensor group A of the INI neuron, and remember the sequence of Attention Window objects that generated the Tₘₐₓ pipe in the sensor group D of the INI neuron as the Pipe Generator.

### 7.8. Multithreaded Sequence Memory

The sequences of events/objects received by different senses are events/objects of a different nature and must be represented by the memory of different sequences. This means that there are layers of objects of different nature in the matrix, which do not intersect with each other in the memory layer of sequences of objects, but are connected by Artificial Neurons of the Label (INM). INMs make it possible to synchronize in time and space sequences of objects of different nature, obtained through different channels of information acquisition. Synchronization in time and space allows us to detect the joint occurrence of events of different nature, for example, events that we hear and that we see. The INM should be similar to the INI, but any of the parallel (simultaneous) sequences should be capable to activate it, that is, the cars meowing sequence (the “Sound” Trumpet Generator) received by us through the hearing channel should be reproduced simultaneously with the input of the sequence of its visual images received through the channel vision (Generator “spotting” tube).

To do this, each of the memory layers of sequences of objects of different nature M1 must, for example, have its own group of sensors A and its own adder B, as well as its own group D of sensors of the Pipe Generator, and the outputs of all adders must be connected to the input of the same Pipe of layer M2 . . . . Thus, activation of the adder of any of the layers of objects of different nature of the M1 level will lead to a signal being sent to the Pipes bus and to all D groups of the Pipe Generator sensors. Moreover, the Pipe Generator, consisting of several Generators of objects of different nature, when activating the Pipe in the “playback” mode of only one of the groups A of sensors of different nature, must activate all Generators of different nature, and they must be introduced into the triangle at the same time, just as they would be introduced in reality, reproducing both the sound of meowing and the image of a cat, for example.

Another solution for synchronization can be a layer of Pipes of the first kind, in which Pipes from objects of different nature are mixed and have connections “each with each” in the layer of Pipes. This allows the Trumpet of the cat's visual images to be in the sequence of Trumpets next to the Trumpet of sound images of the cat's meowing, and the mutual occurrence of such Trumpets will have a high weight of joint occurrence, which in the presented concept of Memory of Sequences means a high degree of connection between the sound and visual images of the cat with each other. In this case, enough INI neurons and INM neurons may not be needed for this. At the same time, in this view, we arrive at stable combinations of Tubes and the need to use INS neurons of stable combinations in the layer of Tubes, which seems logical from the point of view of the need for the most homogeneous organization of all layers of the sequence memory hierarchy.

Measurement layers serve as layers of objects of a different nature, and therefore each measurement layer must have its own group of sensors A, D and its own adder B, and the M2 pipe bus can be common with objects of a different nature or separate, but having connections “each with each” in the Pipes layer. For the appearance of a Pipes for a dimension layer for specific points in time of a time dimension layer or for individual locations of a space dimension layer, it is necessary to create Pipes, and therefore a reason is needed that serves as a trigger for the creation of a time or space Pipe, similar to the maximum sum of the weights of the Pipe Caliber for the Pipes of context sequences in the object layer, which we considered using the example of text information. Since time and space in themselves do not carry a contextual load, it seems that the creation of a context pipe in any of the layers of objects of different nature should be considered as a trigger for the creation of a Pipe in the measurement layer. In this case, the Measurement Pipes will serve as a “label” of measurements for the Pipes of objects of a specific nature: the Pipe associated with the appearance of the cat's visual image will have a time stamp and the Pipe associated with the appearance of the cat's sound image will also have its own time stamp, perhaps the marks will coincide, but in the general case, they may differ somewhat, and a way of “rounding” marks is needed to compare them as simultaneous. Considering that the Measurement Pipe refers to a specific object of the Pipes layer—to the Pipe of objects of a specific nature, in this case it is better to use Artificial Neurons of Labels, which will bind the label of the measurement layer to the Pipe of the context of objects of a specific nature, and the Pipes will be activated either by introducing a label (or rounded marks) to the measurement layer or when the Pipe Caliber (context) appears at the output of the triangle plate of objects of a specific nature.

### 7.9. Synchronization Layer

### 7.9.1. Measurement and Calculus Systems Architecture

The IPP (hierarchical sequence memory), as a rule, is additionally equipped with the formation of a device for measuring the length of the mark (hereinafter—UIDM) with one or more successive groups of measuring buses (hereinafter referred to as the “measurement layer”), and for each group a number system is selected and equipped with the number of buses corresponding to the selected number system—two buses for binary, three for ternary number system, and so on, and each of the buses is connected to a signal source; a signal is supplied to the bus if the value is one and the signal is not applied to the bus if the value is zero; then the direction of increasing the digit capacity of the groups from the groups of lower digit capacity to the groups of higher digit capacity of measurements is determined and each bus of one group of digit capacity is assigned the same measure of length so that in adjacent groups of digit capacity the measure of the length of one bus of the group of higher digit capacity is equal to the sum of the length measures of all buses of the smaller group of digit capacity and to measure the length, the output of each bus is connected to the input of Sensor A1, and the output of each Sensor A1 is connected to the input of the mark length calculator, at the first stage of execution, the calculator calculates the “group length”, for this, the buses with the switched on signal in each digit capacity group are added and the sum is multiplied by the product of numbers, each of which is the number of all buses in each of the digit capacity groups with a lower digit capacity, or “one” if there is no group with a lower digit capacity, and at the second step, the mark length processor sums up all group lengths, and the resulting sum is used as the measured mark length

In UIDM, in order to generate signals by the named signal source, the length is represented by a sequence of one or more successive groups of values, each of the values can be either zero or one; a number system is selected for each group and the number of named values corresponding to the number system is placed in the group—two digits for the binary, three for the ternary number system, and so on, for the sequence of groups, the direction of increasing the digit capacity of the groups from the groups of lower digit capacity to the groups with the larger digit capacity of measurements is determined, and with an increase in the measured value per unit of the corresponding digit, the value of such digit is selected equal to zero and set a value equal to one, and if there is no value of such a digit equal to zero, then all values of such a digit capacity, except one value, are equated to zero, and also find in the group of higher digit capacity a value equal to zero and equate this value to one; when the measured value decreases by one unit of the corresponding digit capacity, choose the value of such a digit capacity equal to one and the value is set equal to zero, and if the value of such a digit capacity is not equal to one, then all values of such a digit capacity, except one, are equated to one, and also find in the group of higher digit capacity a value equal to one and equate this value to zero; the group length is determined, for that the values of the corresponding group are summed up and the sum is multiplied by the number of all values in the adjacent group of lower digit capacity or by one if there is no group of lower digit capacity; and then all group lengths are added and the sum of group lengths is used as the measured mark length.

### 7.9.1.1. Measurement and Rounding Method

### Absolute Measurements

Let's consider an example of the architecture of the Sequence Memory synchronization layer. Suppose the layer consists of nine “frequency buses”—the first three of a first digit capacity (1,2,3), then three of a second digit capacity (4.5.6) and the last three of a third digit capacity (7,8.9), as well as a 1 Hz frequency generator. Consider the full cycle of operation of frequency buses:
1. Buses of the first digit capacity. Buses 1, 2, 3 are switched on and off sequentially at a frequency of 1 Hz (every second) in numerical order, and switched off at the end of a 3-second cycle. Accordingly, bus 1 remains on for 3 seconds, bus 2 remains on for 2 seconds and bus 3 remains on for 1 second. Then the cycle of switching on the buses is repeated again. Thus, the switching on of buses 1,2,3 can be represented as an infinite series of 1,2,3, 1,2,3, 1,2,3, 1,2,3, 1,2,3, 1,2,3, 1,2,3 . . . in which each digit means the inclusion of the bus with the corresponding number.
2. Buses of the second digit capacity. Each of the buses 4,5,6 turns on after the next full cycle of switching on buses 1,2,3, and remains on until the end of the cycle of the 9 second cycle. Accordingly, bus 4 remains on for 9 seconds, bus 5 remains on for 6 seconds and bus 6 remains on for 3 seconds. The cycle of turning on the buses is then restarted again. That is, buses 4,5,6 are switched on sequentially with a frequency of 0.33 Hz (every three seconds) in the order of numbering and every 9 seconds the bus cycle is repeated. Thus, the turning on the buses 4,5,6 can be represented as an infinite series of 4,5,6, 4,5,6, 4,5,6, 4,5,6, 4,5,6, 4,5,6, 4,5,6 . . . in which each digit means the turning on of the bus with the corresponding number.
3. Buses of the third digit capacity. Each of the buses 7,8,9 is switched on after a full cycle of switching on buses 4,5,6. That is, buses 7,8,9 are switched on sequentially with a frequency of 0.111 Hz (every nine seconds) in the order of numbering. And if there are no buses of a higher digit capacity in the matrix, then after a 27-second cycle of switching on the buses, the process of switching on the matrix buses either stops or starts again from point 1.
   Let's demonstrate the correspondence between the switching on of the buses and the time in the form of a table (Table 1):

TABLE 1

| | | | | | | | | | | | | | | | | | | | | |
|---|---|---|---|---|---|---|---|---|---|---|---|---|---|---|---|---|---|---|---|---|
| 1st level | 1 | 2 | 3 | 1 | 2 | 3 | 1 | 2 | 3 | 1 | 2 | 3 | 1 | 2 | 3 | 1 | 2 | 3 | 1 | 2 |
| buses | | | | | | | | | | | | | | | | | | | | |
| 2nd level | | | | 4 | | | 5 | | | 6 | | | 4 | | | 5 | | | 6 | |
| buses | | | | | | | | | | | | | | | | | | | | |
| 3rd digit | | | | | | | | | | 7 | | | | | | | | | 8 | |
| capacity | | | | | | | | | | | | | | | | | | | | |
| buses | | | | | | | | | | | | | | | | | | | | |
| Seconds | 1 | 2 | 3 | 4 | 5 | 6 | 7 | 8 | 9 | 10 | 11 | 12 | 13 | 14 | 15 | 16 | 17 | 18 | 19 | 20 |

As digit capacity can be seen from the table, the signals of two buses 1 and 2 correspond to 2 seconds (hereinafter we will simply indicate the highest of the discharge buses, in this case, bus 2), and for example, 17 seconds corresponds to a set of signals (hereinafter “mark” of measurement) of buses: 2.5, 7. In the example, we used a ternary numbering system, but could use binary or decimal, or any other.

It is important to note that each of the frequency buses 4,5,6 is, as it were, a Pipe, the duration of which can be expressed by the same set of buses 1,2,3. And each of the buses 7,8,9 is a Pipe for the same set of buses 4,5,6. Etc. Thus, the end of the lower digit capacity cycle should turn on a new higher digit capacity bus. The mechanism for creating Pipes allows creation of a layer of “measurable quantities”, and this entire layer and its parts can be configured to any number system—binary, ternary, quaternary, and so on . . . . For a binary system, each pipe of the next layer must be built over two buses of the previous level, for ternary over three, for quaternary over four, and so on . . . .

As you can see, in this example, we essentially named the full size of the lower layer—the duration (if it is time) or length (if it is a distance) or angular size (if it is angular degrees), etc.

Obviously, the total number of switched on frequency buses, multiplied by the frequency of their activation, corresponds to the total time in seconds that it took to turn on these buses. For example, the simultaneous switching on of buses determined by the formula 2,5,7 corresponds to the turning on of buses (1,2), (4,5), (7) and time (Formula 60 Example of calculating the difference of measurement marks):

(2*1 sec)+(2*3 sec)+(1*9 sec)=17 sec

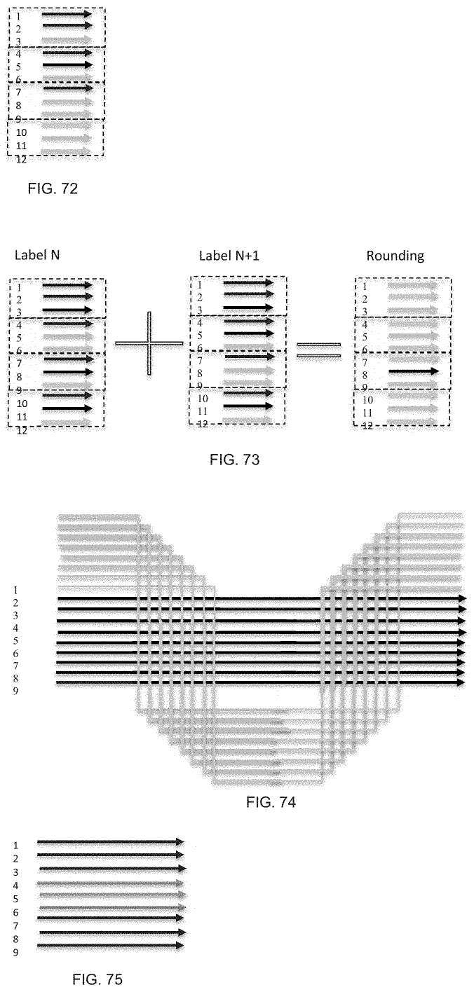

The turning on of buses (1,2), (4,5), (7) can be depicted as shown below (FIG. 72).

### Measuring Pipe Length.

Let's assume that for the measurement layer the Caliber of the measurement layer is the difference between two consecutive measurements.

Suppose (Table 1) for two consecutive measurements we have two measurement marks {3,5,7,11} which corresponds to the time (3*1+2*3+1*9+3*27)=99 sec and {3,4, 8,11} which corresponds to the time (3*1+1*3+2*9+3*27)=105 sec. We define the difference in marks as the difference in the number of buses of the corresponding digit capacity and so the difference between the marks is:

{3,4,8,11}−{3,5,7,11}={0,−1,+1,0},

which corresponds to time (0*1−1*3+1*9+0*27)=6 sec.

Thus, subtracting the previous one from the last label, we can calculate the duration between successive events, for example, between the events of the beginning and the end of learning the Pipe of the context, which we will also call the “Length of the Pipe” of the context.

In the above example, we used a record in which the bus numbers were written in ascending order, which corresponds to a record in which the larger digits are written to the right and the smaller ones to the left. This is not consistent with the writing numbers where the most significant digits are on the left. Following the traditional notation of the digit capacity of numbers reducing from left to right, then the formula (Formula 60) can be rewritten as follows:

{11,8,4,3}−{11,7,5,3}={0,+1,−1,0},

that still corresponds to the time interval (0*27+1*9−1*3+0*1)=6 sec.

### Rounding Measurements

The calculation of the pipe length can be carried out with the Start mark and the End mark, however, a specific Sensor A1 can operate only with the value of one bus, and if one sets the task of determining the length at the level of group of the A1 sensors, one can use the length rounding method.

The result that we got above (Formula 60) has the disadvantage that it has to simultaneously operate with both positive and negative values, and the presented architecture operates only with positive ones (there is a signal or not). To calculate the Length, you can use digital processing, or you can expand the architecture by adding negative ones, but then there will be twice as many buses. If we do not want to increase the number of buses nor use digital processing, then we can use the rounding technique. For this, for example, you can exclude negative values and consider them to be zero (no signal).

In the previous example (Formula 60) we got {0,−1,1,0} and after rounding we get {0,0,1,0}, which corresponds to a rounded difference of 9 sec instead of an exact difference of 6 sec. The proposed technique is based on the fact that the first negative difference (in the direction from high to low digits) occurs precisely in the bit that defines the most significant bit of the rounding error and therefore should be rounded off. Rounding is in the same order of magnitude as accurate measurement. This is quite reminiscent of the property of human memory. At the same time, we have rounded off the size (length or duration) of the Pipe, but below we describe how to find the Pipe by the exact timestamp.

Rounding in the matrix can be illustrated by the following figure (FIG. 73).

The logical rounding operation is recorded in Table 2 below.

TABLE 2
Logical operation of rounding two
measurements on one bus

| | Second value | First | Rounding |
|---|---|---|---|
| Type | (N + 1) | value N | result |
| 1 | 1 | 1 | 0 |
| 2 | 0 | 0 | 0 |
| 3 | 0 | 1 | 0 |
| 4 | 1 | 0 | 1 |

However, the rounding logic used for the learning mode (Table 2) was based on the assumption that the start mark N is always less than the end mark N+1. This assumption may not be true for measurement systems other than time, which only moves forward. For example, when measuring the distance from point to point, it can either increase or decrease, although the distance traveled can only increase. The same can be said about the turns, while the turns in opposite directions correspond to angular values with opposite signs, the sum of all the angles of the turns always increases. If you use the scale of the distance traveled, then the logic (Table 2) can still be used. In other cases, you should change the rounding logic of the sensor C. In addition, the assumption that the start mark N is always less than the end mark N+1 is not valid in any search by mark, because the search mark can be either less or more than the mark of a specific event (Pipes).

While the Totalizer sees the entire mark, each of the A1 sensors operates only with the value of one of the frequency buses and cannot know which of the marks is greater. Therefore, you can use the rounding logic (Table 3), bearing in mind that such logic potentially has twice the rounding error, which, when searching, should lead to noise—giving out a significantly larger number of memories corresponding to the search mark, which means that an additional filter may be needed.

TABLE 3
Logical operation of rounding two measurements
on one bus with double error

| Type | First value | Second value | Rounding result |
|---|---|---|---|
| 1 | 1 | 1 | 0 |
| 2 | 0 | 0 | 0 |
| 3 | 0 | 1 | 1 |
| 4 | 1 | 0 | 1 |

The proposed logic (Table 3) is neutral to the order of entry of values and neutral to which of the values is greater and which is less.

A person familiar with the prior art may suggest a different rounding logic without going beyond the prior art defined by the present work.

### Measurement Comparison

The length of identical events can only be approximately the same. In particular, when measuring the length of the same event with different sensors (for example, ears and eyes), the length of the Pipe (event) may differ. Therefore, when searching, it is necessary to be able to compare the rounded values of the Pipe length and to be able to compare the Pipes with the beginning and ending in some neighborhood. You need a fuzzy search, which will allow you to find Pipes whose start mark lies within some measurement range. To do this, it is convenient to compare the exact or rounded length of the Pipe with the error of a given measurement.

Another search task is that, for example, if January 2000 is entered as the search mark (MP), then all Pipes with a start mark (MN) in January, the length of which is measured in seconds, minutes, hours, days and weeks with a full duration of no more than a month may correspond to such a request. In the given example, the error was specified by the least significant bit of the search mark—one month.

If a length of one kilometer is entered as a search mark, then any Pipe that is less than a kilometer in length can be considered as matching the request.

If we operate with the length of the Pipe rounded using logic (Table 2 or Table 3), then since this length is approximate, then its comparison will occur in wider limits than when comparing the exact length, simply because the accuracy with which the rounding was carried out is unknown.

In connection with the above, it seems necessary to introduce comparison rules that would allow solving the described search problems.

Definition 7

Two results of length rounding can be considered comparable, the values of which are:
1. or, for example, they are located in a group of buses of the same digit capacity MP≈MN.
2. Or, for example, they have nonzero values of adjacent digit capacities MP˜MN, namely MP≤MN or MP≥MN.
3. Or, if the compared rounding results differ in the number of values of the least significant digit, that is, the values of the lengths MP>MN.

Comparison examples for each of the cases (Definition 7):
1. In the first case, either the value {0,0,1,0} or {0,0,2,0} or {0,0,3,0} can be considered comparable to the value {0,0,1,0}.
2. In the second case, comparable with the value {0,0,1,0} can be considered either {0,0,1,1} or {0,0,0,1} or {0,1,1,0} or {0,1,0,0}, as well as, for example, {0,2,0,0} or {0,3,0,0} and so on.
3. In the third case, comparable to the value {0,0,1,0} can be considered either {1,1,0,0} or {1,2,0,0} or {3,3,0,0} and so Further.

### 7.9.1.2. Measurement Layers

The measurement layer consists of a layer of frequency buses and a layer of marks (FIG. 74)

### Frequency Buses

The frequency buses of the measurement layer do not have “each-to-each” connections.

Instead, the lowest digit capacity buses have a generator that alternately turns on the digit capacity buses from the first to the last (hereinafter “discharge cycle”) so that new active buses of the same digit capacity are added to the previously turned on buses (“active” buses). The busses of each digit capacity are switched on at regular intervals (hereinafter referred to as the “digit capacity step”), and turning off the previous one causes the next one to turn on until the last capacity bus is reached. The last bus of digit capacity N:
1. turns off all N-buses except the first and the N-bit cycle repeats from the beginning.
2. includes the next step of the N+1 digit capacity.

Thus, the digit capacity level N cycle is equal to one step of digit capacity level N+1, and the sum of steps of digit capacity level N is equal to the cycle of digit capacity level N.

### Measurement Buses

Since each measurement mark contains a set of active frequency buses, it is reasonable to use an additional “Marks layer” in Triangle to memorize the marks, which is a layer of Measurement Tubes above the frequency buses layer. The measurement mark bus in the Measurement Pipes' layer is one of the buses of the Type 1 Pipes layer (Pipes above the objects' layer) and therefore has “each-to-each” links with all Context Pipes, which allows you to associate a measurement mark with any of the Context Pipes or with several Pipes of context, if the Pipes mark match, for example, Pipes were formed in the same place in space or at the same time. The context pipe can also be associated with not one, but several marks, if, for example, the same context pipe appeared at different times or in different places. The mark layer is presented fully connected so that you can store a sequence of marks, which allows you to “rewind” time or a path traveled or another dimension.

### 7.9.2. Artificial Neuron of Measurement Marks (INM) Design and Operation

The IPP uses an Artificial Neuron of the Marks (INM) as the named calculator of the mark length, which, in addition to the named sensors A1, is equipped with a plurality of Sensors C, and each Sensor C is equipped with at least three connections, the INM, as well is equipped with the Totalizer B1 with activation function, memory and calculator, an input and an output; By the first connection, the Sensor C is connected to the output of the Totalizer B1, and by the Second connection, the Sensor C is connected to the output of the Totalizer of one of the plurality of INI of the named Device, and by the Third connection, the Sensor C is connected to the inputs of the set of Sensors D of the named INI; the input of the Totalizer B1 is connected to the outputs of a plurality of Sensors A1, the input of each of which is connected to one of the measuring buses of the named UIDM; INM is used in learning mode and in playback mode; in the learning mode, an activation signal is sent to the input of the Totalizer B1, which is then transmitted to the output of the Totalizer B1 and then to the First connections of the set of Sensors C, each of which goes into the waiting mode for the learning signal of the INI on its Second connection, and when the learning signal of the INI appears on the Second connection, then the Sensor C transmits the learning signal through the First connection of Sensor C to Totalizer B1 INM, and Sensor C itself is forced to establish a connection between the First connection and the Third connection of Sensor C for use in the “playback” mode, which allows transmitting the signal from the output of the Totalizer B1 to the inputs of many Sensors D in the playback mode; when the activation signal is applied to the input of the Totalizer B1, all A1 Sensors connected to the input of the Totalizer B1 are forced to measure the presence of a signal in the measuring bus, and then to transmit to the Totalizer B1 as the First value “zero” if there is no signal on the bus, or the value “one”, if there is a signal on the bus, and the Totalizer B1 uses the named First values received from all A1 Sensors to calculate the First mark length and places the First mark length in memory; after the arrival of the learning signal of the INI through the Sensor C to the Totalizer B1, the Totalizer B1 forces the Sensors A1 to re-measure the presence of a signal in the measuring bus, and then to transfer to the Totalizer B1 as the Second value “zero” if there is no signal on the bus, or the value “one”, If there is a signal on the bus, and the named Second values received from all A1 Sensors, the Totalizer B1 uses to calculate the Second mark length and places the Second mark length in the memory; Totalizer B1 retrieves from memory the First and Second mark lengths and calculates the difference between the First and Second mark lengths and stores it in memory as the value of the activation function of the Totalizer B1; in playback mode, Sensor A1 measures the presence of a signal in the measuring bus, and then transmits to the Totalizer B1 as the Third value “zero” if there is no signal on the bus, or the value “one” if there is a signal on the bus, and after receiving from all Sensors A1 of the Third values Totalizer B1 calculates the Third mark length, and then calculates the difference between the First mark length and the Third mark length and compares the result with the named value of the activation function of Totalizer B1 using a comparison algorithm, the result of which is “comparable” or “not comparable”, and if the Third and Fourth mark lengths are “comparable”, then the Totalizer B1 gives an activation signal to the output and the activation signal is transmitted through Sensor C to the named group of Sensors D of the INI neuron.

INM is designed to activate the INI Generator and the INM Generator when entering a measurement mark or Pipe length as a search request to the PP.

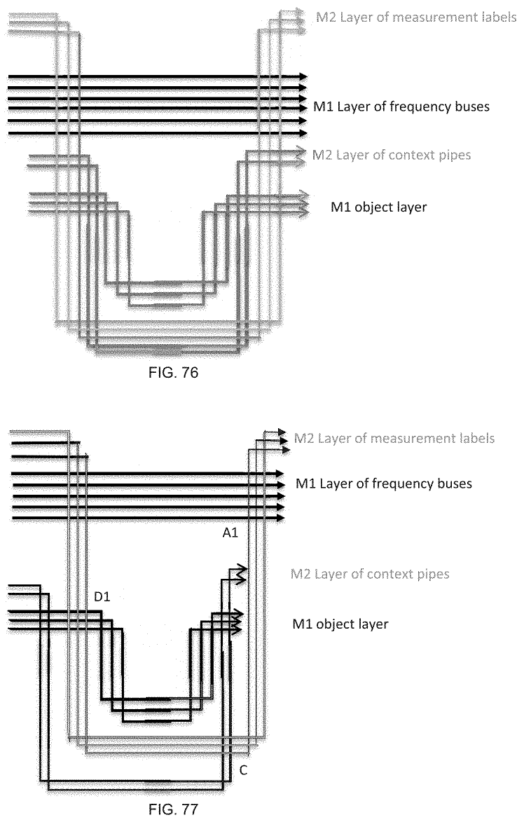

The architecture of the layers of the matrix containing the Layer of frequency buses M1, the Layer of objects M1, as well as the Layer of measurement marks M2 and Layer M2 of the context pipes corresponds to the architecture of other layers of the matrix (FIG. 76). However, not all matrix nodes are used for INM switching and therefore we will redraw the matrix to show those that are used (FIG. 77).

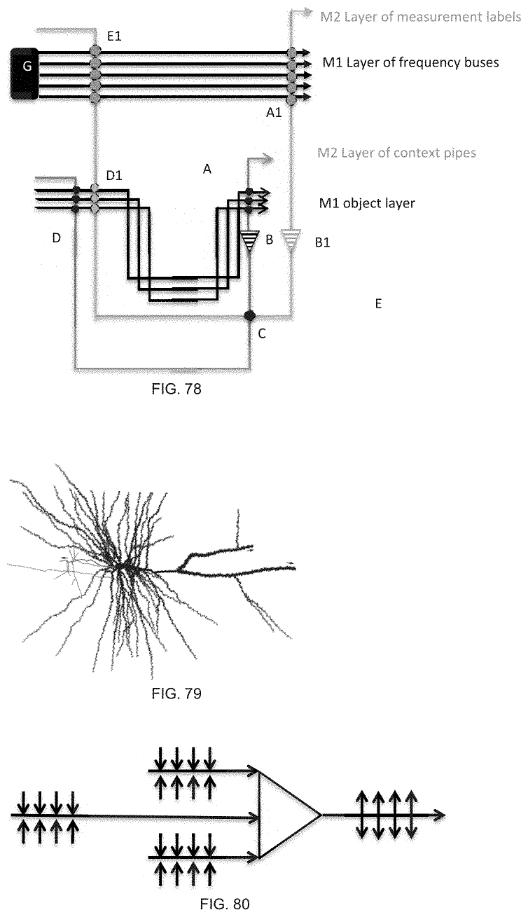

The “M2 measurement mark layer” is itself fully connected and can memorize sequences of measurement marks. It also forms the following groups of connections with other layers:
1. At least one group of connections “each to each” in “Layer M1 objects”. The group of connections is designated D1, (FIG. 77). However, an architecture with two connection groups E1 and D1 in the “object layer M1” is preferred.
2. Preferably, at least one group of connections “each to each” in the “Layer M2 of the Context Pipes”. The group of connections is designated C, (FIG. 77).
3. At least one triangle or crossbar matrix connections in the layer of frequency buses M1. The group of compounds is designated A1, (FIG. 77).
4. The next mark′ bus from the “Layer of measurement marks M2” (FIG. 77) is activated simultaneously with the bus of the Pipe “Layer M2 of the context pipes” connected by the INI neurons [7.3] with the “Layer M1 of objects”. Let us illustrate the operation of the measurement mark layer by the example of only two neurons INI and INM (FIG. 78).

### 7.9.3. INM Operation

### 7.9.3.1. Learning

The task of INM learning is to memorize the label—the moment of the beginning and the duration of the learning of the INI, as well as to create a connection between the created mark and the Generator of the INI.

On each of the Layer of frequency buses M1 Generator G cyclically sends bus activation signals as described above [7.7.1.1].

In learning mode, at least one INM bus and one INI bus are always active. Since the mark bus serves for fixing the time and duration of the learning of the INI, the activity of these two buses is synchronous—when a new bus of the INI is switched on for training (“start of learning”), the next free bus of the INM is turned on to memorize the mark for the INI, and with the end of INI learning (“End of learning”) its bus is switched off and turns off the INM bus, which must remember the mark for the INI and the duration of the creation of the Pipe for the INI.

### 7.9.3.2. 7.9.3.2. Playback (Search)

The purpose of the replay is to replay Generator of INI Context Pipe and Generator of INM mark in response to inputting a measurement label into the measurement layer. The entered label is a search query and, in fact, is a label in the rounding vicinity of the INM Generator. In the playback mode, a measurement mark is introduced into the PP, which activates the INM, and it, in turn, activates the INI Generator at the input to the matrix. The INM generator can also be activated via sensor C when the INI is activated.

### 7.9.3.3. A1 Group Sensors

Each of the A1 group sensors is installed at the intersection of one of the buses of the Layer of frequency buses (“frequency bus”) and one of the buses of the Layer of measurement marks M2 (“bus of Marks”). The A1 group sensor is a neuron of the IVK type and when a signal is applied to one of the buses of the Pipes layer (active Pipe), all neurons at the intersection of the active Pipe with the active buses of the measurement layer change the value of the co-occurrence weight from the initial value “did not meet” to the value “met”, for example, from zero to one. Thus, after activating the Pipes bus, all IVKs at the intersection of the Pipes bus with the buses of the measurement marks will receive a weight value of 1, and all others will either be locked or have a value of zero.

In the learning mode with accurate metering, the A1 Sensor can memorize and store or not memorize and not store the values of the start and end states. In the first case, the stored data is sent to the Totalizer B1 at its request or is used by Sensor A1 to calculate the exact or rounded length of the Pipe, and in the latter case, the Sensor A1 immediately sends to the Totalizer B1 the measured state of the frequency bus for the “Start Mark” and the state of the frequency bus at the moment of “End mark”.

In the “playback” mode, the A1 sensor is activated when a “search mark” is entered into the frequency bus layer as a search query. Namely, when entering some mark as a search query, the A1 sensor measures the state of the frequency bus and sends the value to the Totalizer B1.

7.9.3.4. Group D1 and E1 sensors

The sensors of the D1 group are completely analogous to the sensors of the D group of the INI neuron and remember the same Pipe Generator as the INI. Therefore, INM can use the group of its own sensors D1 to memorize the Pipe Generator or use the D sensor group of the INI's Pipe Generator. It seems preferable to use one group of D sensors, this will simplify the design and reduce the cost.

The sensors of the E1 group of the INM neuron are similar to the D sensors of the INI neuron and are designed to memorize and activate the INM Generator, however, unlike the D sensors, in the case of E1 sensors, there is no need to memorize the order of the measurement buses, since the attenuation function is not used in the measurement layer. Therefore, each of the E1 sensors can have only two states—open or closed. All E1 sensors of the INM Generator are switched to the “open” state.

### 7.9.3.5. Sensor C

In the learning mode, sensor C behaves like an INV neuron, which is installed at the intersection of the INM and INI buses and records the weight of the co-occurrence of INM and INI objects. However, a specific start mark can be assigned to the Context Pipe only once, and therefore, there should not be repeated INI learnings on the same INM mark. This allows sensor C to memorize only two states—there is a connection or there is no connection.

In the playback mode, the Sensor C must provide activation of the INI Generator and the INM Generator either upon activation of the INI or upon activation of the INM. Thus, both named Generators are activated either when a context Cluster appears at the output of matrix that is capable of activating the INI or if such a measurement label has been introduced that can activate the INM.

In the learning mode, the outputs of the Totalizer B1 (INM) and the Totalizer B (INI) can be activated simultaneously or in turn, first one and then the other. In the latter case, sensor C can serve as a bridge for transmitting the activation signal from the first bus to the second. With simultaneous activation of the INI and INM buses at the start of learning, sensor C must remember the connection between the INI and INM buses. Memorization by Sensor C of the connection between INI and INM can occur in response to the appearance of a difference in the characteristics of activation signals for INI and INM, or vice versa, in response to the absence of a difference in the characteristics of these signals.

In playback mode, the operation of sensor C should determine which group of sensors D or D1 will be used. To avoid re-activation of the Pipe Generator (sensor group D is a copy of group D1), it is preferable to operate sensor C in which, in playback mode, sensor C has two inputs and two outputs, wherein both and the output of the Totalizer B and the output of the Totalizer B1 can serve as sensor C input, and as the outputs—a bus leading to the sensors of the D group of the INI neuron and the bus leading to the sensors of the E1 group of the INM neuron. This avoids the activation of the same Generators D and D1, and also avoids the requirement for the microcircuit to use additional sensors of the D1 group, which will reduce the complexity of the architecture and the cost of the Memory of Sequences processors.

### 7.9.3.6. Totalizer B1

Having received from each of the A1 group Sensors the state of the frequency buses at the time of the Start Mark and the End Mark, the Adder B1 calculates the exact value of the Length Mark (the length of the Context Pipe) as the absolute value of the difference between the Start Mark and the End Mark, and also remembers at least the Mark Start or End Mark and Length Mark or all named marks [7.7.1.1].

In the “playback” mode, the Adder B1 receives from each of the A1 group Sensors the value of the frequency bus state corresponding to the “Search mark”, calculates the “Search length” as an absolute value of the difference between the “Search mark” and “Start mark” and compares the received value of the “Length search” with the saved “Pipe length” value. If the “Pipe length” is comparable (Definition 7) to the “Search length”, then the Totalizer B1 activation function activates the Totalizer B1 output and sends a signal to Sensor C, which activates the D sensor group of the Pipe Generator. It is clear that instead of the Start Mark when calculating the Search Length, you can also use the End Mark, which will result in a shift of the “match” by the Pipe Length to the future.

The adder B1 receives from each of the sensors A1 a value represented by zero or one, and calculates the exact value of the label in the units of the busses of the least digit capacity, and for this Adder B1 (Formula 61 Algorithm for calculating the length):
1. 1. sumulates the values obtained from all Sensors C installed on the frequency buses of the same digit capacity N
2. 2. each sum obtained is multiplied by the product of (N−1) factors, each of which is equal to the number of frequency buses in the adjacent least significant digit capacity (N−2), and the sum of the least significant digit capacity is multiplied by one or uses the sum of the least significant digit capacity as “product” for the next step
3. 3. sums up the products obtained at the previous step and the result obtained is the exact value of the mark in the units of the least significant digit capacity.

### EXAMPLE

Suppose that in the least significant digit capacity there are 10 buses, in the next 20, in the next 30 and in the most significant digit capacity—40. Suppose that in the most significant digit capacity there are signals in 4 buses, in the adjacent least significant—3, in the next 2 and in the least significant—1 bus, which corresponds to the record (the most significant digit capacities on the left and the least significant ones on the right):

1111,111,11,1

Then the length in units of the least significant digit capacity will be:

(1+1+1+1)*30*20*10+(1+1+1)*20*10+(1+1)*10+1=24 000+600+20+1=24 621

### 7.9.3.7. Memorizing Marks in the Pipe

To memorize a set of measuring buses with non-zero signal values (hereinafter referred to as the “Measurement Label”), on which the INM learned, the measuring buses in the IPP are equipped with sensors of the E1 group, and sensor C is equipped with a Fourth connection, which is connected with the named sensors of the E1 group; in the learning mode, the learning signal is fed to the First or Second connection of Sensor C, which transmits the learning signal to the Fourth connection and a group of E1 Sensors, each of which memorizes the weight of the co-occurrence with the corresponding bus of the measurement layer, if there is a measurement mark signal in the said measurement bus; in the playback mode after the triggering of the INI activation function or the INM activation function, sensor C receives an activation signal from one of the Totalizers and transmits an activation signal through the Fourth connection to a group of E1 sensors and, if the co-occurrence weight of the corresponding E1 sensor is greater than zero, the activation signal is transmitted through sensor E1 to the named bus as a signal of memory of the value of the measurement mark on which the INM was trained.

If necessary, a start mark or an end mark, or both, can be transmitted to the output of the measurement matrix and stored as values of frequent objects in the Pipe Caliber Cluster.

### 7.9.3.8. Conclusion

By comparing “Pipe Length” to “Search Length”, all context Pipes whose length is comparable (Definition 7) to the Length of specific context pipes will be “played” (activated or “recalled”).

Thus, the sequential appearance of Pipes of objects of different nature (for example, through the channel of sight and through the channel of hearing) will be accompanied by the appearance of a connection through the INV located at the intersection of the buses of these Pipes in the layer of Pipes M2, and each of the Pipes will have sequential measurement marks, for example, time stamps following one after another or location marks sequentially located along the route.

Obviously, the matrix of frequency buses M1 can also be adapted to enter the length of an event, for this you should either duplicate the frequency buses by means of inputting both start marks and length marks or to enter start marks and length marks different signals should be used, at least one of the characteristics of which allows A1 sensors to determine whether they are receiving a start mark signal or a length mark signal. Entering the start mark and the length mark into the matrix of frequency buses M1 would allow the Sequence Memory to recall events of a certain duration in time, tied to a certain point of the beginning of events. For example, to answer the question “What happened yesterday?”, Since the question has a duration—“day” as a morning-to-evening or as a midnight-to-midnight, as well as a start mark—“yesterday” or the beginning of yesterdays morning or the beginning of yesterdays day.

Synchronization of measurements (comparison of length) of events allows identifying simultaneous and parallel sequences and events [2.1.5]. For example, an image of a cat received through the channels of vision will be synchronized with the sounds of meowing received through the channels of hearing, since they are synchronous in time. In a similar way, these images can be synchronized in space, which is another layer of dimensions.

### 7.9.3.9. Alternative Solutions

An alternative can be a measurement synchronization architecture in which there are no frequency buses, and the total number of cycles of the frequency generator is recorded in the synchronization pipes. However, such a model would have the disadvantage that in the absence of a unique set of “event mark” buses, the search for the Context Pipe Generator would become impossible without the use of digital filters, which would be needed to find the Pipe containing the record of the required number of frequency generator cycles.

### 7.9.4. Other Measurement Features

Let's list other features of the Synchronization Layer implementation:
1. 1. Selecting a reference point
2. 2. Choice of direction relative to reference point + or −
3. 3. Synchronization of measurements with different reference points.

### 7.9.4.1. The Reference Point.

The countdown of a person's life begins at the moment of his birth, but this does not mean at all that the world did not exist before. Therefore, the choice of the reference point is important and may differ for different implementations. Moreover, if for the temperature scale we can adhere to the opinion of the existence of absolute zero −273 degrees Kelvin, then with respect to time it is difficult to choose a reference point with certainty, if only because the moment of the origin of the universe is not known for certain, and it is also unknown whether time existed before its occurrence.

### 7.9.4.2. Positive and Negative Scale

Returning to temperature, it should be borne in mind that in Celsius and Fahrenheit measurement systems, the reference point differs from Kelvinabi absolute zero and therefore it becomes necessary to have both a positive and a negative measurement scale, which can lead to an increase in the number of frequency buses required for counting and synchronization in both directions.

### 7.9.4.3. Synchronization of Measurements

When we try to touch a moving object with our hand, then to estimate the place where the hand and the object meet (to estimate the point of intersection of trajectories), our brain uses a model with two reference points in space—the position of the object and the position of the hand at the moment of the beginning of the approach. Thus, in most robotics applications it may be necessary to use multiple reference points, which means that the synchronization layer must contain a sufficient number of frequency buses and be expandable.

However, the choice of reference points is not enough, for synchronization it is necessary that sequence memory can make estimates and compare their values.

### 7.9.5. Time Synchronization

The presented measurement architecture makes it possible to represent any moment in time in the form of an event mark—a set of time synchronization buses (hereinafter also referred to as “timestamp”).

Time is an example of a mixed calculation system, since there are 60 seconds in a minute, 60 minutes in an hour, 24 hours in a day, up to 365 days in a year, and the number of years may be limited. The dimension synchronization layer architecture allows such a complex model to be implemented by placing the following layers:
60 buses with 1 Hz switching frequency
60 buses with a switching frequency of 1/60 Hz
24 buses with a switching frequency of

$$\frac{1}{( 60 * 24 )} Hz$$

365 buses with a switching frequency of

$$\frac{1}{( 60 * 24 * 365 )} Hz$$

Any number of tires with a switching frequency of 1 time per year

As an example of the application of the Length Calculation Algorithm (Formula 61), we calculate the total length of time of three years, which corresponds to the following number of frequency buses 111,0,0,0,0 and the length of the year in units of the least significant bit (second) will be equal to:

(1+1+1)*365*24*60*60+0*365+0*24+0*60+0*60=94 608 000 seconds

It is clear that to account for shorter periods of time before buses with a frequency of 10 Hz, others with a higher frequency can be placed, and to account for decades, centuries, millennia, and so on, buses can be placed with a switching frequency of every 10, 100, 1000 years, and so on, further up and down the sync bus architecture.

As it was repeatedly shown earlier, the Pipe (“Context Pipe”) corresponds to the context of the sequence and, if the identifiers of all active buses of the Synchronization Layer (hereinafter, the set of active time measurement buses, we will call the “timestamp”) are written into the Pipe Generator records at the time of the Pipe creation, then in the Context Pipe's Cluster it will be possible to find identifiers of “timestamp” buses and calculate from them the “absolute time” of the Pipe recording, counted from the start of switching on the Synchronization Layer, if the beginning of switching on the Synchronization Layer was selected as the starting point of time.

At the same time, it is desirable to compare fragments of sequences of similar duration, and for this it is necessary to calculate the duration of the input of the compared fragments, tied to the time of the beginning of their input. Thus, it is necessary to link not to the “absolute time” of the start of the Synchronization Layer, but to the “relative time” of the beginning of entering sequences or their fragments into the Sequence Memory. To do this, it is necessary to know the time of the Generator record of the previous Pipe, which can be found in the sequence memory using the back-forward communication between successive Pipes [5.2.1].

Thus, if the described Sequence Memory synchronization block is placed in the matrix, then storing in the Pipe Generator the identifiers of “timestamp” buses of the Synchronization Layer allows you to bind the Context Pipe to the absolute and relative time of the Sequence Memory synchronization Layer, and the presence of the Synchronization Pipe identifier in the Pipe Generator allows find the Pipe Context Generator not only by the Pipe Cluster, but also by the “timestamp” corresponding to the creation time of this Cluster.

In the considered example, switching the buses of the Synchronization layer allows you to measure the time with the required accuracy. The architecture allows you to start counting time from the moment the universe was created, or counting time back from the original time of the system. You can also take into account weeks, months, and any other periods.

Modern production of radio electronic components with a 10 nanometer norm allows 1000 buses to be placed on a silicon substrate with a width of only 10 micrometers.

### 7.9.6. Synchronization in Space.

When synchronizing space, the choice of the reference point is especially important and therefore frequency buses are needed for both the positive scale and the negative scale. People perceive themselves as a reference point for distance to objects, and apparently for robots, the reference point will also be themselves or the location of their sensors, such as video cameras or other devices that observe the world around them in visible or invisible for or eye or ear or . . . radiation or other manifestations As an absolute reference point for the robot, you can also select the point of its first activation or the point where the robot was produced, or the point where the robot works, and so on. For people, such a point can be, for example, a homeland.

However, for the completeness of the model, it is necessary to take into account the directions. As a model, you can take a geodetic model with two coordinates—latitude and longitude, or with two positions—left or right (however, people actually use angular values—“behind” meaning an angle of 180 degrees or “side” meaning an angle of 90 degrees and so on), as well as with the rise/fall in relation to the reference point—the “horizon”. Thus, three layers of space synchronization may be sufficient for robots.

### 7.10. Emotion and Ethics Layer

The layer of emotions and ethical norms is created in the form of a limited number of buses of the “Emotion layer” of the sequence memory. Each bus represents a discrete value of a particular emotion on a bad—good scale. Ethical norms can also be represented by Sequence Memory objects, and objects by triangle's buses and also corresponding to the “bad-good” scale. Corresponding values of emotions and ethical norms, as well as sequences of emotions and norms are assigned to events in the process of learning Memory of Sequences by activating the bus of the corresponding discrete value of emotion/ethical norm at the moment of input of the corresponding event. If the objects of emotion were objects of the Memory of a Sequence of objects, they would have weights of co-occurrence with other unique objects of the Memory of Sequences of objects and could be found in sequences as objects of sequences. However, the nature of emotions cannot simultaneously coincide with the nature of objects of different nature, in particular, the information that a person receives through the channels of hearing, touch and vision is information of a different nature, but what if we had a sense of a magnetic field? Probably, therefore, it should be concluded that, at least, emotions are not objects of the Memory of Sequences (layers) of objects.

At least one of the emotions or ethical norms in the API is encoded only by one of the named groups of measuring lines, and each bus of the named group of measurements (hereinafter referred to as the “emotion bus”) encodes a certain discrete value of the named one of the emotions or ethical norms.

Emotion buses in the IPP are connected “each to each” and at the intersections of each pair of emotion buses is installed INV.

In some versions of the IPP, more than one of the named groups of measuring lines are used as a group of measuring lines of a certain emotion or ethical norm, and discrete values of different digit capacity for the said emotion or ethical norm are encoded by the buses of the group of the corresponding digit capacity.

### 7.10.1. Reflex Emotions.

Reflex emotions serve as protection for our body. Having burned ourselves after touching the hot frying pan, we pull our hand away to the side opposite to the frying pan. Having hit our head on the pipe, we deflect our head to the side opposite to the pipe. If a stone is flying at us, then we will predict (imagine the flight sequence before hitting us) where it can get and recoil in a safe (opposite) direction. Thus, it can be assumed that reflexes generally have a reversible effect, leading the affected part of the body (or that may suffer) in the direction opposite to the outgoing danger. In a first approximation, this can be thought of as rewinding a sequence that led to a dangerous situation.

Positive reflex emotions tend to repeat the sequence from the beginning. For example, if we are hungry, then we eat, but we eat in portions, each of which is comparable to the capacity of the mouth. So the first portion is followed by the second, followed by the third, and so on, until the feeling of fullness stops this process of eating the next portion.

What is common in the presentation of negative and positive emotions is that the system seeks to return to a state with a maximum positive or minimum negative value of emotion, that is, the system tries to maximize the value of an emotional state. Thus, if negative emotions are presented with a negative scale of values—the stronger the negative emotion, the lower its negative value and the higher the absolute, and positive—the stronger the positive emotion, the higher its positive and absolute value, then in both cases the system tends to increase the value emotions by returning to a higher value of the emotional state of the system.

The point of emotional balance of the system is between negative and positive values, and therefore it can be considered the starting point—zero and called the “comfort point”. For the stability of the state of comfort, each positive emotional state must be balanced by the opposite negative state. This means that the emergence of a positive emotion, followed by a deviation from the point of comfort, should ultimately lead to an increase in negative emotion, which is the opposite of the named positive. For example, if we are hungry, then the negative emotion—hunger forces us to look for food, and when we start eating, we first compensate for the negative emotion of hunger, and when the feeling of hunger is compensated for, then as we eat, the negative emotion of oversaturation arises and begins to grow, which ultimately leads to give up food and trigger a positive emotion of digesting food. And so on, the cycle of changing emotions is repeated. Therefore, when working on a system, it is important to draw up a balanced map of emotions and their cycles in order to prevent self-destruction of the system.

### 7.10.1.1. Negative Reflex Emotions

So, as a working model of the system's reflex reactions to an acute negative emotion, the following can be proposed: a sequence of events/objects leads to an increase in negative emotion and, depending on the level of negativity of the emotion and the rate of its amplification, a certain “point of return” is reached, which serves as a trigger for the reverse sequence, and the sequence of events is rewound, that is, played in reverse order to the “comfort point”. Thus, we need to determine the moment when the system left the “comfort point” and the moment when the system reached the “point of return”. In terms of the Synchronization Layer [7.7], we should define the length between the named points. It should be noted that the Return Point also serves as a pause trigger [2.2.8] and interrupts the current sequence. Apparently, the scale of emotions may contain a synthetic object or end with a synthetic object with the conditional name “Return point”, when it appears, the sequence input is interrupted, a Pipe is created and the sequence is rewound the length of such a Pipe to the “comfort point”.

### 7.10.1.2. Positive Emotions

As a working model of the system's reflex reactions to a positive emotion, the following can be proposed: the sequence of events/objects leads to a positive emotion, which the system tries to prolong or enhance. In particular, if the emotion disappears with the end of the sequence of events (Trumpets), then the system repeats this sequence of events from the beginning, and if, as the sequence is entered, the opposite negative emotion grows, then the achievement of parity of positive and negative emotions (reaching the “comfort point”) generates a pause [2.2.8], the entry of the sequence is terminated and the Pipe is formed. If the positive emotion grows as you input the sequence, the system continues entering the sequence until a compensating negative emotion arises and a “comfort point” is reached.

Thus, it is necessary to define the “comfort point” from which the sequence should start over, as well as the “return point”, which serves as a trigger to repeat the sequence from the “comfort point”. The “return point” can also serve as a pause trigger [2.2.8]. Apparently, the scale of emotions may contain a synthetic object or end with a synthetic object with the conditional name “Sequence Repeat”, upon the appearance of which the sequence will be rewound back the full length of the Pipe of such a sequence to the “comfort point” or X % of the length of the Pipe and from this point will be played again. Repeat playback will continue until the saturation point is reached. Achievement of a negative emotion with its “Reverse point” or a point of physical fatigue or exhaustion can also serve as a saturation point. A good example of the unattainability of the “saturation point” is the spawning of pink salmon, when the fish die on the way to the spawning site or immediately after spawning. That is, the “point of return” is located outside the possibility of return and is, in fact, a “point of no return”.

### 7.10.2. Acquired Emotions

If, when entering texts or watching films, the determination of their emotional coloring can be automated, then when observing natural phenomena such an assessment should be entered into the Memory of Sequences along with information about the phenomenon, since the nature of such an assessment is subjective and social, and even children have to be taught this. In many cases, abstract rules of behavior are dictated by non-obvious consequences for society or individuals, which a person can underestimate, and other abstract rules are a variation on the theme “do not do to others what you yourself would not like” and robots themselves cannot learn such emotions either unless the nature of their “emotions” is human. Therefore, it seems necessary to train machines to evaluate events correctly. Probably, it is possible to create training examples of situations for robots, for their rapid learning in the field of emotional and ethical assessment of various events that robots can face in life and automatically adjust the “psyche” of the robot at the time of its production.

However, it is necessary that the presence of an emotional assessment leads to the blocking or stimulation of certain hypotheses in order to form a set of acceptable and a set of preferred hypotheses. For example, if one of the predictions of the robot's actions is associated with a deterioration in the emotional coloring of events or even to an unacceptable emotional coloring (for example, it ends with the death of a person), then the robot should exclude such a forecast from the number of acceptable ones, and if the forecast ends with an improvement in the emotional coloring of events, then such a forecast should refer to the set of admissible or even to the set of preferable hypotheses, depending on the degree of change in the emotional color.

The result of tire activations in the Emotion layer during the input of sequences (training the PP) will be that the identifiers of the emotional tires will appear in the Pipes of the context and, when making predictions, the robot will extract the Pipe Generators and select from them those that stimulate rather than block the robot's actions. Thus, the Sequence Memory Matrix for the first time allows the implementation of artificial intelligence capable of ethical and emotional assessment of events.

### 7.10.3. The Scale of Emotions as a Scale of Synchronization of Measurements

If each feeling is represented as a scale or one of the categories of the measurement scale, and the gradation of feeling “good-bad” as the values of such a category or scale, then the architecture of the emotion layer can be similar to the architecture of the measurement synchronization layer [7.7.1]. This will allow retrieving from memory sequences corresponding to a certain set of emotions with rounding or sequences with a certain “amplitude” of changes in emotions.

### 7.11. Architecture of Multithreaded Synchronous Hierarchical Sequence Memory (MSIPP)

For the formation of Multi-threaded Hierarchical Sequence Memory (MIPP) the IPP can be equipped with two or more different UIDMs, a plurality of INI neurons and a plurality of INM neurons, which are connected by the named set of Sensors C; moreover, the set of the named Sensors C of the corresponding neuron of the INI is represented by subsets, each of which connects the corresponding INI by means of the named INM with the named different Length measuring devices; and a plurality of named Sensors C of the corresponding neuron of the INM connects the corresponding INM with the groups of Sensors D of various neurons of the INI; in the training mode of the corresponding INI, one or more named INMs are also trained, each of which connects the named INI with different UIDM; in the playback mode after the activation function of the Adder B of one of the INI neurons or after the activation of the activation function of the Adder B1 of one of the INM neurons, such a neuron transmits an activation signal, respectively, to the Second or First connection of Sensor C, and Sensor C transmits an activation signal through its Third and Fourth connections on the group of group D sensors of the corresponding INI neuron and on the E1 sensor group of the corresponding INM neuron.

For the formation of Multi-threaded Synchronous Hierarchical Memory of Sequences (MSIPP) MIPP is equipped with a plurality of IPPs of objects of different nature (IPPRP), each of which is equipped with multiple layers of measurements of different nature, and wherein at least a pair of IPPRP use at least one layer of measurements of the same nature, and to synchronize the measurement marks of such at least one measurement layer of the same nature in such at least two IPPRPs, the named measurement layers of the same nature are equipped with one measurement signal generator or equipped with different measurement signal generators of the same nature, in each of which enter the same coordinates of the measurement origin.

MSIPP is equipped with a plurality of IPP of objects of different nature (IPPRP), and all named IPPRP use a common layer of synthetic objects of the M2 hierarchy so that the sequences of synthetic objects of the named layer consist of synthetic objects, each of which is generated by a layer of the M1 hierarchy of one of the named IPPRP.

To provide multithreading of measurements in the Hierarchical Sequence Memory, IPPs provide multiple layers of measurements of different natures, for example, a layer for measuring time, location, emotion, ethics, and any other dimensions. The set of C sensors associated with neurons INI is divided into subsets, and each subset of Sensors C is associated with the INM of different measurement layers. Thus, each INI neuron turns out to be associated with different measurement layers. In the learning mode of the INI, simultaneously with the INI, in each layer of measurements, the INM neuron is trained, the training bus of which is active at the moment of learning the INI. This allows each INI neuron to be connected via Sensors C with the INM neurons of measurement layers of different nature. For example, one and the same INI can be associated with the INM neuron of the time measurement layer, with the INM neuron of the location measurement layer, and with the INM neuron of the emotion and ethical standards layer.

For the purposes of synchronization of MSIPP, the preferred architecture is to combine a plurality of Hierarchical Sequence Memories (IPPs), each of which is an IPP for objects of different nature. For example, one IPP is used for visual images, another for audio, a third for textual information, and so on . . . . At least the lowest layer of each IPP—an object sequence memory layer, must store only sequences of objects of a named unique nature, and since the measurement layer is placed at the objects layer, each IPP must have its own measurement layers for each measurement.

The principles of combining the named IPPs into a single Multithreaded IPP are as follows:
1. Measurement layers of the same nature for IPP objects of different nature should be synchronized by using a single reference point of generators G (FIG. 78) of measurement layers of the same nature. IPPs for objects of different natures can also be synchronized by using the same generator G for measurement layers of the same nature. For example, for all layers of time measurement, the time generator must have either the same reference point or it must be the same time generator for all layers of time measurement for each IPP of objects of a different nature. Likewise, layers of geodetic measurements must have either a single coordinate reference point or a single Coordinate Generator.
2. All IPPs of objects of different nature must be combined at the level of one of the layers of Pipes, for example, at the level of Pipes of the 1st kind or at the level of Pipes of the 2nd kind, and so on. This becomes possible because the Pipes are synthetic objects of meaning and, as objects, lose their original nature, which makes it possible to unite synthetic objects at any of the levels of the Pipes.

It is reasonable to use dedicated Generators for measurement layers of the same nature in IPPs of objects of different nature in a situation, for example, when the location of different IPPs is different. An example of such a situation can be humanity as a set of people who have a single community as humanity—a common history, a common planet, and so on. So each of the people has its own IPP, however, the knowledge and achievements of all mankind, represented by archives and databases, is an example of an IPP common for all mankind as a whole, and such an IPP is synchronized in time and space by binding to a single time scale (in our terms, this is Time generator), as well as such a MIPP is synchronized in space using geodetic referencing or referencing to the geography of the Earth, first by assigning and using geographical names, and then by assigning and using geodetic coordinates.

The use of separate measurement layers for each IPP allows you to create your own measurement marks for each Memory of Sequences of objects of a unique nature, and such marks of each of the Sequence Memories of objects of any other nature are synchronized with each other due to the use of either a single reference point or a single Generator. So, for example, the sound row of a cat's meow and the visual row of a cars appearance will be synchronized in time and space, which makes it possible to simultaneously extract both sequences from the PP of visual images and from the PP of sound images by entering into both PPs as a search query the time stamp of the cat's appearance or a mark the location of the cat's appearance.

### 7.12. Disadvantages of Neural Networks

Despite the fact that the perceptron functionally simulates the operation of pyramidal neurons—many inputs and one output, modern neural networks rely on mathematical methods to determine the weights of the incoming connections of the perceptron, in particular, the error backpropagation method and other abstract techniques that are not directly related to the mechanisms of sequence memory and not based on its work. While Sequence Memory is taught by introducing sequences, that is, building a statistical model of the external world in Sequence Memory, neural network training techniques can only train a neural network to solve highly specialized problems.

### 7.13. Advantages of Sequence Memory Hardware Implementation

As shown earlier, the software implementation of Sequence Memory using a recursive index of search engines requires storing a set of hits in the index for each of the unique sequence objects, which is why the task of generating a Cluster of a unique object is very laborious. The problem of generating a Cluster of a unique object with the help of neural networks is solved by the methods of training a neural network (the method of back propagation of an error), which do not allow directly linking the values of the weight coefficients of artificial neurons with the statistics of the co-occurrence of unique objects, and this does not allow us to reliably assert that the behavior of the neural network will be completely determined by the picture of the world obtained by the neural network in the learning process, and its decisions will be predictable. The latter circumstance limits the use of neural networks in tasks where the decisions made by the neural network are related to the safety of people.

The transition to the hardware implementation of the Memory of Sequences in the form of a matrix allows generating a Cluster of a unique object in one cycle of operation of the matrix: by feeding the signal of the corresponding unique object to the input of the matrix, at the output of the matrix we obtain a set of signals of the Cluster of the named unique object.

The use of the hardware implementation of the PP in the form of a matrix also makes it possible to automate the task of producing conclusions through the generation of synthetic objects with their anticipatory and feedback to existing unique objects. Synthetic objects and the named connections are generated in the process of learning and using the hardware implementation of the PP.

1. A method of creation and functioning of the sequence memory wherein digital information is represented by a plurality of machine-readable data arrays, each of which is a sequence of unique objects, each represented by a unique machine-readable value of the object, and each unique object (hereinafter the “key object”) appears, at least in some sequences, the sequence memory is trained by feeding the sequences of objects to the memory input, and each time the key object appears, the memory extracts the objects preceding the key object in the sequence (hereinafter referred to as “frequent objects of the past”), increases by one the value of the counter of the co-occurrence of the key object with each unique frequent object of the past and updates the counter value with a new value, and combines the counter values for different unique frequent objects into a data array of weights of the “past”, as well the memory, at each appearance of the key object, extracts from the named sequence the objects following the named key object in the named sequence (hereinafter referred to as “frequent objects of the future”), increases by one the value of the counter of the mutual occurrence of the key object with each unique frequent object and updates the counter value with a new value, and combines the counter values for different unique frequent objects into a data array of weights of the “future”; each data array of “past” and “future” is being divided into subsets (hereinafter “rank sets”), each of which contains only frequent objects equidistant from the named key object either in the “past” or in the “future”, and each unique key object with at least one corresponding rank set is put in the sequence memory; and the sequence memory provides a search in the named data arrays for the named rank set of weights in response to the input of the named unique key object or the search for the named unique key object in response to the input of the rank set or its part.

2. The method according to claim 1 wherein for each unique key object, at least one rank set of the future or past of the same specific rank (hereinafter the “base rank” of the set) is stored in the sequence memory, and each weight of mutual occurrence in such a rank set refers to a frequent object that in a sequence directly adjoins the named key object or is separated from the named key object by the number of frequent objects corresponding to the rank.

3. The method according to claim 2, wherein a certain number of all rank sets of the base rank are stored in memory as a reference hereinafter referred to as the “Reference Memory State” or “ESP”, and any instant memory state hereinafter referred to as the “MSP” or part of it is compared accordingly with the ESP or part of it to identify deviations of the MSP from the ESP.

4. The method according to claim 3, wherein an array of “future” or an array of “past”, or a set of a rank other than the base rank, are represented by a set derived from a set of MSP.

5. The method according to claim 2 wherein the base' rank set is the set of the first rank and contains the weights of the frequent objects immediately adjacent to the named key object in the sequences.

6. The method according to claim 2 wherein a limited number of rank sets are stored in memory.

7. The method according to claim 6 wherein the data arrays of future and past are formed as a linear composition of the weights or rank sets of the MSP data array.

8. The method according to claim 8 wherein when entering an object, the unique digital code of which could have been entered with an error, the comparison of rank sets is carried out in order to identify a possible error.

9. The method according to claim 1 wherein compare rank sets of different ranks hereinafter referred to as the “coherent sets” for known key objects of the sequence, and the rank of the rank set for each key object is selected corresponding to the number of sequence objects separating the named key object and the hypothesis object hereinafter referred to as the “focal object of coherent sets”, the possibility of the appearance of which in the sequence is checked.

10. The method according to claim 1 wherein for each object of a specific set of frequent objects, a rank set is retrieved from the sequence memory, for which the named frequent object is a key object, the extracted rank sets of the same rank are compared to determine at least one object that is simultaneously contained in all retrieved rank sets.

11. The method according to claim 1 wherein sequences are entered into memory in cycles, and at each cycle a queue of objects of the sequence hereinafter referred to as the “attention window” is introduced into the memory, and when moving to the next cycle, the queue of objects is increased or shifted by at least one object into the future or the past.

12. The method according to claim 11 wherein during the named cycle, for each of the objects of the attention window as for a key object, at least one named array or rank set is retrieved from memory, containing the weights of frequent objects, the weights of unique frequent object, simultaneously contained in all named arrays or sets are extracted from all named arrays or sets and added together, thus forming a set of pipe containing the total weights of unique frequent objects of simultaneous occurrence with all attention window objects.

13. The method according to claim 12 wherein the weights of the occurrence of all frequency Objects from the Set of Pipe are extracted and summed, obtaining the Total Weight of the Pipe.

14. The method according to claim 13 wherein the difference between two consecutive values of the total weight of the pipe is calculated and, if the difference does not exceed the specified error, then each unique frequent object that does not occur in at least one of the arrays or rank sets of the attention window′ objects is removed from the pipe set and its weight is equalized to zero, and the resulting set is considered the pipe caliber set, the named pipe caliber set is assigned a newly created sequence memory object identifier (hereinafter “Synthetic Object”), and the named synthetic object identifier, the set of the pipe caliber and the set of attention window objects (further referred to as the pipe generator) are being linked to each other and stored in the sequence memory.

15. The method according to claim 14 wherein a search query to the sequence memory is used as an attention window, for which a pipe set is determined and compared with the pipe caliber sets previously stored in sequence memory, and if the difference between the pipe set and the pipe caliber set is comparable with some error, then the pipe generator corresponding to the named pipe caliber set is retrieved from the sequence memory and used as the result of the search (hereinafter “memories”) in the sequence memory.

16. The method according to claim 14 order of creation of successive pipe calibers each containing frequent objects set of the current hierarchy level (hereinafter referred to as “hierarchy level M1”) are being stored in the sequence memory as a sequence of corresponding them synthetic objects of a higher level of hierarchy (hereinafter referred to as “hierarchy level M2”).

17. The method according to claim 16 wherein a sequence of Synthetic Objects is introduced as one of the machine-readable data arrays of the hierarchy level M2 of the sequence memory.

18. The method according to claim 14 wherein at least one of the named weight arrays of the future or the past, or named sets of pipe or pipe caliber, or ESP, or MSP, or a collection of named arrays and sets, or any set derived from the named arrays and sets are fed to an artificial neural network with known architecture as a dataset or used as a source of weights to adjust the weights of connections between its artificial neurons.

19. A sequence memory (hereinafter «PP») containing two interconnected sets of N parallel numbered buses, of which the first set is located above the second set so that the buses of the first and second sets form intersections (crossbar), where the ends of each set of buses located on one of the sides of the crossbar are used as inputs, and the opposite ends are used as outputs so that the signals applied to the inputs of the first set of buses are read both from the outputs of the first set of buses, and from the outputs of the second set buses in the presence of commutative elements in the intersection of the first and second set; the angle β\hat{ }0 between the buses of the first and second sets is chosen, based on the functional and geometric requirements for the memory device, wherein, the buses of the first and second sets with the same numbers are connected to each other at their intersection so that the set of such connections forms a diagonal of the matrix, dividing the crossbar into two symmetric triangular semi-crossbars (hereinafter referred to as “Triangles”), at least one of which (hereinafter the “First Triangle”) is used by connecting each two buses, at least with mismatching numbers from the first and second sets at their intersection by means of at least one Artificial Neuron of Occurrence (INV) so that the ends of the buses of the first set are inputs and the ends of the second set of buses are outputs of the Triangle, and INV is used as the named Switching Element for accumulating, storing and reading the weight of the co-occurrence of objects to which the buses connected by the named INV correspond; each of said INVs functions at least as a counter with an activation function and a memory cell for storing the last value and the value of the INV activation threshold; before starting the device operation, the last value is assigned some initial value, which is saved in the memory cell of the Counter; the value of the INV activation threshold is also stored in the memory cell; in the learning mode, each time when signals are applied simultaneously to each of the buses connected by means of the INV, the named INV measures one of the signal characteristics on each of their buses, then compares the measured values of the characteristics and, if the comparison result corresponds to the value of the INV activation threshold, the INV reads the last value from the memory cell, increases the named last value by the amount of change in the occurrence and stores the new last value in the memory cell, and in the playback mode the signal is fed to at least one of the named buses connected by means of the INV, the signal is passed through the INV, where from the memory cell the last value is extracted, one of the signal characteristics is changed according to the extracted last value, and the named modified signal is transmitted to the second of the named buses connected by means of the INV, to extract the named last value from the named one of the signal characteristics and use the named last values as the weight of the co-occurrence of objects to which the buses correspond.
